(19) United States
(12) Patent Application Publication
(10) Pub. No.: US 2007/0141397 A1
(43) Pub. Date: Jun. 21, 2007

(54) TRANSITION METAL COMPLEX COMPOUND AND ORGANIC ELECTROLUMINESCENCE DEVICE USING THE COMPOUND

(75) Inventors: Masami Watanabe, Chiba (JP); Fumio Okuda, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: IDEMITSU KOSAN CO., LTD, Chiyoda-ku (JP)

(21) Appl. No.: 11/610,093

(22) Filed: Dec. 13, 2006

Related U.S. Application Data
(60) Provisional application No. 60/750,338, filed on Dec. 15, 2005.

(51) Int. Cl. B32B 19/00

(52) U.S. Cl. 428/690

(57) ABSTRACT

The present invention relates to a transition metal complex compound of a specific structure having a metal carbene bond and an organic electroluminescent device in which an organic thin film layer comprising a single layer or plural layers having at least a light emitting layer is interposed between an anode and a cathode, wherein at least one layer in the organic thin film layer contains the transition metal complex compound described above, and provided are an organic EL device having a high luminous efficiency and emitting blue light and a transition metal complex compound materializing the same.

### BACKGROUND OF THE INVENTION

The present invention relates to a transition metal complex compound and an organic electroluminescence device using the compound, specifically to an organic electroluminescence device having a high current efficiency and emitting blue light and a novel transition metal complex compound which materializes the same.

### RELATED ART

An organic electroluminescence (EL) device is a spontaneous luminescent device making use of the principle that a fluorescent substance emits light by recombination energy of holes injected from an anode and electrons injected from a cathode by applying an electric field. Since a low voltage-driven organic EL device of a laminate type was reported by C. W. Tang et al. of Eastman Kodak Company (C. W. Tang and S. A. Vanslyke, Applied Physics Letters, Vol. 51, p. 913, 1987), researches on organic EL devices comprising organic materials as structural materials have actively been carried out. Tang et al. use tris(8-hydroxyquinolinol aluminum) for the light emitting layer and a triphenyldiamine derivative for the hole transporting layer. The advantages of a laminate structure include an elevation in an efficiency of injecting holes into a light emitting layer, a rise in a production efficiency of excimers formed by blocking electrons injected from a cathode to recombine them and shutting up of excimers formed in a light emitting layer. As shown in the above example, a two layer type comprising a hole transporting (injecting) layer and an electron transporting and light emitting layer and a three layer type comprising a hole transporting (injecting) layer, a light emitting layer and an electron transporting (injecting) layer are well known as the device structures of an organic EL device. In such laminate type structural devices, device structures and forming methods are studied in order to enhance a recombination efficiency of holes and electrons injected.

Known as luminescent materials for an organic EL device are luminescent materials such as chelate complexes including a tris(8-quinolinolate)aluminum complex, coumarin derivatives, tetraphenylbutadiene derivatives, distyrylarylene derivatives and oxadiazole derivatives. It is reported that emission of a blue color to a red color in a visible region is obtained from them, and it is expected that a color display device is materialized (refer to, for example, a patent document 1, a patent document 2 and a patent document 3).

In recent years, it is proposed as well to make use of organic phosphorescent materials in addition to luminescent materials for a light emitting layer in an organic EL device (refer to, for example, a non-patent document 1 and a non-patent document 2). As described above, a singlet state and a triplet state in an excited state of a phosphorescent material are utilized in a light emitting layer of an organic EL device, whereby a high luminous efficiency is achieved. It is considered that a singlet excimer and a triplet excimer are produced in a proportion of 1:3 due to a difference in a spin multiplicity when an electron and a hole are recombined in an organic EL device, and therefore it is considered that a luminous efficiency which is larger by 3 to 4 times than that of a device using only a fluorescent material is achieved if a phosphorescent luminescent material is used.

In such organic EL device, there has been used a constitution in which layers are laminated in such an order as an anode, a hole transporting layer, an organic light emitting layer, an electron transporting layer (hole blocking layer), an electron transporting layer and a cathode so that a triplet excited state or a triplet excimer is not quenched, and a host compound and a phosphorescent material have been used for an organic light emitting layer (refer to, for example, a patent document 4 and a patent document 5). The above patent documents relate to technologies on phosphorescent materials emitting red to green lights. Further, technologies on luminescent materials having a blue color base luminescent color are disclosed as well (refer to, for example, a patent document 6, a patent document 7 and a patent document 8). However, they have very short device lifetimes. In particular, skeleton structures of ligands in which Ir metal is bonded to a phosphorus atom are described in the patent document 7 and the patent document 8, and while they emit blued light, they have weak bonding and are markedly poor in a heat resistance. A complex in which an oxygen atom and a nitrogen atom are bonded to central metal is described in a patent document 9. However, a specific effect of a group bonded to an oxygen atom is not described and uncertain. A complex in which each one of nitrogen atoms contained in different cyclic structures is bonded to central metal is disclosed in a patent document 10, and a device prepared by making use of it emits blue light, but an external quantum efficiency thereof is as low as about 5%.

On the other hand, transition metal complex compounds having a metal carbene bond (hereinafter referred to as a carbene complex) are researched in recent years (refer to, for example, a patent document 11 and non-patent documents 3 to 11).

Carbene means two-coordinate carbon which has two electrons in an sp² hybrid orbital and a 2p orbital, and it can assume four kinds of structures depending on combinations of the orbitals in which two electrons are present and a direction of spin. Usually, it is singlet carbene and comprises an occupied orbital of sp² hybrid and an empty 2p orbital.

A carbene complex has a short lifetime and is instable, and it has so far been utilized as a reaction intermediate in organic synthetic reaction or a synthetic conversion reagent for addition to olefin. In 1991, stable carbene complexes comprising an aromatic heterocyclic structure and stable carbene complexes comprising a non-aromatic cyclic structure were found out, and thereafter, non-cyclic carbene complexes came to be stably obtained by stabilizing them with nitrogen and phosphorus. A catalytic performance is enhanced by using them as a ligand to bond them to transition metals, and therefore in recent years, expectation to stable carbene complexes grows high in catalytic reaction in organic synthesis.

It is found that particularly in olefin metathesis reaction, the performances are notably enhanced by adding or coordinating stable carbene complexes. Further, in recent years, developed are researches on the efficiency of Suzuki coupling reaction, oxidation and selective hydroformylation reaction of alkanes and optically active carbene complexes, and application of carbene complexes to the organic synthetic field attracts attentions.

The examples of complexes specifically having a carbene iridium bond are described in the following non-patent document 12 (tris(carbene)iridium complex comprising a non-heterocyclic type carbene ligand) and non-patent document 13 (unidentate coordination type monocarbene iridium complex), but applications thereof to the organic EL device field and the like are not described therein.

Further, synthesis of iridium complexes having a carbene bond, an emission wavelength thereof and the performances of the devices are described in the patent document 11, but the energy efficiency and the external quantum efficiency are low. In addition thereto, the emission wavelength is distributed in a ultraviolet region, and the visual efficiency is inferior. Accordingly, they are not suited to light emitting devices in a visual wavelength region such as organic EL. They can not be vacuum-deposited because of the reasons that a decomposition temperature is low and that a molecular weight is high, and the complexes are decomposed in deposition, so that a problem is involved in the point that impurities are mixed in producing the devices.
Patent document 1: Japanese Patent Application Laid-Open No. 239655/1996
Patent document 2: Japanese Patent Application Laid-Open No. 183561/1995
Patent document 3: Japanese Patent Application Laid-Open No. 200289/1991
Patent document 4: U.S. Pat. No. 6,097,147
Patent document 5: International Publication No. WO 01/41512
Patent document 6: US 2001/0025108
Patent document 7: US 2002/0182441
Patent document 8: Japanese Patent Application Laid-Open No. 170684/2002
Patent document 9: Japanese Patent Application Laid-Open No. 123982/2003
Patent document 10: Japanese Patent Application Laid-Open No. 133074/2003
Patent document 11: International Publication No. WO 05/019373
   Non-patent document 1: D. F. OBrien and M. A. Baldo et al. “Improved energy transfer in electrophosphorescent devices”, Vol. 74, No. 3, pp. 442 to 444, Jan. 18, 1999 Non-patent document 2: M. A. Baldo et al. “Very high-efficiency green organic light-emitting devices based on electrophosphorescence”, Applied Physics Letters, Vol. 75, No. 1, pp. 4 to 6, Jul. 5, 1999
Non-patent document 3: Chem. Rev., 2000, 100, p. 39
Non-patent document 4: J. Am. Chem. Soc., 1991, 113, p. 361
Non-patent document 5: Angew. Chem. Int. Ed., 2002, 41, p. 1290
Non-patent document 6: J. Am. Chem. Soc., 1999, 121, p. 2674
Non-patent document 7: Organometallics, 1999, 18, p. 2370
Non-patent document 8: Angew. Chem. Int. Ed., 2002, 41, p. 1363
Non-patent document 9: Angew. Chem. Int. Ed., 2002, 41, p. 1745
Non-patent document 10: Organometallics, 2000, 19, p. 3459
Non-patent document 11: Tetrahedron Asymmetry, 2003, 14, p. 951
Non-patent document 12: Organomet. Chem., 1982, 239, C26 to C30
Non-patent document 13: Chem. Commun., 2002, p. 2518

### DISCLOSURE OF THE INVENTION

The present invention has been made in order to solve the problems described above, and an object thereof is to provide an organic EL device having a high luminous efficiency and emitting blue light and a novel transition metal complex compound which materializes the same.

Intensive researches repeated by the present inventors in order to achieve the object described above have resulted in finding that in a transition metal complex compound having a metal carbene bond, an emission wavelength can be shifted to a longer wavelength as compared with that of a bidentate ligand type complex by turning a ligand of the complex into a tridentate having a metal carbene bond. This phenomenon is useful as a technology in which an emission wavelength can be controlled to a desired wavelength, and it is particularly useful for deriving a material having an emission wavelength in an ultraviolet region into a material having an emission wavelength in a blue color region (a visual wavelength region can be expanded). It has been found that an organic EL device having a high luminous efficiency and emitting blue light can be obtained by making use of the above technology, and thus the present invention has come to be completed.

That is, the present invention provides transition metal complex compounds having a metal carbene bond represented by the following Formulas (1) to (5): 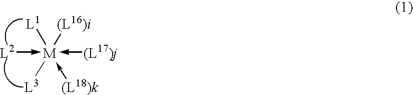
[in Formula (1), a bond shown by a solid line (—) represents a covalent bond; a bond shown by an arrow (→) represents a coordinate bond; L²→M represents a metal carbene bond; M represents a metal atom of iridium (Ir) or platinum (Pt); L¹-L²-L³ represents a cross-linked tridentate ligand, and L¹⁶, L¹⁷ and L¹⁸ each independently represent a unidentate ligand, a cross-linked bidentate ligand in which two of them are cross-linked or a cross-linked tridentate ligand in which at least two of L¹⁶ and L¹⁷, L¹⁷ and L¹⁸ and L¹⁶ and L¹⁸ are cross-linked; at least one of L¹, L² and L³ may be cross-linked with at least one of L¹⁶, L¹⁷ and L¹⁸; i, j and k each represent an integer of 0 to 1, and 2+i represents a valence of metal M;
L¹ and L³ each independently represent a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent;
L² represents a divalent group having carbene carbon which may have a substituent;
L16 represents a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁶ and L¹⁷ or L¹⁶ and L¹⁸ are cross-linked, it is a divalent group of each group described above, and when L¹⁶ and L¹⁷ and L¹⁶ and L¹⁸ are cross-linked, it is a trivalent group of each group described above;
L¹⁷ and L¹⁸ each independently represent a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁶ and L¹⁷, L¹⁶ and L¹⁸ or L¹⁷ and L¹⁸ are cross-linked, it is a monovalent group of each ligand described above, and when L¹⁶ and L¹⁷ and L¹⁷ and L¹⁸ are cross-linked and when L¹⁶ and L¹⁸ and L¹⁷ and L¹⁸ are cross-linked, it is a divalent group of each ligand described above]. 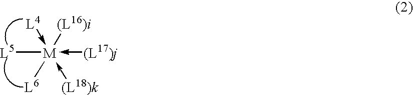
   [in Formula (2), a bond shown by a solid line (—) represents a covalent bond; a bond shown by an arrow (→) represents a coordinate bond; L⁴→M represents a metal carbene bond; M represents a metal atom of iridium (Ir) or platinum (Pt); L⁴-L⁵-L⁶ represents a cross-linked tridentate ligand, and L¹⁶, L¹⁷ and L¹⁸ each independently represent a unidentate ligand, a cross-linked bidentate ligand in which two of them are cross-linked or a cross-linked tridentate ligand in which at least two of L¹⁶ and L¹⁷, L¹⁷ and L¹⁸ and L¹⁶ and L¹⁸ are cross-linked; at least one of L⁴, L⁵ and L⁶ may be cross-linked with at least one of L¹⁶, L¹⁷ and L¹⁸; i, j and k each represent an integer of 0 to 1, and 2+i represents a valence of metal M;
L⁶ each independently represents a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent;
L⁵ represents a group obtained by removing one hydrogen atom of each group represented by L⁶ described above to make it trivalent;
L⁴ represents a monovalent group having carbene carbon which may have a substituent, a monovalent aromatic hydrocarbon group having 6 to 30 ring carbon atoms which may have a substituent or a monovalent heterocyclic group having 3 to 30 ring carbon atoms which may have a substituent, and at least one of them is a monovalent group having carbene carbon which may have a substituent;
L¹⁶ represents a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁶ and L¹⁷ or L¹⁶ and L¹⁸ are cross-linked, it is a divalent group of each group described above, and when L¹⁶ and L¹⁷ and L¹⁶ and L¹⁸ are cross-linked, it is a trivalent group of each group described above;
L¹⁷ and L¹⁸ each independently represent a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁶ and L¹⁷, L¹⁸ and L¹⁸ or L¹⁷ and L¹⁸ are cross-linked, it is a monovalent group of each ligand described above, and when L¹⁶ and L¹⁷ and L¹⁷ and L¹⁸ are cross-linked and when L¹⁶ and L¹⁸ and L¹⁷ and L¹⁸ are cross-linked, it is a divalent group of each ligand described above]. 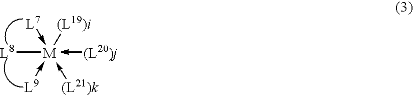
   [in Formula (3), a bond shown by a solid line (—) represents a covalent bond; a bond shown by an arrow (→) represents a coordinate bond; M represents a metal atom of iridium (Ir) or platinum (Pt); L⁷-L⁸-L⁹ represents a cross-linked tridentate ligand, and L¹⁹, L²⁰ and L²¹ each independently represent a unidentate ligand, a cross-linked bidentate ligand in which two of them are cross-linked or a cross-linked tridentate ligand in which at least two of L¹⁹ and L²⁰, L²⁰ and L²¹ and L¹⁹ and L²¹ are cross-linked; at least one of L⁷, L⁸ and L⁹ may be cross-linked with at least one of L¹⁹, L²⁰ and L²¹; i, j and k each represent an integer of 0 to 1, and 1+i+j represents a valence of metal M; L⁸ represents a trivalent aromatic hydrocarbon group having 6 to 30 ring carbon atoms which may have a substituent, a trivalent heterocyclic group having 3 to 30 ring carbon atoms which may have a substituent, a trivalent carboxyl-containing group having 1 to 30 carbon atoms which may have a substituent, a trivalent hydrocarbon group containing amino group or hydroxyl group which may have a substituent, a trivalent cycloalkane moiety having 3 to 50 ring carbon atoms which may have a substituent, a trivalent alkane moiety having 1 to 30 carbon atoms which may have a substituent, a trivalent alkene moiety having 2 to 30 carbon atoms which may have a substituent or a trivalent arylalkane moiety having 7 to 40 carbon atoms which may have a substituent;
L⁷ and L⁹ each independently represent a monovalent group having carbene carbon which may have a substituent, a monovalent aromatic hydrocarbon group having 6 to 30 ring carbon atoms which may have a substituent or a monovalent heterocyclic group having 5 to 30 ring carbon atoms which may have a substituent; and at least one of L⁷ and L⁹ is a monovalent group having carbene carbon which may have a substituent;
L¹⁹ and L²⁰ each independently represent a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁹ and L²⁰, L¹⁹ and L²¹ or L²⁰ and L²¹ are cross-linked, it is a divalent group of each group described above, and when L¹⁹ and L²⁰ and L¹⁹ and L²¹ are cross-linked and when L¹⁹ and L²⁰ and L²⁰ and L²¹ are cross-linked, it is a trivalent group of each group described above;
L²¹ represents a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁹ and L²¹ or L²⁰ and L²¹ are cross-linked, it is a monovalent group of each ligand described above, and when L¹⁹ and L²¹ and L²⁰ and L²¹ are cross-linked, it is a divalent group of each ligand described above]. 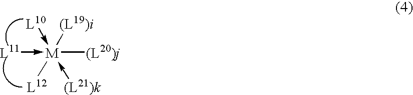
   [in Formula (4), a bond shown by a solid line (—) represents a covalent bond; a bond shown by an arrow (→) represents a coordinate bond; L¹⁰→M represents a metal carbene bond; M represents a metal atom of iridium (Ir) or platinum (Pt); L¹⁰-L¹¹-L¹² represents a cross-linked tridentate ligand, and L¹⁹, L²⁰ and L²¹ each independently represent a unidentate ligand, a cross-linked bidentate ligand in which two of them are cross-linked or a cross-linked tridentate ligand in which at least two of L¹⁹ and L²⁰, L²⁰ and L²¹ and L¹⁹ and L²¹ are cross-linked; at least one of L¹⁰, L¹¹ and L¹² may be cross-linked with at least one of L¹⁹, L²⁰ and L²¹; i, j and k each represent an integer of o to 1, and 1+i+j represents a valence of metal M;

L¹² represents a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent;
L¹⁰ represents a monovalent group having carbene carbon which may have a substituent;
L¹¹ represents a divalent aromatic hydrocarbon group having 6 to 30 ring carbon atoms which may have a substituent, a divalent heterocyclic group having 3 to 30 ring carbon atoms which may have a substituent or a divalent group having carbene carbon which may have a substituent;
L¹⁹ and L²⁰ each independently represent a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁹ and L²⁰, L¹⁹ and L²¹ or L²⁰ and L²¹ are cross-linked, it is a divalent group of each group described above, and when L¹⁹ and L²⁰ and L¹⁹ and L²¹ are cross-linked and when L and L²⁰ and L²⁰ and L²¹ are cross-linked, it is a trivalent group of each group described above;
L²¹ represents a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁹ and L²¹ or L²⁰ and L²¹ are cross-linked, it is a monovalent group of each ligand described above, and when L¹⁹ and L²¹ and L²⁰ and L²¹ are cross-linked, it is a divalent group of each ligand described above]. 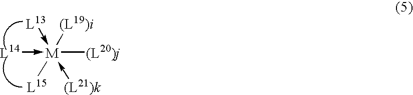
   [in Formula (5), a bond shown by a solid line (—) represents a covalent bond; a bond shown by an arrow (→) represents a coordinate bond; L¹⁴→M represents a metal carbene bond; M represents a metal atom of iridium (Ir) or platinum (Pt); L¹³-L¹⁴-L¹⁵ represents a cross-linked tridentate ligand, and L¹⁹, L²⁰ and L²¹ each independently represent a unidentate ligand, a cross-linked bidentate ligand in which two of them are cross-linked or a cross-linked tridentate ligand in which at least two of L¹⁹ and L²⁰, L²⁰ and L²¹ and L¹⁹ and L²¹ are cross-linked; at least one of L¹³, L¹⁴ and L¹⁵ may be cross-linked with at least one of L¹⁹, L²⁰ and L²¹; i, j and k each represent an integer of 0 to 1, and 1+i+j represents a valence of metal M;
L¹⁵ represents a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent;
L¹⁴ represents a divalent group having carbene carbon which may have a substituent;
L¹³ represents a monovalent aromatic hydrocarbon group having 6 to 30 ring carbon atoms which may have a substituent, a monovalent heterocyclic group having 3 to 30 ring carbon atoms which may have a substituent or a monovalent group having carbene carbon which may have a substituent;
L¹⁹ and L²⁰ each independently represent a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁹ and L²⁰, L¹⁹ and L²¹ or L²⁰ and L²¹ are cross-linked, it is a divalent group of each group described above, and when L¹⁹ and L²⁰ and L¹⁹ and L²¹ are cross-linked and when L¹⁹ and L²⁰ and L²⁰ and L²¹ are cross-linked, it is a trivalent group of each group described above;
L²¹ represents a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁹ and L²¹ or L²⁰ and L²¹ are cross-linked, it is a monovalent group of each ligand described above, and when L¹⁹ and L²¹ and L²⁰ and L²¹ are cross-linked, it is a divalent group of each ligand described above].

Further, the present invention provides an organic EL device in which an organic thin film layer comprising a single layer or plural layers having at least a light emitting layer is interposed between an anode and a cathode, wherein at least one layer in the above organic thin film layer contains the transition metal compound described above.

The transition metal complex compound of the present invention having a metal carbene bond has a high luminous efficiency and emits blue light.

### BEST MODE FOR CARRYING OUT THE INVENTION

The transition metal complex compound of the present invention is a transition metal complex compound having a metal carbene bond represented by the following Formulas (1) to (5).

First, the transition metal complex compound represented by Formula (1) shall be explained.

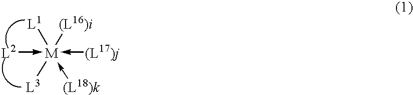

In Formula (1), a bond shown by a solid line (—) represents a covalent bond, and a bond shown by an arrow (→) represents a coordinate bond. L²→M represents a metal carbene bond.

In Formula (1), M represents a metal atom of iridium (Ir) or platinum (Pt), and Ir is preferred.

In Formula (1), L¹-L²-L³ represents a cross-linked tridentate ligand, and L¹⁶, L¹⁷ and L¹⁸ each independently represent a unidentate ligand, a cross-linked bidentate ligand in which two of them are cross-linked or a cross-linked tridentate ligand in which at least two of L¹⁶ and L¹⁷, L¹⁷ and L¹⁸ and L¹⁶ and L¹⁸ are cross-linked At least one of L¹, L² and L³ may be cross-linked with at least one of L¹⁶, L¹⁷ and L¹⁸; i, j and k each represent an integer of 0 to 1, and 2+i represents a valence of metal M.

In Formula (1), L¹⁶ represents a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁶ and L¹⁷ or L¹⁶ and L¹⁸ are cross-linked, it is a divalent group of each group described above, and when L¹⁶ and L¹⁷ and L¹⁶ and L¹⁸ are cross-linked, it is a trivalent group of each group described above.

The aromatic hydrocarbon group described above has preferably 6 to 18 ring carbon atoms and includes, for example, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl-4-yl, p-terphenyl-3-yl, p-terphenyl-2-yl, m-terphenyl-4-yl, m-terphenyl-3-yl, m-terphenyl-2-yl, o-tolyl, m-tolyl, p-tolyl, p-t-butylphenyl, p-(2-phenylpropyl)phenyl, 3-methyl-2-naphthyl, 4-methyl-1-naphthyl, 4-methyl-1-anthryl, 4′-methylbiphenylyl, 4″-t-butyl-p-terphenyl-4-yl, o-cumenyl, m-cumenyl, p-cumenyl, 2,3-xylylenyl, 3,4-xylylenyl, 2,5-xylylenyl, mesitylenyl, perfluorophenyl and groups obtained by converting the above groups into divalent groups.

Among them, preferred are phenyl, 1-naphthyl, 2-naphthyl, 9-phenanthryl, 2-biphenylyl, 3-biphenylyl, 4-biphenylyl, p-tolyl, 3,4-xylylenyl and groups obtained by converting the above groups into divalent groups.

The heterocyclic group described above has preferably 3 to 18 ring carbon atoms and includes, for example, 1-pyrrolyl, 2-pyrrolyl, 3-pyrrolyl, pyrazinyl, 2-pyridinyl, 1-imidazolyl, 2-imidazolyl, 1-pyrazolyl, 1-indolidinyl, 2-indolidinyl, 3-indolidinyl, 5-indolidinyl, 6-indolidinyl, 7-indolidinyl, 8-indolidinyl, 2-imidazo[1,5-a]pyridinyl, 1-imidazo[4,5-a]pyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 9-carbazolyl, β-carboline-1-yl, β-carboline-3-yl, β-carboline-4-yl, β-carboline-5-yl, β-carboline-6-yl, β-carboline-7-yl, β-carboline-6-yl, β-carboline-9-yl, 1-phenanthridinyl, 2-phenanthridinyl, 3-phenanthridinyl, 4-phenanthridinyl, 6-phenanthridinyl, 7-phenanthridinyl, 8-phenanthridinyl, 9-phenanthridinyl, 10-phenanthridinyl, 1-acridinyl, 2-acridinyl, 3-acridinyl, 4-acridinyl, 9-acridinyl, 1,7-phenanthroline-2-yl, 1,7-phenanthroline-3-yl, 1,7-phenanthroline-4-yl, 1,7-phenanthroline-5-yl, 1,7-phenanthroline-6-yl, 1,7-phenanthroline-8-yl, 1,7-phenanthroline-9-yl, 1,7-phenanthroline-10-yl, 1,8-phenanthroline-2-yl, 1,8-phenanthroline-3-yl, 1,8-phenanthroline-4-yl, 1,8-phenanthroline-5-yl, 1,8-phenanthroline-6-yl, 1,8-phenanthroline-7-yl, 1,8-phenanthroline-9-yl, 1,8-phenanthroline-10-yl, 1,9-phenanthroline-2-yl, 1,9-phenanthroline-3-yl, 1,9-phenanthroline-4-yl, 1,9-phenanthroline-5-yl, 1,9-phenanthroline-6-yl, 1,9-phenanthroline-7-yl, 1,9-phenanthroline-8-yl, 1,9-phenanthroline-10-yl, 1,10-phenanthroline-2-yl, 1,10-phenanthroline-3-yl, 1,10-phenanthroline-4-yl, 1,10-phenanthroline-5-yl, 2,9-phenanthroline-1-yl, 2,9-phenanthroline-3-yl, 2,9-phenanthroline-4-yl, 2,9-phenanthroline-5-yl, 2,9-phenanthroline-6-yl, 2,9-phenanthroline-7-yl, 2,9-phenanthroline-8-yl, 2,9-phenanthroline-10-yl, 2,8-phenanthroline-1-yl, 2,8-phenanthroline-3-yl, 2,8-phenanthroline-4-yl, 2,8-phenanthroline-5-yl, 2,8-phenanthroline-6-yl, 2,8-phenanthroline-7-yl, 2,8-phenanthroline-9-yl, 2,8-phenanthroline-10-yl, 2,7-phenanthroline-1-yl, 2,7-phenanthroline-3-yl, 2,7-phenanthroline-4-yl, 2,7-phenanthroline-5-yl, 2,7-phenanthroline-6-yl, 2,7-phenanthroline-8-yl, 2,7-phenanthroline-9-yl, 2,7-phenanthroline-10-yl, 1-phenazinyl, 2-phenazinyl, 1-phenothiazinyl, 2-phenothiazinyl, 3-phenothiazinyl, 4-phenothiazinyl, 10-phenothiazinyl, 1-phenoxazinyl, 2-phenoxazinyl, 3-phenoxazinyl, 4-phenoxazinyl, 10-phenoxazinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrole-1-yl, 2-methylpyrrole-3-yl, 2-methylpyrrole-4-yl, 2-methylpyrrole-5-yl, 3-methylpyrrole-1-yl, 3-methylpyrrole-2-yl, 3-methylpyrrole-4-yl, 3-methylpyrrole-5-yl, 2-t-butylpyrrole-4-yl, 3-(2-phenylpropyl)pyrrole-1-yl, 2-methyl-1-indolyl, 4-methyl-1-indolyl, 2-methyl-3-indolyl, 4-methyl-3-indolyl, 2-t-butyl-1-indolyl, 4-t-butyl-1-indolyl, 2-t-butyl-3-indolyl, 4-t-butyl-3-indolyl, pyrrolidine, pyrazolidine, piperazine and groups obtained by converting the above groups into divalent groups.

Among them, preferred are 2-pyridinyl, 1-indolidinyl, 2-indolidinyl, 3-indolidinyl, 5-indolidinyl, 6-indolidinyl, 7-indolidinyl, 8-indolidinyl, 2-imidazo[1,5-a]pyridinyl, 1-imidazo[4,5-a]pyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 1-carbazolyl, 2-carbazolyl, 3-carbazolyl, 4-carbazolyl, 9-carbazolyl and groups obtained by converting the above groups into divalent groups.

The carboxyl-containing group described above includes, for example, an ester bond (—C(═O)O—), methyl ester, ethyl ester, butyl ester and groups obtained by converting the above groups into divalent groups.

The cycloalkyl group and the cycloalkylene group each described above include, for example, cyclopropyl, cyclobutyl, cyclopentyl, cyclohexyl, 4-methylcyclohexyl, 1-adamantyl, 2-adamantyl, 1-norbornyl, 2-norbornyl and groups obtained by converting the above groups into divalent groups.

The alkyl group and the alkylene group each described above have preferably 1 to 10 carbon atoms and include, for example, methyl, ethyl, propyl, isopropyl, n-butyl, s-butyl, isobutyl, t-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, neopentyl, 1-methylpentyl, 2-methylpentyl, 2-pentylhexyl, 1-butylpentyl, 1-heptyloctyl, 3-methylpentyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 1,2-dinitroethyl, 2,3-dinitro-t-butyl, 1,2,3-trinitropropyl, cyclopentyl, cyclohexyl, cyclooctyl, 3,5-tetramethylcyclohexyl and groups obtained by converting the above groups into divalent groups.

Among the above groups, preferred are methyl, ethyl, propyl, isopropyl, n-butyl, s-butyl, isobutyl, t-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, neopentyl, 1-methylpentyl, 1-pentylhexyl, 1-butylpentyl, 1-heptyloctyl, cyclohexyl, cyclooctyl, 3,5-tetramethylcyclohexyl and groups obtained by converting the above groups into divalent groups.

The alkenyl group and the alkenylene group each described above have preferably 2 to 16 carbon atoms and include, for example, vinyl, allyl, 1-butenyl, 2-butenyl, 3-butenyl, 1,3-butadienyl, 1-methylvinyl, styryl, 2,2-diphenylvinyl, 1,2-diphenylvinyl, 1-methylallyl, 1,1-dimethylallyl, 2-methylallyl, 1-phenylallyl, 2-phenylallyl, 3-phenylallyl, 3,3-diphenylallyl, 1,2-dimethylallyl, 1-phenyl-1-butenyl, 3-phenyl-1-butenyl and groups obtained by converting the above groups into divalent groups, and preferred are styryl, 2,2-diphenylvinyl, 1,2-diphenylvinyl group and groups obtained by converting the above groups into divalent groups.

The aralkyl group and the aralkylene group each described above have preferably 7 to 18 carbon atoms and include, for example, benzyl, 1-phenylethyl, 2-phenylethyl, 1-phenylisopropyl, 2-phenylisopropyl, phenyl-t-butyl, α-naphthylmethyl, 1-α-naphthylethyl, 2-α-naphthylethyl, 1-α-naphthylisopropyl, 2-α-naphthylisopropyl, β-naphthylmethyl, 1-β-naphthylethyl, 2-β-naphthylethyl, 1-β-naphthylisopropyl, 2-β-naphthylisopropyl, 1-pyrrolylmethyl, 2-(1-pyrrolyl)ethyl, p-methylbenzyl, m-methylbenzyl, o-methylbenzyl, p-chlorobenzyl, m-chlorobenzyl, o-chlorobenzyl, p-bromobenzyl, m-bromobenzyl, o-bromobenzyl, p-iodobenzyl, m-iodobenzyl, o-iodobenzyl, p-hydroxybenzyl, m-hydroxybenzyl, o-hydroxybenzyl, p-aminobenzyl, m-aminobenzyl, o-aminobenzyl, p-nitrobenzyl, m-nitrobenzyl, o-nitrobenzyl, p-cyanobenzyl, m-cyanobenzyl, o-cyanobenzyl, 1-hydroxy-2-phenylisopropyl, 1-chloro-2-phenylisopropyl and groups obtained by converting the above groups into divalent groups, and preferred are benzyl, p-cyanobenzyl, m-cyanobenzyl, o-cyanobenzyl, 1-phenylethyl, 2-phenylethyl, 1-phenylisopropyl, 2-phenylisopropyl and groups obtained by converting the above groups into divalent groups.

The hydrocarbon group containing amino group or the hydroxyl group each described above includes amino groups having the respective hydrocarbon groups represented by L¹ described above and groups obtained by substituting hydrogen atoms of the hydrocarbon groups described above with hydroxyl groups.

In Formula (1), L¹⁷ and L¹⁸ each independently represent a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁶ and L¹⁷, L¹⁶ and L¹⁸ or L¹⁷ and L¹⁸ are cross-linked, it is a monovalent group of each ligand described above, and when L¹⁶ and L¹⁷ and L¹⁷ and L¹⁸ are cross-linked and when L¹⁶ and L¹⁸ and L¹⁷ and L¹⁸ are cross-linked, it is a divalent group of each ligand described above.

The heterocycle described above includes groups obtained by converting groups in the same examples as given in L¹⁶ described above into groups of zero valence.

The carboxylic acid ester described above includes, for example, methyl formate, ethyl formate, methyl acetate, ethyl acetate, methyl propionate, ethyl propionate, methyl benzoate, ethyl benzoate, methyl 2-pyridinecarboxylate, ethyl 2-pyridinecarboxylate, methyl 3-pyridinecarboxylate, ethyl 3-pyridinecarboxylate, methyl 4-pyridinecarboxylate, ethyl 4-pyridinecarboxylate, methyl phenylacetate, ethyl phenylacetate, methyl 2-pyridinacetate, ethyl 2-pyridinacetate, methyl 3-pyridinacetate, ethyl 3-pyridinacetate, methyl 4-pyridinacetate, ethyl 4-pyridinacetate, methyl 2-pyrrolecarboxylate, methyl 3-pyrrolecarboxylate, methyl 2-thiophenecarboxylate and methyl 3-thiophenecarboxylate.

The carboxylic amide described above includes, for example, N,N-dimethylformamide, N,N-dimethylacetamide, N,N-dimethylbenzoic amide, N,N-dimethyl-2-pyridinecarboxylic amide, N,N-dimethyl-3-pyridinecarboxylic amide, N,N-dimethyl-4-pyridinecarboxylic amide, N,N-dimethyl-phenylacetic amide, N,N-dimethyl-2-pyridineacetic amide, N,N-dimethyl-3-pyridineacetic amide, N,N-dimethyl-4-pyridineacetic amide, N,N-dimethyl-2-pyrrolecarboxylic amide, N,N-dimethyl-3-pyrrolecarboxylic amide, N,N-dimethyl-2-thiophenecarboxylic amide, N,N-dimethyl-3-thiophenecarboxylic amide, N-methylformamide, N-methylacetamide, N-methylbenzoic amide, N-methyl-2-pyridinecarboxylic amide, N-methyl-3-pyridinecarboxylic amide, N-methyl-4-pyridinecarboxylic amide, N-methyl-phenylacetic amide, N-methyl-2-pyridineacetic amide, N-methyl-3-pyridineacetic amide, N-methyl-4-pyridineacetic amide, N-methyl-2-pyrrolecarboxylic amide, N-methyl-3-pyrrolecarboxylic amide, N-methyl-2-thiophenecarboxylic amide, N-methyl-3-thiophenecarboxylic amide, acetamide, benzoic amide, 2-pyridinecarboxylic amide, 3-pyridinecarboxylic amide, 4-pyridinecarboxylic amide, phenylacetic amide, 2-pyridineacetic amide, 3-pyridineacetic amide, 4-pyridineacetic amide, 2-pyrrolecarboxylic amide, 3-pyrrolecarboxylic amide, 2-thiophenecarboxylic amide and 3-thiophenecarboxylic amide.

The amine described above includes, for example, triethylamine, tri-n-propylamine, tri-n-butylamine, N,N-dimethylaniline, methyldiphenylamine, triphenylamine, dimethyl(2-pyridine)amine, dimethyl(3-pyridine)amine, dimethyl(4-pyridine)amine, methylbis(2-pyridine)amine, methylbis(3-pyridine)amine, methylbis(4-pyridine)amine, tris(2-pyridine)amine, tris(3-pyridine)amine, tris(4-pyridine)amine, diisopropylamine, di-n-propylamine, di-n-butylamine, N-methylaniline, methylphenylamine, diphenylamine, methyl(2-pyridine)amine, methyl(3-pyridine)amine, methyl(4-pyridine)amine, methyl(2-pyridine)amine, methyl(3-pyridine)amine, methyl(4-pyridine)amine, bis(2-pyridine)amine, n-propylamine, n-butylamine, aniline, (2-pyridine)amine, (3-pyridine)amine, (4-pyridine)amine, (2-pyridine)amine, (3-pyridine)amine, (4-pyridine)amine, pyridine, 2-methylpyridine, 3-methylpyridine, 4-methylpyridine, 2-trifluoromethylpyridine, 3-trifluoromethylpyridine, 4-trifluoromethylpyridine and N-methylpyrrole.

The phosphine described above includes, for example, phosphines obtained by substituting nitrogen of the amines described above with phosphorus.

The isonitrile described above includes, for example, butylisocyanide, isobutylisocyanide, sec-butylisocyanide, t-butylisocyanide, phenylisocyanide, 2-tolylisocyanide, 3-tolylisocyanide, 4-tolylisocyanide, 2-pyridineisocyanide, 3-pyridineisocyanide, 4-pyridineisocyanide and benzylisocyanide.

The ether described above includes, for example, diethyl ether, di-n-propyl ether, di-n-butyl ether, diisobutyl ether, di-sec-butyl ether, di-t-butyl ether, anisole, diphenyl ether, furan, tetrahydrofuran and dioxane.

The thioether described above includes, for example, thioethers obtained by substituting oxygen of the ethers described above with sulfur.

The double bond-containing compound having 1 to 30 carbon atoms described above includes, for example, ethylene, propylene, 1-butene, 1-pentene, 1-hexene, 1-heptene, 1-octene, 1-nonene, 1-decene, 1-eicosene, 2-butene, 2-pentene, 2-hexene, 2-heptene, 2-octene, 2-nonene, 2-decene, 2-eicosene, 3-hexene, 3-heptene, 3-octene, 3-nonene, 3-decene, 3-eicosene, isobutene, styrene, α-methylstyrene, β-methylstyrene, butadiene, isoprene and stilbene.

In Formula (1), L¹ and L³ each independently represent a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent.

The preferred carbon number and specific examples of the above respective groups include the same examples of the divalent groups as given in L¹⁶ described above.

In Formula (1), L² represents a divalent group having carbene carbon which may have a substituent, such as cyclic diarylcarbene, cyclic diaminocarbene, cyclic aminooxycarbene, cyclic aminothiocarbene and cyclic diborylcarbene (reference document: Chem. Rev. 2000, 100, p. 39).

To be more specific, it includes an (imidazolyl-2-ylidene, N¹, N³) group, a (1,2,4-triazolyl-5-ylidene, N¹, N⁴) group and a (4,5-benzimidazolyl-2-ylidene, N¹, N³) group, and an (imidazolyl-2-ylidene, N¹, N³) group and a (4,5-benzimidazolyl-2-ylidene, N¹, N³) group are preferred.

The structures of L² preferred among them shall be listed in the form of L¹-L²-L³. In the following, Me is methyl, and L¹ and L³ are the same as described above.

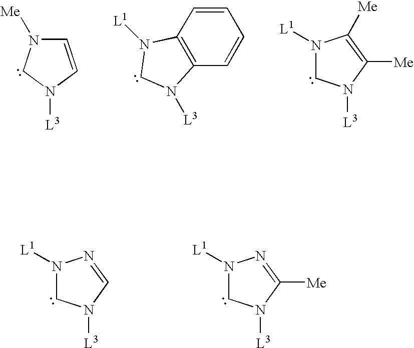

Next, the transition metal complex compound represented by Formula (2) shall be explained.

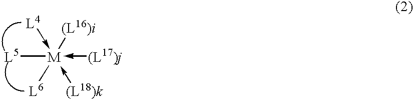

In Formula (2), a bond shown by a solid line (—) represents a covalent bond, and a bond shown by an arrow (→) represents a coordinate bond. L⁴→M represents a metal carbene bond, and M is the same as described above.

In Formula (2), L⁴-L⁵-L⁶ represents a cross-linked tridentate ligand, and L¹⁶, L¹⁷ and L¹⁸ each independently represent a unidentate ligand, a cross-linked bidentate ligand in which two of them are cross-linked or a cross-linked tridentate ligand in which at least two of L¹⁶ and L¹⁷, L¹⁷ and L¹⁸ and L¹⁶ and L¹⁸ are cross-linked. At least one of L⁴, L⁵ and L⁶ may be cross-linked with at least one of L¹⁶, L¹⁷ and L¹⁸; i, j and k each represent an integer of 0 to 1, and 2+i represents a valence of metal M.

In Formula (2), L⁶ each independently represents a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent.

The preferred carbon number and specific examples of the above respective groups include the same examples of the divalent groups as given in L³ of Formula (1).

In Formula (2), L⁵ is a group obtained by removing one hydrogen atom of each group represented by L⁶ described above to make it trivalent, and the preferred carbon number and specific examples thereof include groups obtained by removing one hydrogen atom of the same divalent groups as the examples given in L³ of Formula (1) to make them trivalent.

In Formula (2), L⁴ is a monovalent group having carbene carbon which may have a substituent, a monovalent aromatic hydrocarbon group having 6 to 30 ring carbon atoms which may have a substituent or a monovalent heterocyclic group having 3 to 30 ring carbon atoms which may have a substituent, and at least one of them is a monovalent group having carbene carbon which may have a substituent.

Cyclic diarylcarbene, cyclic diaminocarbene, cyclic aminooxycarbene, cyclic aminothiocarbene and cyclic diborylcarbene can be given as the monovalent group having carbene carbon described above (reference document: Chem. Rev. 2000, 100, p. 39).

To be more specific, it includes an (imidazolyl-2-ylidene, N¹) group which has a substituent on N of a 3-position, a (1,2,4-triazolyl-5-ylidene, N¹) group which has a substituent on N of a 4-position, a (thiazolyl-2-ylidene, N) group, a (4,5-benzimidazolyl-2-ylidene, N¹) group which has a substituent on N of a 3-position and an (imidazo[1,5a]pyridyl-3-ylidene, N²) group.

Among them, preferred are an (imidazolyl-2-ylidene, N¹) group which has a substituent on N of a 3-position, a (4,5-benzimidazolyl-2-ylidene, N¹) group which has a substituent on N of a 3-position and an (imidazo[1,5a]pyridyl-3-ylidene, N²) group, and more preferred are an (imidazolyl-2-ylidene, N¹) group which has a substituent on N of a 3-position and a (4,5-benzimidazolyl-2-ylidene, N¹) group which has a substituent on N of a 3-position.

The structures of L⁴ preferred among them shall be listed in the form of L⁴-L⁵. In the following, Ph is phenyl; Me is methyl; and Et is ethyl. L⁵ is the same as described above.

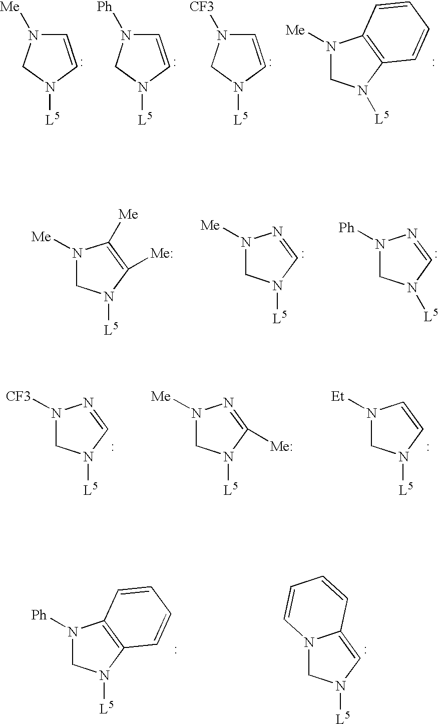

The examples of the aromatic hydrocarbon group and the heterocyclic group each described above include the same examples of the monovalent groups as given in L¹⁶ of Formula (1).

In Formula (2) L¹⁶, L¹⁷ and L¹⁸ are the same as in Formula (1), and the preferred examples of the respective groups include the same ones.

Next, the transition metal complex compound represented by Formula (3) shall be explained.

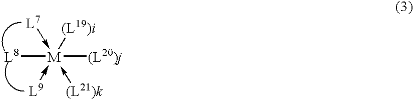

In Formula (3), a bond shown by a solid line (—) represents a covalent bond, and a bond shown by an arrow (→) represents a coordinate bond. M is the same as described above.

In Formula (3), L⁷-L⁸-L⁹ represents a cross-linked tridentate ligand, and L¹⁹, L²⁰ and L²¹ each independently represent a unidentate ligand, a cross-linked bidentate ligand in which two of them are cross-linked or a cross-linked tridentate ligand in which at least two of L¹⁹ and L²⁰, L²⁰ and L²¹ and L¹⁹ and L²¹ are cross-linked. At least one of L⁷, L⁸ and L⁹ may be cross-linked with at least one of L¹⁹, L²⁰ and L²¹; i, j and k each represent an integer of 0 to 1, and 1+i+j represents a valence of metal M.

In Formula (3), L⁸ represents a trivalent aromatic hydrocarbon group having 6 to 30 ring carbon atoms which may have a substituent, a trivalent heterocyclic group having 3 to 30 ring carbon atoms which may have a substituent, a trivalent carboxyl-containing group having 1 to 30 carbon atoms which may have a substituent, a trivalent hydrocarbon group containing amino group or hydroxyl group which may have a substituent, a trivalent cycloalkane moiety having 3 to 50 ring carbon atoms which may have a substituent, a trivalent alkane moiety having 1 to 30 carbon atoms which may have a substituent, a trivalent alkene moiety having 2 to 30 carbon atoms which may have a substituent or a trivalent arylalkane moiety having 7 to 40 carbon atoms which may have a substituent.

The preferred carbon number and specific examples of the above respective groups include groups obtained by removing one hydrogen atom of the same divalent groups as the examples given in L³ of Formula (1) to make them trivalent.

In Formula (3), L⁷ and L⁹ each independently represent a monovalent group having carbene carbon which may have a substituent, a monovalent aromatic hydrocarbon group having 6 to 30 ring carbon atoms which may have a substituent or a monovalent heterocyclic group having 5 to 30 ring carbon atoms which may have a substituent. At least one of L⁷ and L⁹ is a monovalent group having carbene carbon which may have a substituent.

The preferred carbon number and specific examples of the above respective groups include the same monovalent groups as the examples given in L⁴ of Formula (2).

In Formula (3), L¹⁹ and L²⁰ each independently represent a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁹ and L²⁰, L²⁰, and L²¹ or L²⁰ and L²¹ are cross-linked, it is a divalent group of each group described above, and when L¹⁹ and L²⁰ and L¹⁹ and L²¹ are cross-linked and when L¹⁹ and L²⁰ and L²⁰ and L²¹ are cross-linked, it is a trivalent group of each group described above.

The preferred carbon number and specific examples of the above respective groups include the same divalent groups as the examples given in L³ of Formula (1).

In Formula (3), L²¹ represents a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁹ and L²¹ or L²⁰ and L²¹ are cross-linked, it is a monovalent group of each ligand described above, and when L¹⁹ and L²¹ and L²⁰ and L²¹ are cross-linked, it is a divalent group of each ligand described above.

The specific examples of the above respective groups include the same examples as given in L¹⁷ and L¹⁸ of Formula (1).

Next, the transition metal complex compound represented by Formula (4) shall be explained.

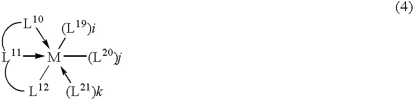

In Formula (4), a bond shown by a solid line (—) represents a covalent bond, and a bond shown by an arrow (→) represents a coordinate bond. L¹⁰→M represents a metal carbene bond, and M is the same as described above.

In Formula (4), L¹⁰-L¹¹-L¹² represents a cross-linked tridentate ligand, and L¹⁹, L²⁰ and L²¹ each independently represent a unidentate ligand, a cross-linked bidentate ligand in which two of them are cross-linked or a cross-linked tridentate ligand in which at least two of L¹⁹ and L²⁰, L²⁰ and L²¹ and L¹⁹ and L²¹ are cross-linked. At least one of L¹⁰, L¹¹ and L¹² may be cross-linked with at least one of L¹⁹, L²⁰ and L²¹; i, j and k each represent an integer of 0 to 1, and 1+i+j represents a valence of metal M.

In Formula (4), L¹² represents a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent.

The preferred carbon number and specific examples of the above respective groups include the same divalent groups as the examples given in L³ of Formula (1).

In Formula (4), L¹¹ represents a monovalent group having carbene carbon which may have a substituent.

The monovalent group having carbene carbon includes the same divalent groups as the examples given in L⁴ of Formula (2).

In Formula (4), L¹¹ represents a divalent aromatic hydrocarbon group having 6 to 30 ring carbon atoms which may have a substituent, a divalent heterocyclic group having 3 to 30 ring carbon atoms which may have a substituent or a divalent group having carbene carbon which may have a substituent.

The preferred carbon number and specific examples of the above respective groups include groups obtained by removing one hydrogen atom of the same monovalent groups as the examples given in L⁴ of Formula (2) to make them divalent.

In Formula (4), L¹⁹, L²⁰ and L²¹ are the same as in Formula (3), and the examples of the respective groups include the same ones.

Next, the transition metal complex compound represented by Formula (5) shall be explained.

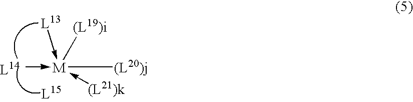

In Formula (5), a bond shown by a solid line (—) represents a covalent bond, and a bond shown by an arrow (→) represents a coordinate bond. L¹⁴ M represents a metal carbene bond, and M is the same as described above.

In Formula (5), L¹³-L¹⁴-L¹⁵ represents a cross-linked tridentate ligand, and L¹⁹, L²⁰ and L²¹ each independently represent a unidentate ligand, a cross-linked bidentate ligand in which two of them are cross-linked or a cross-linked tridentate ligand in which at least two of L¹⁹ and L²⁰, L²⁰ and L²¹ and L¹⁹ and L²¹ are cross-linked. At least one of L¹³, L¹⁴ and L¹⁵ may be cross-linked with at least one of L¹⁹, L²⁰ and L²¹; i, j and k each represent an integer of 0 to 1, and 1+i+j represents a valence of metal M.

In Formula (5), L¹⁵ represents a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent.

The preferred carbon number and specific examples of the above respective groups include the same divalent groups as the examples given in L³ of Formula (1).

In Formula (5), L¹⁴ represents a divalent group having carbene carbon which may have a substituent.

The divalent group having carbene carbon includes the same divalent groups as the examples given in L² of Formula (1).

In Formula (5), L¹³ represents a monovalent aromatic hydrocarbon group having 6 to 30 ring carbon atoms which may have a substituent, a monovalent heterocyclic group having 3 to 30 ring carbon atoms which may have a substituent or a monovalent group having carbene carbon which may have a substituent.

The preferred carbon number and specific examples of the above respective groups include the same monovalent groups as the examples given in L⁴ of Formula (2).

In Formula (5), L¹⁹, L²⁰ and L²¹ are the same as in Formula (3), and the examples of the respective groups include the same ones.

A L¹L²L³M part in Formula (6) has preferably a structure represented by the following Formula (6):

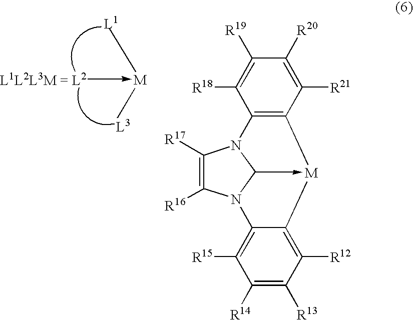

In Formula (6), R¹² to R²¹ each independently represent a hydrogen atom, a halogen atom, a thiocyano group or a cyano group, a nitro group, a —S(═O)₂R′ group or a —S(═O)R′ group, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 30 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 ring carbon atoms which may have a substituent, an arylamino group having 6 to 30 carbon atoms which may have a substituent, an alkylsilyl group having 3 to 30 ring carbon atoms which may have a substituent, an arylsilyl group having 6 to 30 carbon atoms which may have a substituent or a carboxyl-containing group having 1 to 30 carbon atoms, and they may be cross-linked.

(R′ each independently represents a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 50 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent).

The alkyl group described above has preferably 1 to 10 carbon atoms and includes, for example, methyl, ethyl, propyl, isopropyl, n-butyl, s-butyl, isobutyl, t-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, neopentyl, 1-methylpentyl, 2-methylpentyl, 1-pentylhexyl, 1-butylpentyl, 1-heptyloctyl, 3-methylpentyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 1,2-dinitroethyl, 2,3-dinitro-t-butyl, 1,2,3-trinitropropyl, cyclopentyl, cyclohexyl, cyclooctyl and 3,5-tetramethylcyclohexyl.

Among the above groups, preferred are methyl, ethyl, propyl, isopropyl, n-butyl, s-butyl, isobutyl, t-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, neopentyl, 1-methylpentyl, 1-pentylhexyl, 1-butylpentyl, 1-heptyloctyl, cyclohexyl, cyclooctyl and 3,5-tetramethylcyclohexyl.

The halogenated alkyl group described above has preferably 1 to 10 carbon atoms and includes, for example, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl group, 2-iodoethyl, 2-iodoisobutyl, 1,2-diiodoethyl, 1,3-diiodoisopropyl, 2,3-diiodo-t-butyl, 1,2,3-triiodopropyl, fluoromethyl, 1-fluoromethyl, 2-fluoromethyl, 2-fluoroisobutyl, 1,2-difluoroethyl, difluoromethyl, trifluoromethyl, pentafluoroethyl, perfluoroisopropyl, perfluorobutyl and perfluorocyclohexyl.

Among the above groups, preferred are fluoromethyl, trifluoromethyl, pentafluoroethyl, perfluoroisopropyl, perfluorobutyl and perfluorocyclohexyl.

The aromatic hydrocarbon group described above has preferably 6 to 18 ring carbon atoms and includes, for example, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl-4-yl, p-terphenyl-3-yl, p-terphenyl-2-yl, m-terphenyl-4-yl, m-terphenyl-3-yl, m-terphenyl-2-yl, o-tolyl, m-tolyl, p-tolyl, p-t-butylphenyl, p-(2-phenylpropyl)phenyl, 3-methyl-2-naphthyl, 4-methyl-l-naphthyl, 4-methyl-1-anthryl, 4′-methylbiphenylyl, 4″-t-butyl-p-terphenyl-4-yl, o-cumenyl, m-cumenyl, p-cumenyl, 2,3-xylylenyl, 3,4-xylylenyl, 2,5-xylylenyl, mesitylenyl and perfluorophenyl.

Among them, preferred are phenyl, 1-naphthyl, 2-naphthyl, 9-phenanthryl, 2-biphenylyl, 3-biphenylyl, 4-biphenylyl, p-tolyl and 3,4-xylylenyl.

The cycloalkyl group described above includes, for example, cyclopropyl, cyclobutyl, cyclopentyl, cyclohexyl, 4-methylcyclohexyl, 1-adamantyl, 2-adamantyl, 1-norbornyl and 2-norbornyl.

The aralkyl group described above has preferably 7 to 18 carbon atoms and includes, for example, benzyl, 1-phenylethyl, 2-phenylethyl, 1-phenylisopropyl, 2-phenylisopropyl, phenyl-t-butyl, α-naphthylmethyl, 1-α-naphthylethyl, 2-α-naphthylethyl, 1-α-naphthylisopropyl, 2-α-naphthylisopropyl, β-naphthylmethyl, 1-β-naphthylethyl, 2-β-naphthylethyl, 1-β-naphthylisopropyl, 2-β-naphthylisopropyl, 1-pyrrolylmethyl, 2-(1-pyrrolyl)ethyl, p-methylbenzyl, m-methylbenzyl, o-methylbenzyl, p-chlorobenzyl, m-chlorobenzyl, o-chlorobenzyl, p-bromobenzyl, m-bromobenzyl, o-bromobenzyl, p-iodobenzyl, m-iodobenzyl, o-iodobenzyl, p-hydroxybenzyl, m-hydroxybenzyl, o-hydroxybenzyl, p-aminobenzyl, m-aminobenzyl, o-aminobenzyl, p-nitrobenzyl, m-nitrobenzyl, o-nitrobenzyl, p-cyanobenzyl, m-cyanobenzyl, o-cyanobenzyl, 1-hydroxy-2-phenylisopropyl and 1-chloro-2-phenylisopropyl, and preferred are benzyl, p-cyanobenzyl, m-cyanobenzyl, o-cyanobenzyl, 1-phenylethyl, 2-phenylethyl, 1-phenylisopropyl and 2-phenylisopropyl.

The alkenyl group described above has preferably 2 to 16 carbon atoms and includes, for example, vinyl, allyl, 1-butenyl, 2-butenyl, 3-butenyl, 1,3-butadienyl, 1-methylvinyl, styryl, 2,2-diphenylvinyl, 1,2-diphenylvinyl, 1-methylallyl, 1,1-dimethylallyl, 2-methylallyl, 1-phenylallyl, 2-phenylallyl, 3-phenylallyl, 3,3-diphenylallyl, 1,2-dimethylallyl, 1-phenyl-l-butenyl and 3-phenyl-1-butenyl, and styryl, 2,2-diphenylvinyl and 1,2-diphenylvinyl are preferred.

The heterocyclic group described above has preferably 3 to 18 ring carbon atoms and includes, for example, 1-pyrrolyl, 2-pyrrolyl, 3-pyrrolyl, pyrazinyl, 2-pyridinyl, 1-imidazolyl, 2-imidazolyl, 1-pyrazolyl, 1-indolidinyl, 2-indolidinyl, 3-indolidinyl, 5-indolidinyl, 6-indolidinyl, 7-indolidinyl, 8-indolidinyl, 2-imidazo[1,5-a]pyridinyl, 1-imidazo[4,5-a]pyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 9-carbazolyl, β-carboline-1-yl, β-carboline-3-yl, β-carboline-4-yl, β-carboline-5-yl, β-carboline-6-yl, β-carboline-7-yl, β-carboline-6-yl, β-carboline-9-yl, 1-phenanthridinyl, 2-phenanthridinyl, 3-phenanthridinyl, 4-phenanthridinyl, 6-phenanthridinyl, 7-phenanthridinyl, 8-phenanthridinyl, 9-phenanthridinyl, 10-phenanthridinyl, 1-acridinyl, 2-acridinyl, 3-acridinyl, 4-acridinyl, 9-acridinyl, 1,7-phenanthroline-2-yl, 1,7-phenanthroline-3-yl, 1,7-phenanthroline-4-yl, 1,7-phenanthroline-5-yl, 1,7-phenanthroline-6-yl, 1,7-phenanthroline-8-yl, 1,7-phenanthroline-9-yl, 1,7-phenanthroline-10-yl, 1,8-phenanthroline-2-yl, 1,8-phenanthroline-3-yl, 1,8-phenanthroline-4-yl, 1,8-phenanthroline-5-yl, 1,8-phenanthroline-6-yl, 1,8-phenanthroline-7-yl, 1,8-phenanthroline-9-yl, 1,8-phenanthroline-10-yl, 1,9-phenanthroline-2-yl, 1,9-phenanthroline-3-yl, 1,9-phenanthroline-4-yl, 1,9-phenanthroline-5-yl, 1,9-phenanthroline-6-yl, 1,9-phenanthroline-7-yl, 1,9-phenanthroline-8-yl, 1,9-phenanthroline-10-yl, 1,10-phenanthroline-2-yl, 1,10-phenanthroline-3-yl, 1,10-phenanthroline-4-yl, 1,10-phenanthroline-5-yl, 2,9-phenanthroline-1-yl, 2,9-phenanthroline-3-yl, 2,9-phenanthroline-4-yl, 2,9-phenanthroline-5-yl, 2,9-phenanthroline-6-yl, 2,9-phenanthroline-7-yl, 2,9-phenanthroline-8-yl, 2,9-phenanthroline-10-yl, 2,8-phenanthroline-1-yl, 2,8-phenanthroline-3-yl, 2,8-phenanthroline-4-yl, 2,8-phenanthroline-5-yl, 2,8-phenanthroline-6-yl, 2,8-phenanthroline-7-yl, 2,8-phenanthroline-9-yl, 2,8-phenanthroline-10-yl, 2,7-phenanthroline-1-yl, 2,7-phenanthroline-3-yl, 2,7-phenanthroline-4-yl, 2,7-phenanthroline-5-yl, 2,7-phenanthroline-6-yl, 2,7-phenanthroline-8-yl, 2,7-phenanthroline-9-yl, 2,7-phenanthroline-10-yl, 1-phenazinyl, 2-phenazinyl, 1-phenothiazinyl, 2-phenothiazinyl, 3-phenothiazinyl, 4-phenothiazinyl, 10-phenothiazinyl, 1-phenoxazinyl, 2-phenoxazinyl, 3-phenoxazinyl, 4-phenoxazinyl, 10-phenoxazinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrole-1-yl, 2-methylpyrrole-3-yl, 2-methylpyrrole-4-yl, 2-methyl-pyrrole-5-yl, 3-methylpyrrole-1-yl, 3-methylpyrrole-2-yl, 3-methylpyrrole-4-yl, 3-methylpyrrole-5-yl, 2-t-butylpyrrole-4-yl, 3-(2-phenylpropyl)pyrrole-1-yl, 2-methyl-1-indolyl, 4-methyl-1-indolyl, 2-methyl-3-indolyl, 4-methyl-3-indolyl, 2-t-butyl-1-indolyl, 4-t-butyl-1-indolyl, 2-t-butyl-3-indolyl, 4-t-butyl-3-indolyl, pyrrolidine, pyrazolidine and piperazine.

Among them, preferred are 2-pyridinyl, 1-indolidinyl, 2-indolidinyl, 3-indolidinyl, 5-indolidinyl, 6-indolidinyl, 7-indolidinyl, 8-indolidinyl, 2-imidazo[1,5-a]pyridinyl, 1-imidazo[4,5-a]pyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 1-carbazolyl, 2-carbazolyl, 3-carbazolyl, 4-carbazolyl and 9-carbazolyl.

The alkoxy group and the aryloxy group each described above are groups represented by —OX¹, and the examples of X¹ include the same groups as explained in the alkyl group, the halogenated alkyl group and the aryl group each described above.

The alkylamino group and the arylamino group each described above are groups represented by —NX¹X², and the examples of X¹ and X² include the same groups as explained in the alkyl group, the halogenated alkyl group and the aryl group each described above.

The carboxyl-containing group described above includes, for example, methyl ester, ethyl ester and butyl ester.

The alkylsilyl group described above includes, for example, trimethylsilyl, triethylsilyl, t-butyldimethylsilyl, vinyldimethylsilyl and propyldimethylsilyl.

The arylsilyl group described above includes, for example, triphenylsilyl, phenyldimethylsilyl and t-butyldiphenylsilyl.

The ring structure formed by cross-linking R¹² to R²¹ includes the same examples as given in the heterocyclic group described above.

The specific examples of the L¹L²L³M part in Formula (1) are preferably the following structures:

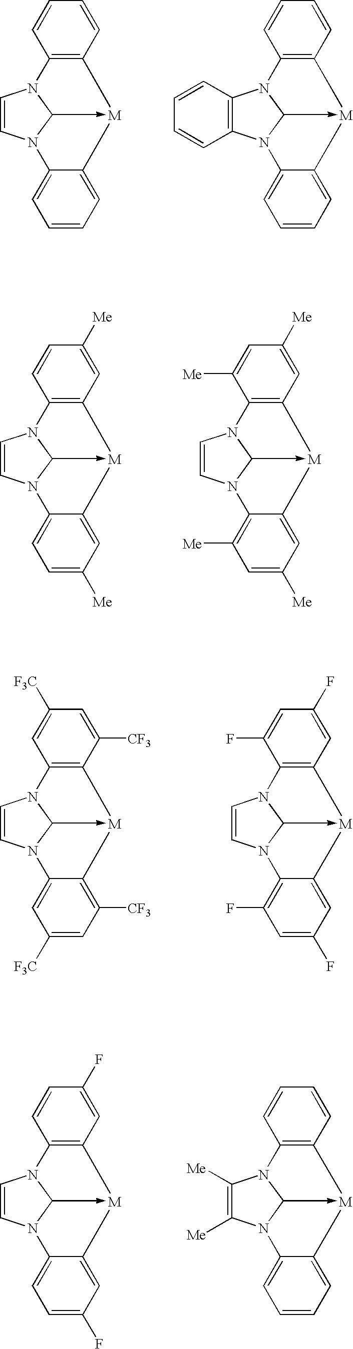

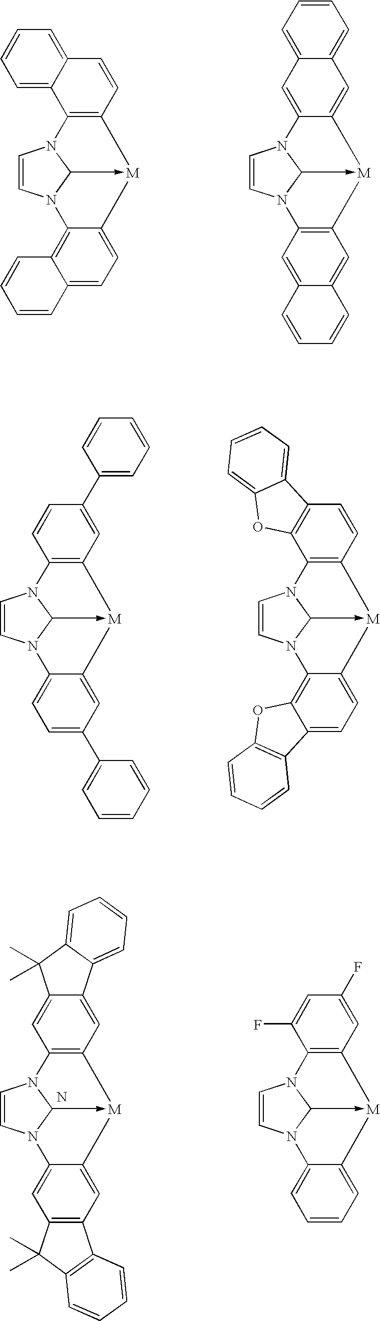

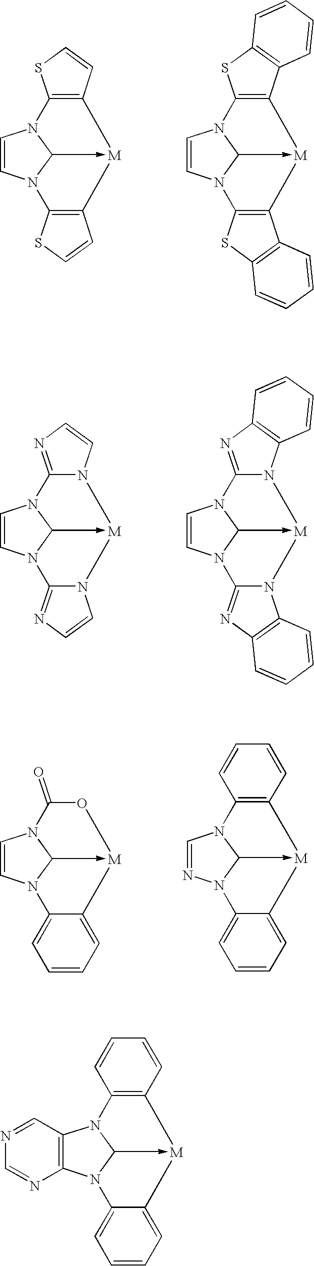

A L⁴L⁵L⁶M part in Formula (2) has preferably a structure represented by the following Formula (7):

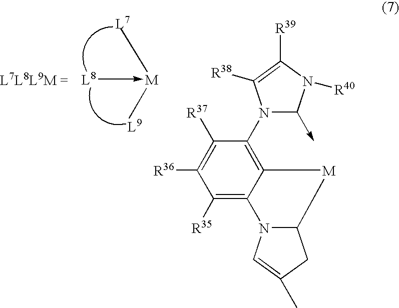

In Formula (7), R²² to R³¹ each are independently the same as R¹² to R²¹ in Formula (6) and include the same specific examples.

The specific examples of the L⁴L⁵L⁶M part in Formula (2) are preferably the following structures:

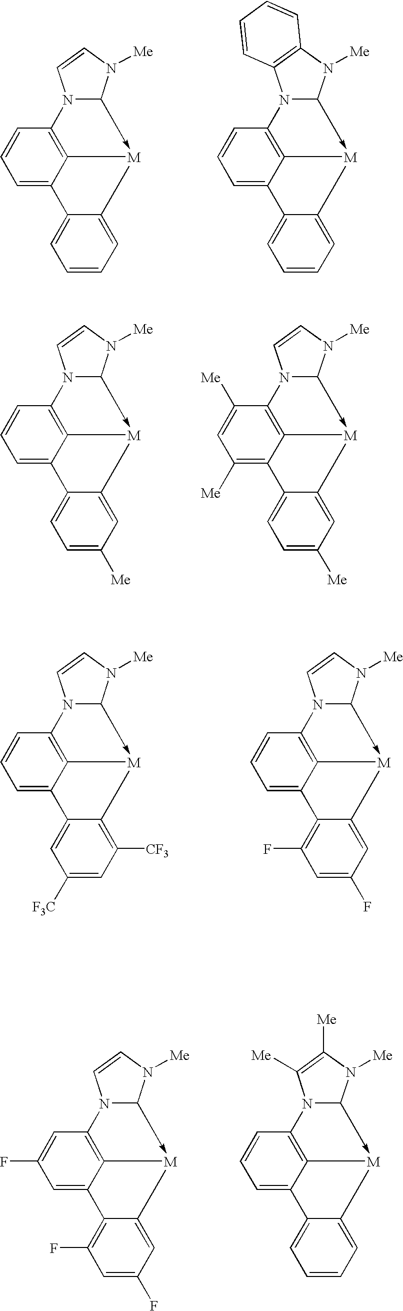

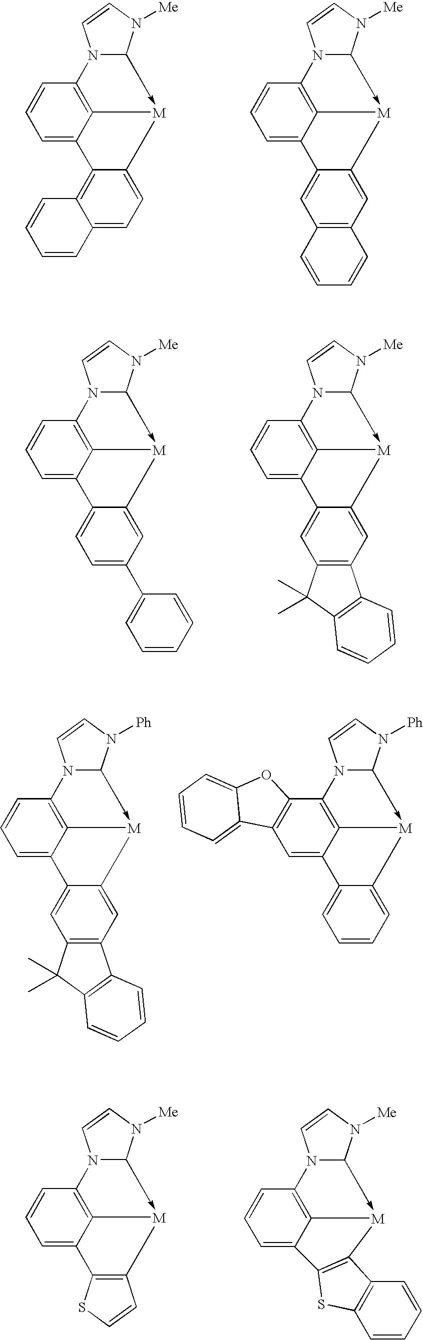

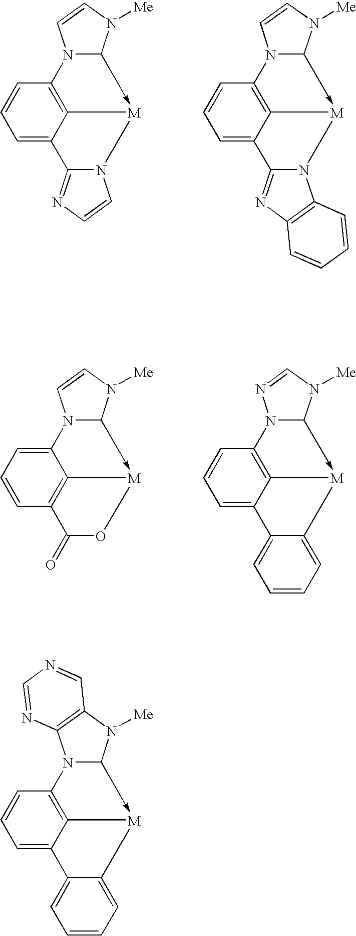

A L⁷L⁸L⁹M part in Formula (3) has preferably a structure represented by the following Formula (8) or (9):

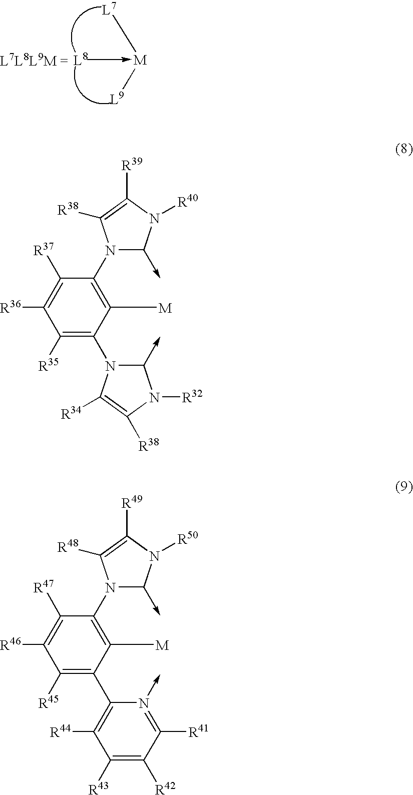

In Formulas (8) and (9), R³² to R⁵⁰ each are independently the same as R¹² to R²¹ in Formula (6) and include the same specific examples.

The specific examples of the L⁷L⁸L⁹M part in Formula (3) are preferably the following structures:

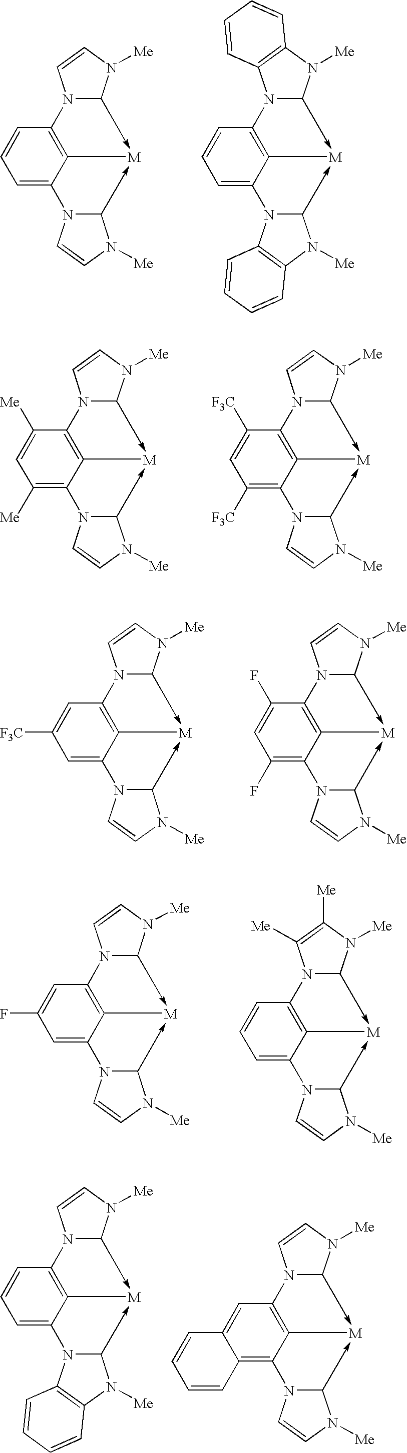

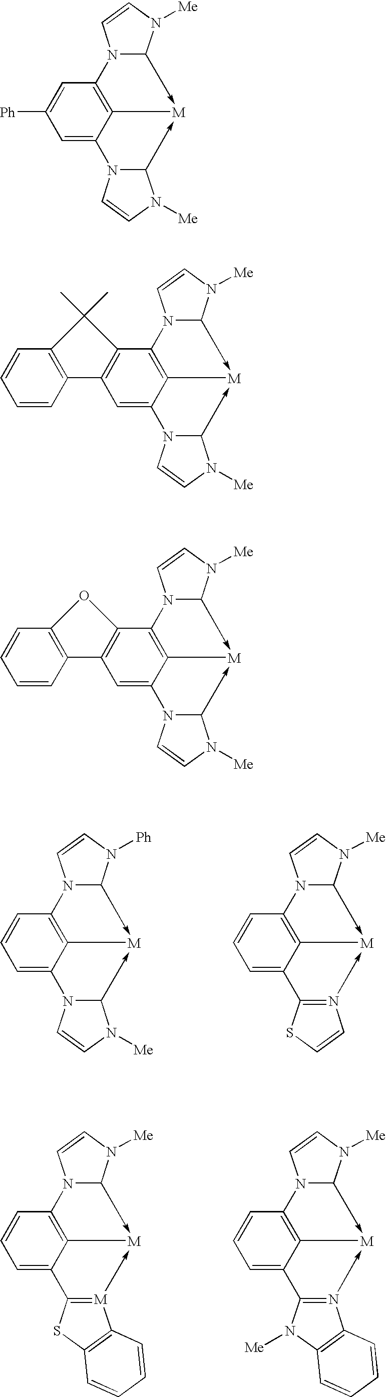

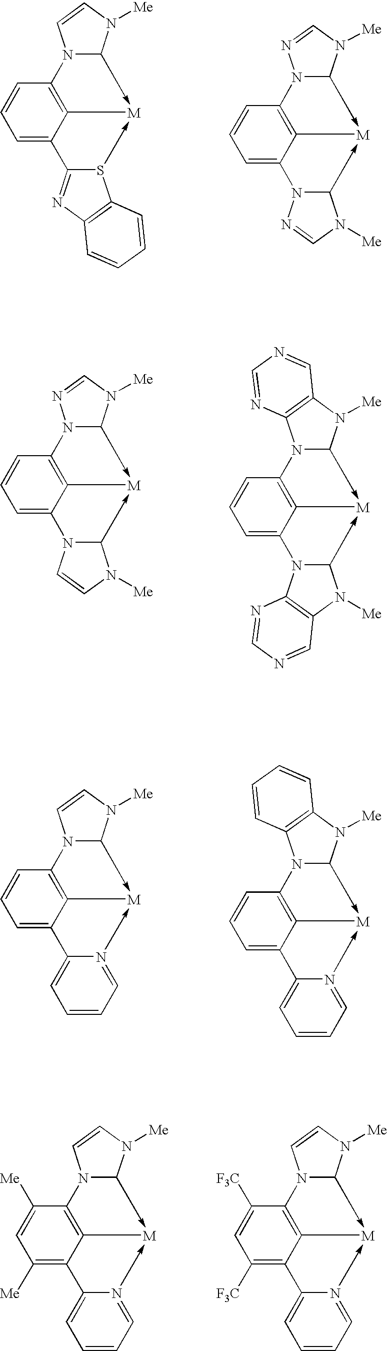

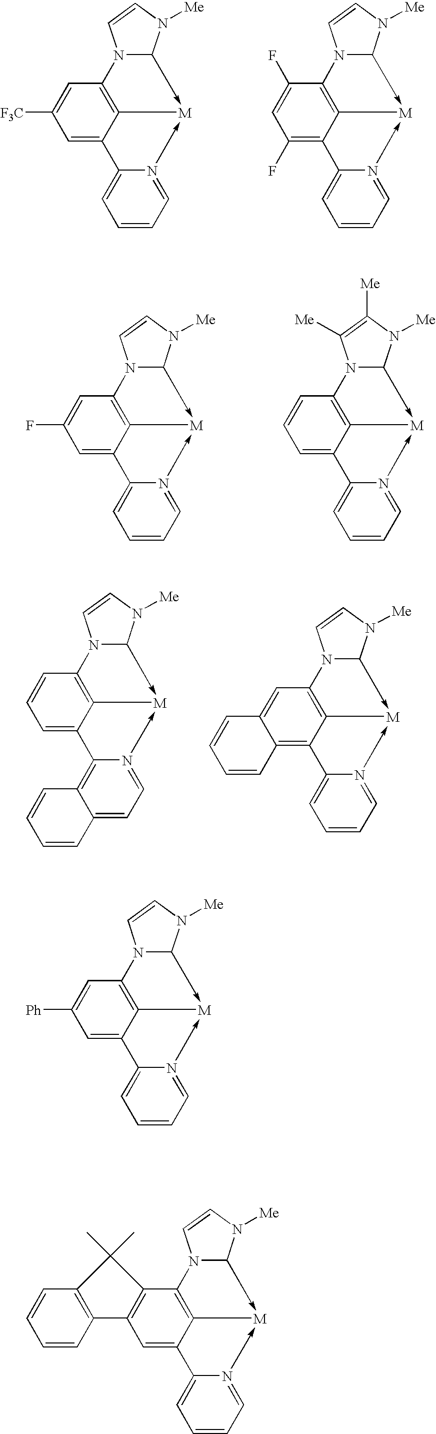

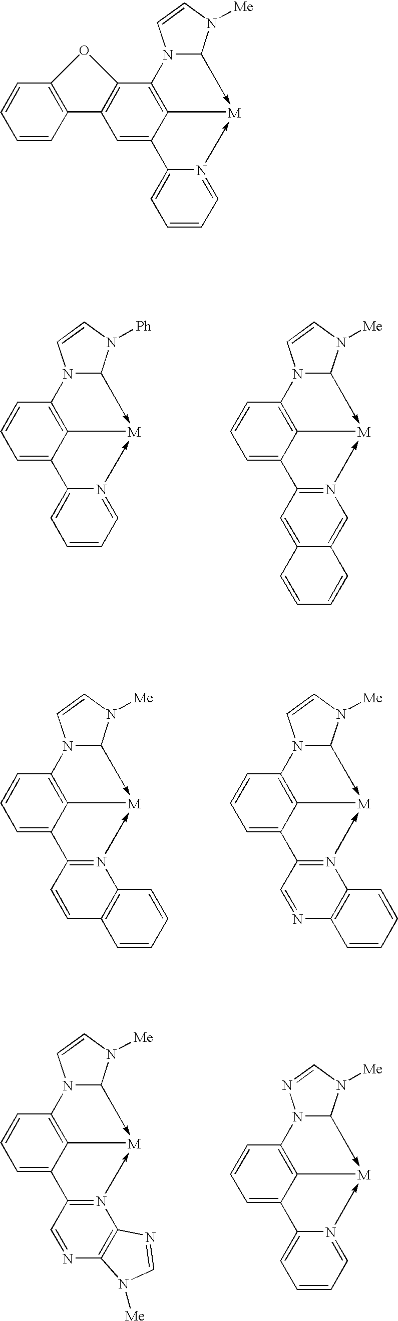

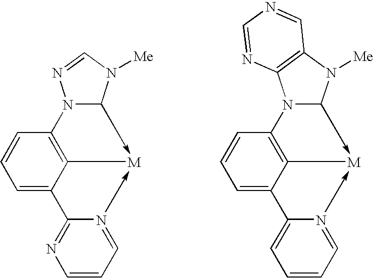

A L¹⁰L¹¹L¹²M part in Formula (4) has preferably a structure represented by the following Formula (10):

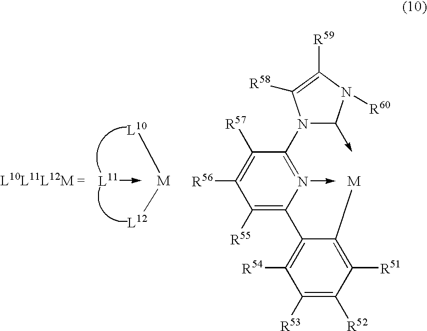

In Formula (10), R⁵¹ to R⁶⁰ each are independently the same as R¹² to R²¹ in Formula (6) and include the same specific examples.

The specific examples of the L¹⁰L¹¹L¹²M part in Formula (4) are preferably the following structures:

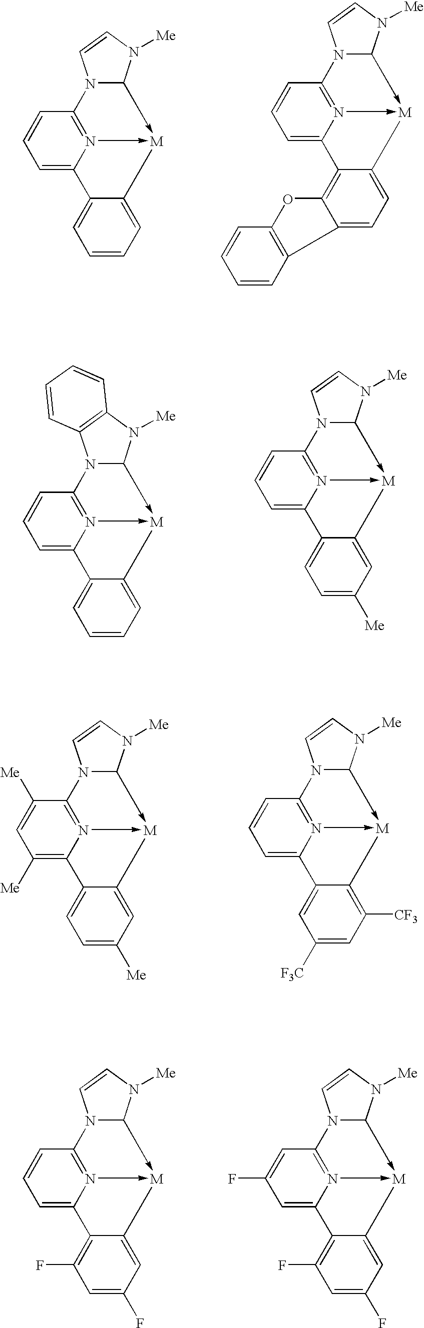

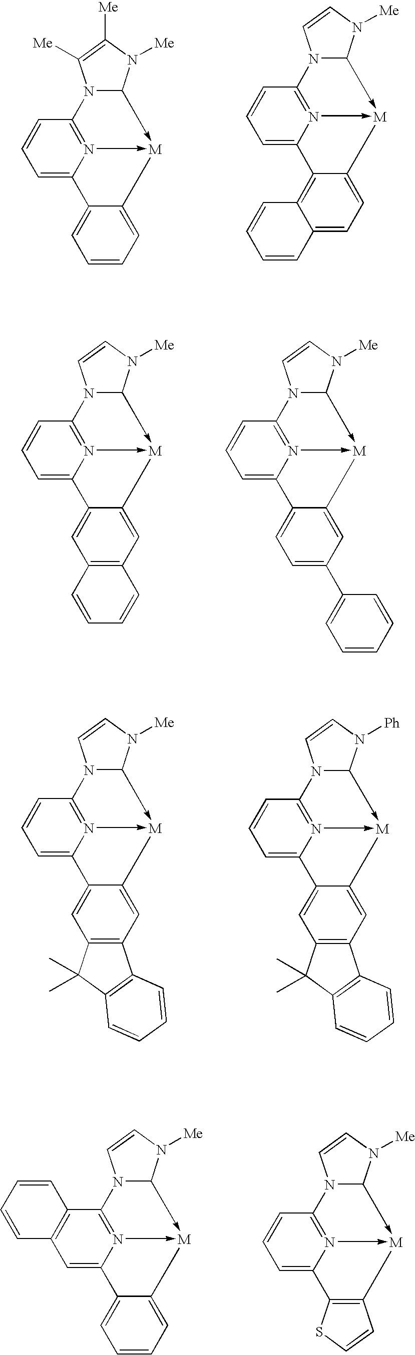

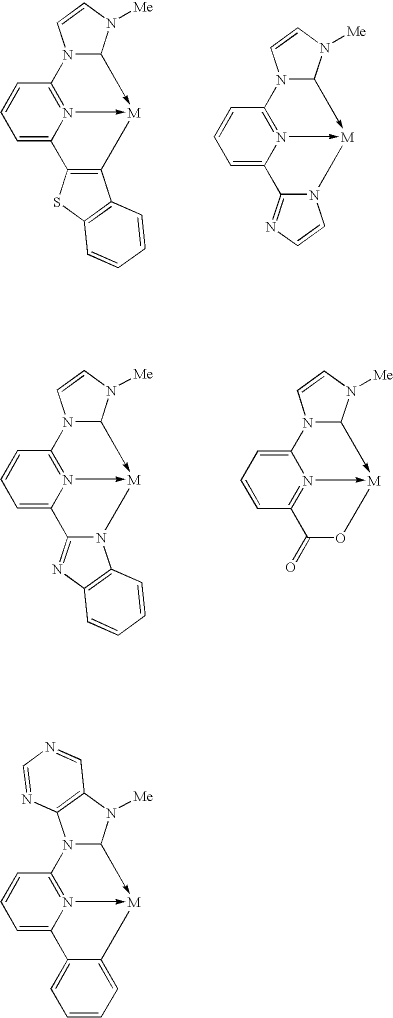

A L¹³L¹⁴L¹⁵M part in Formula (5) has preferably a structure represented by the following Formula (11):

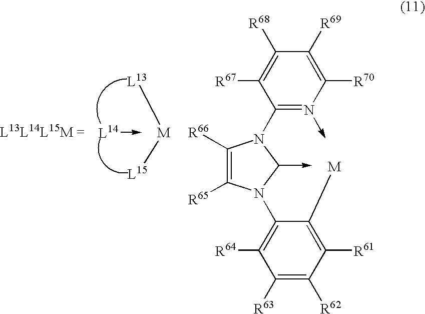

In Formula (11), R⁶¹ to R⁷⁰ each are independently the same as R¹² to R²¹ in Formula (6) and include the same specific examples.

The specific examples of the L¹³L¹⁴L¹⁵M part in Formula (5) are preferably the following structures:

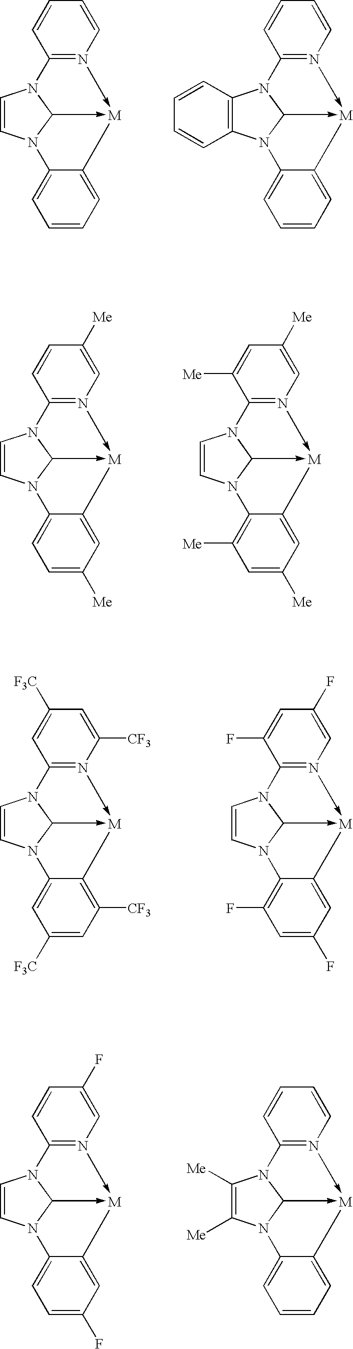

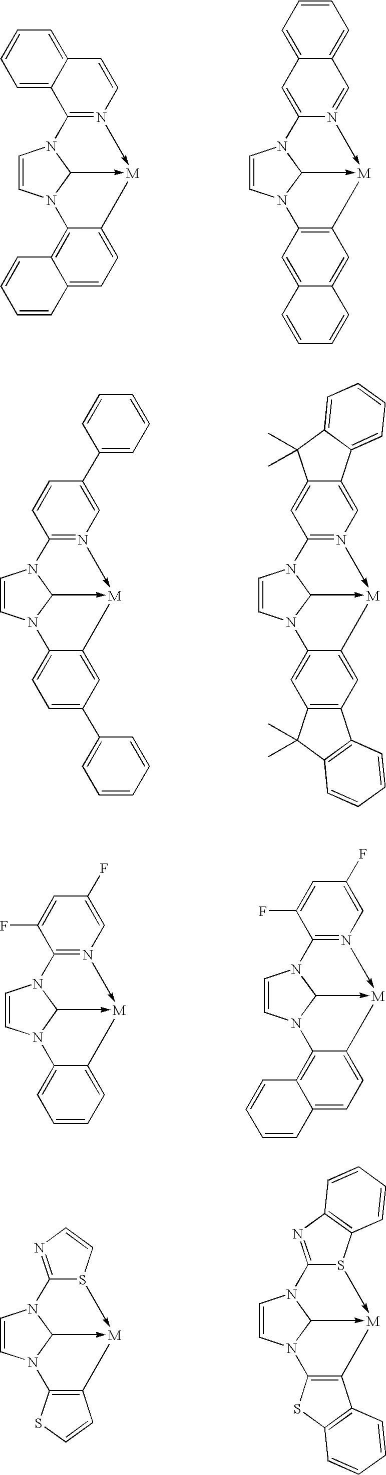

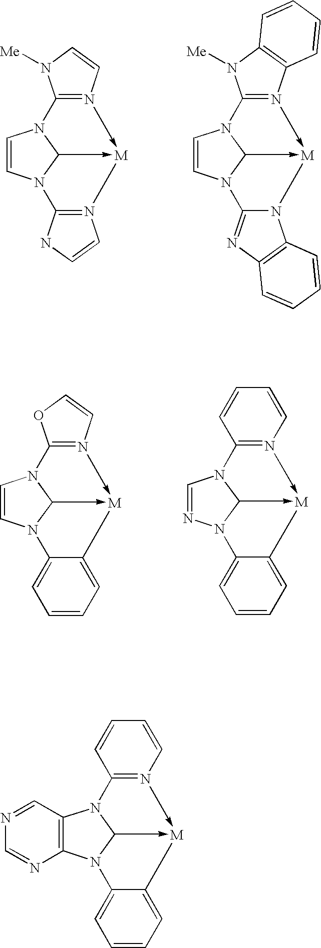

A M(L¹⁶)ᵢ(L¹⁷)ⱼ(L¹⁸)ₖ part in Formula (1) and Formula (2) each preferably has independently a structure represented by the following Formula (12), (13) or (14):
M (L¹⁶)ᵢ(L¹⁷)ⱼ(L¹⁸)

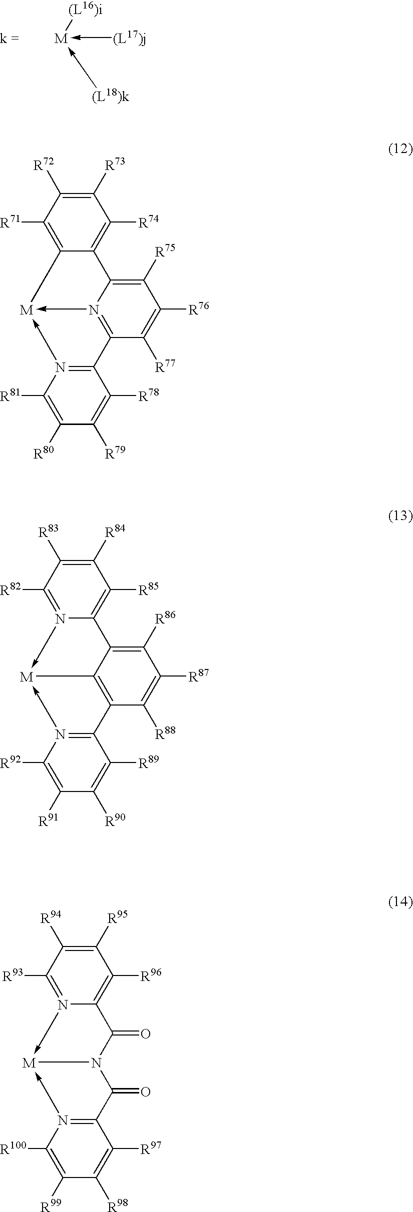

In Formulas (12) to (14), R⁷¹ to R¹⁰⁰ each are independently the same as R¹² to R²¹ in Formula (6) and include the same specific examples.

The specific examples of the M(L¹⁶)ᵢ(L¹⁷)ⱼ(L¹⁸) k part in Formula (1) and Formula (2) are preferably the following structures:

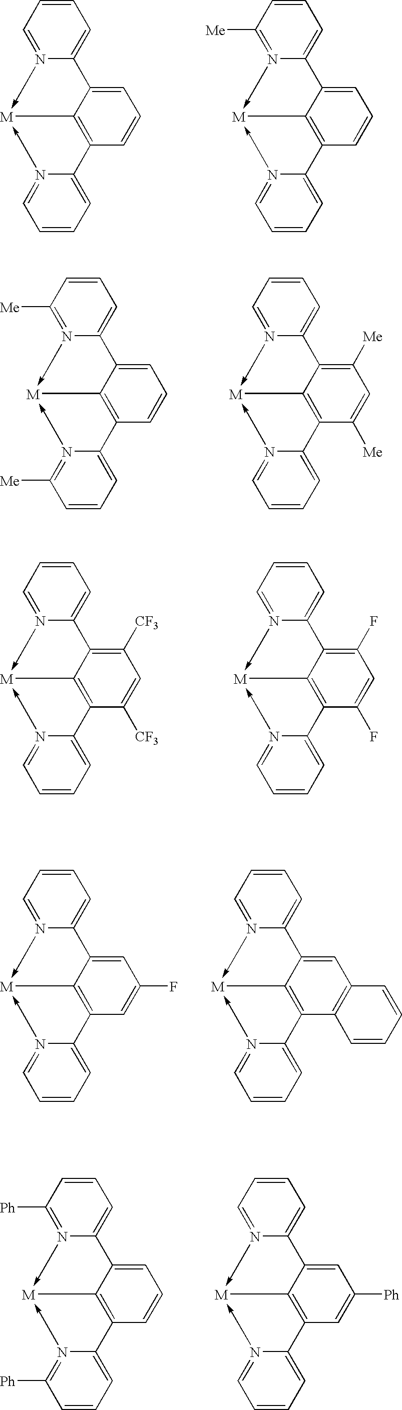

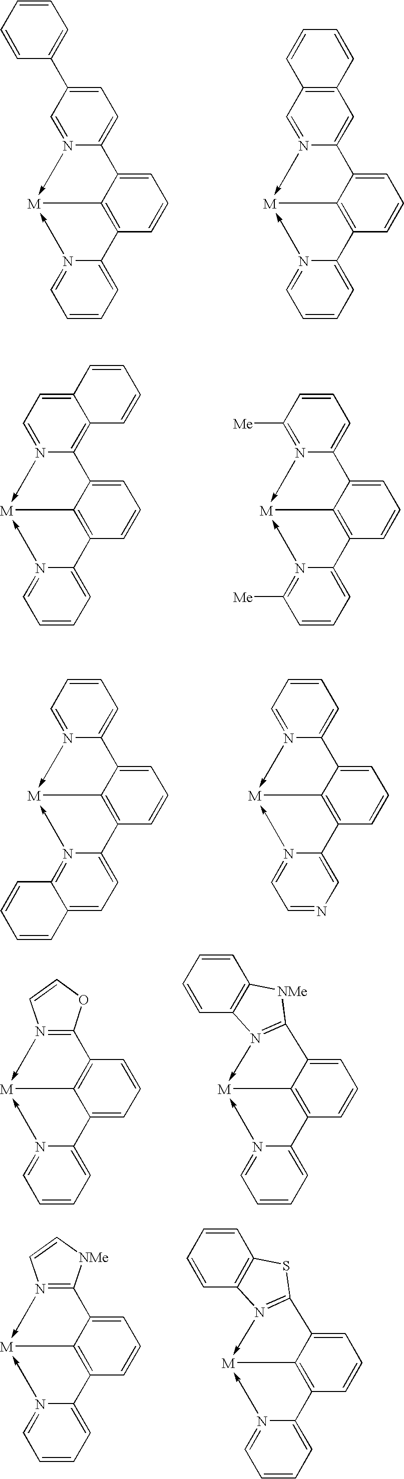

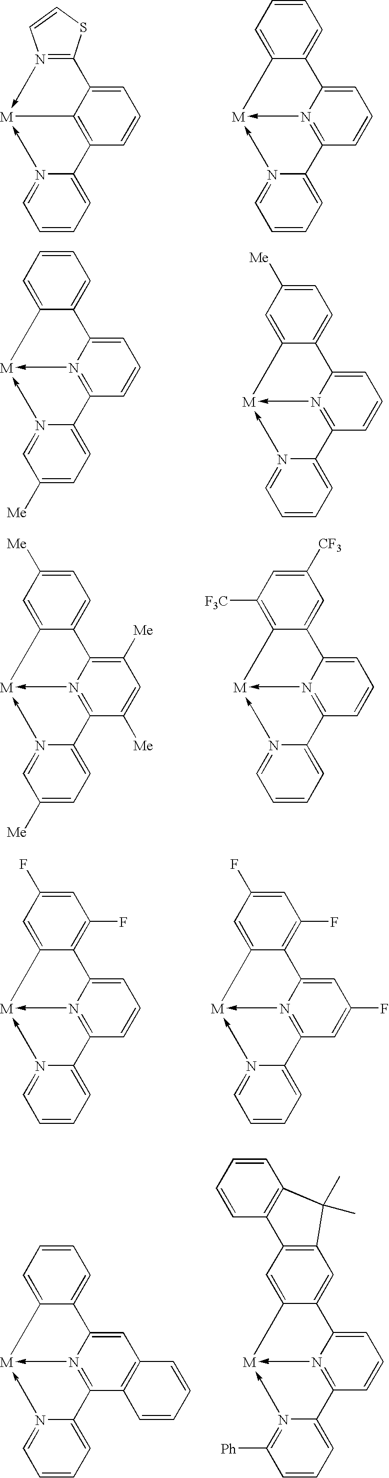

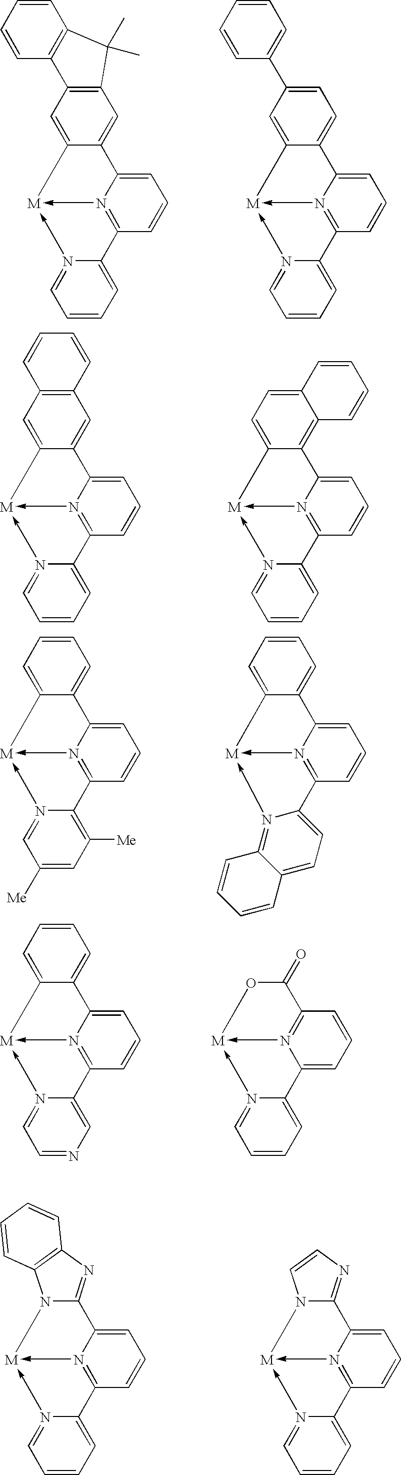

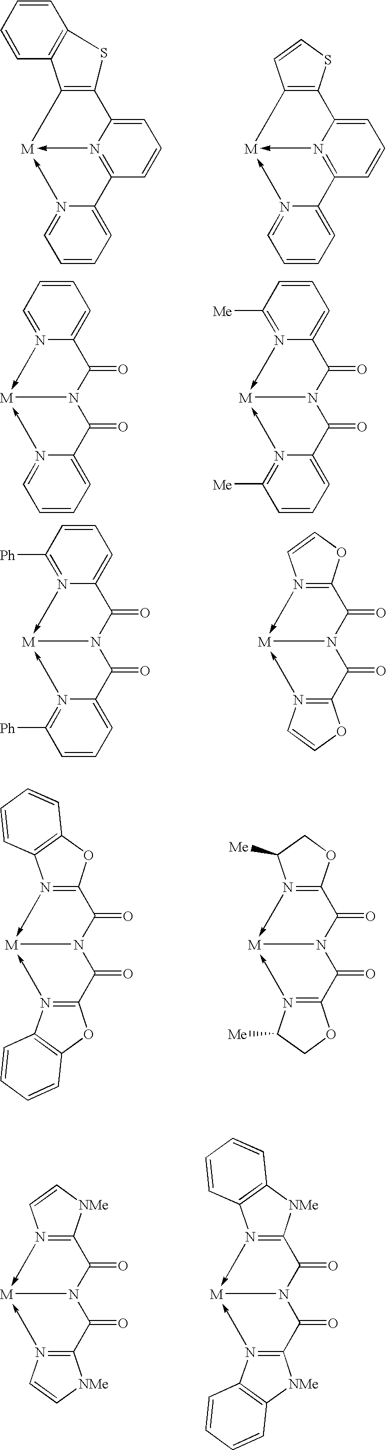

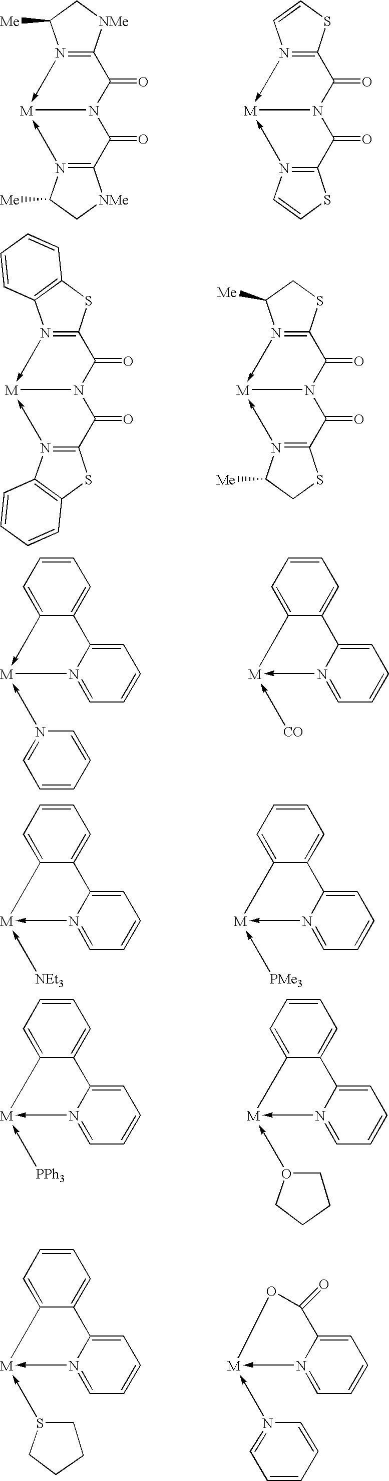

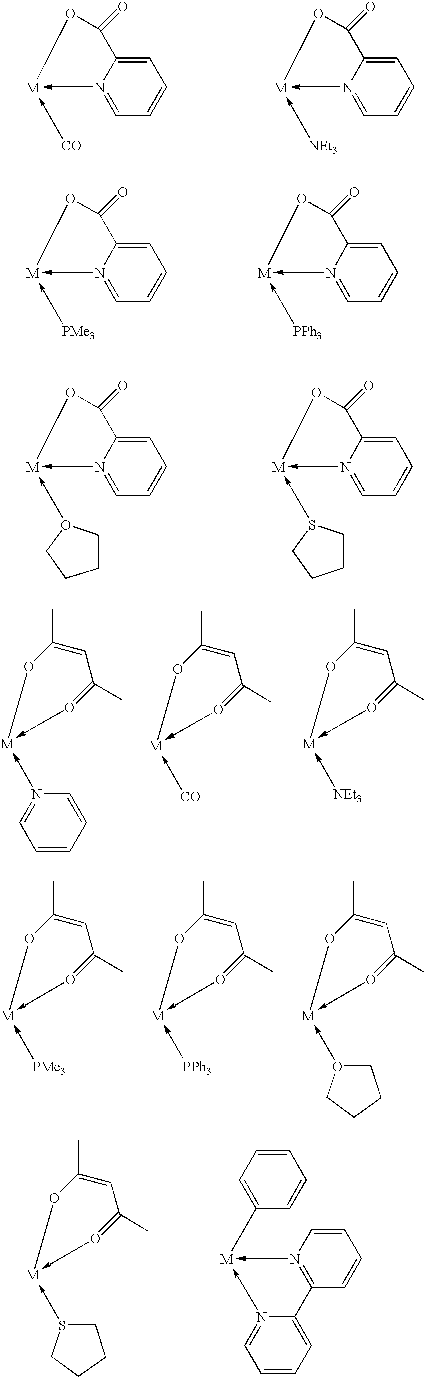

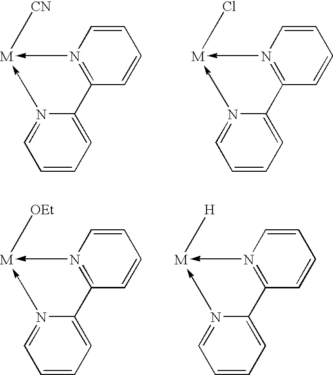

A M(L¹⁹)ᵢ(L²⁰)ⱼ(L²¹)ₖ part in Formula (4) and Formula (5) each preferably has independently a structure represented by the following Formula (15), (16), (17) or (18):
M (L¹⁹)ᵢ(L²⁰)ⱼ(L²¹)

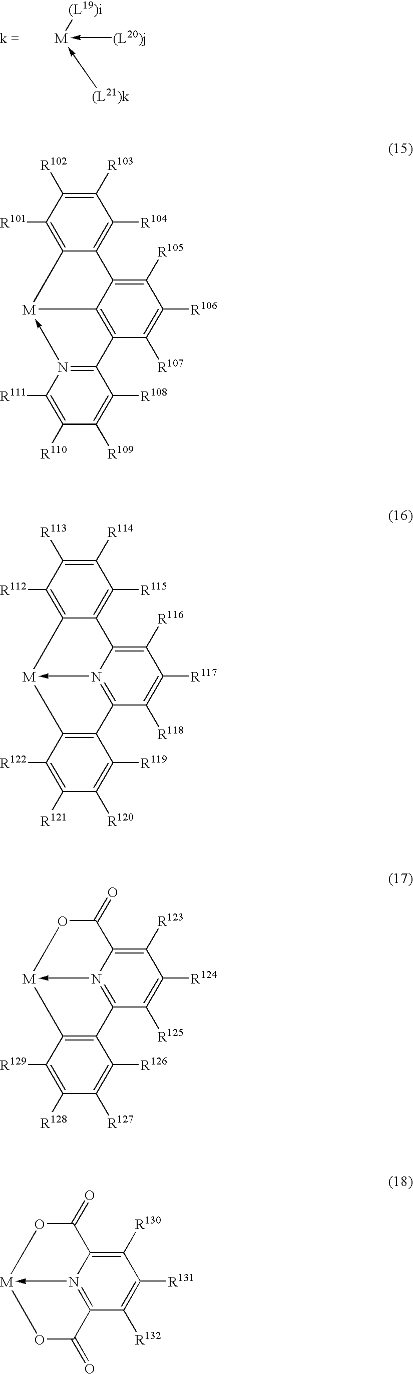

In Formulas (15) to (18), R¹⁰¹ to R¹³² each are independently the same as R¹² to R²¹ in Formula (6) and include the same specific examples.

The specific examples of the M(L¹⁹)ᵢ(L²⁰)ⱼ(L²¹)ₖ part in Formula (4) and Formula (5) are preferably the following structures:

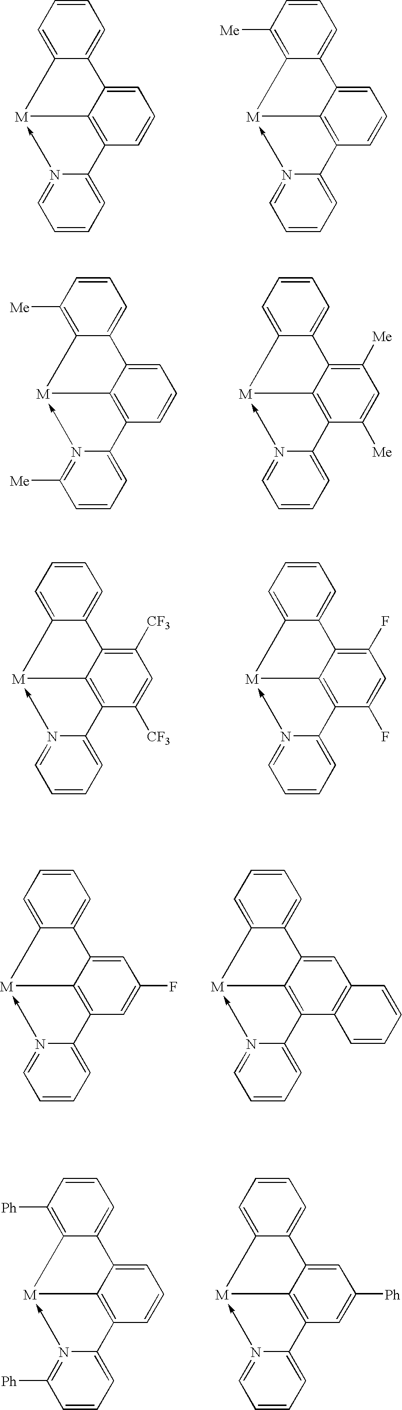

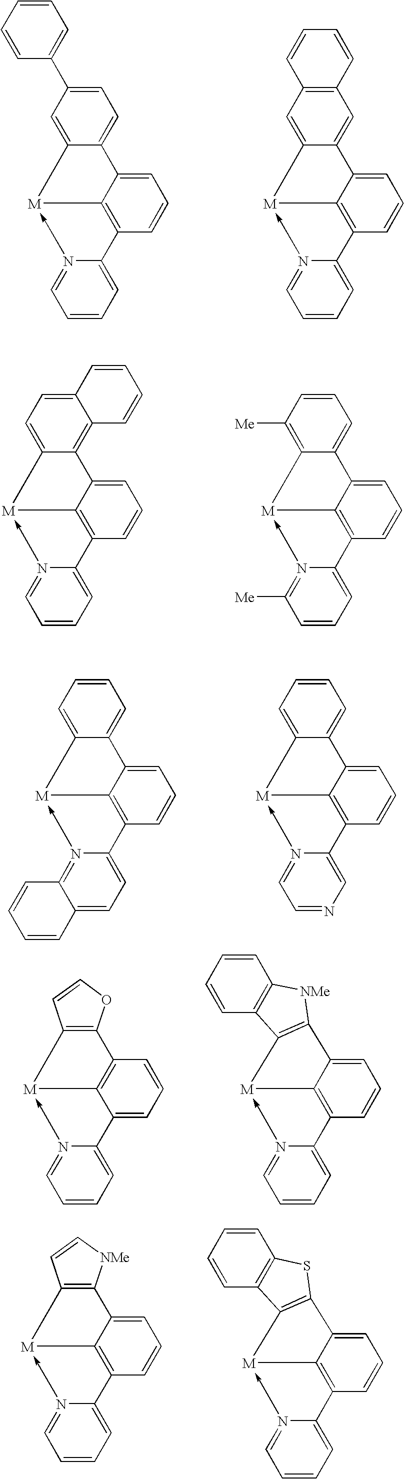

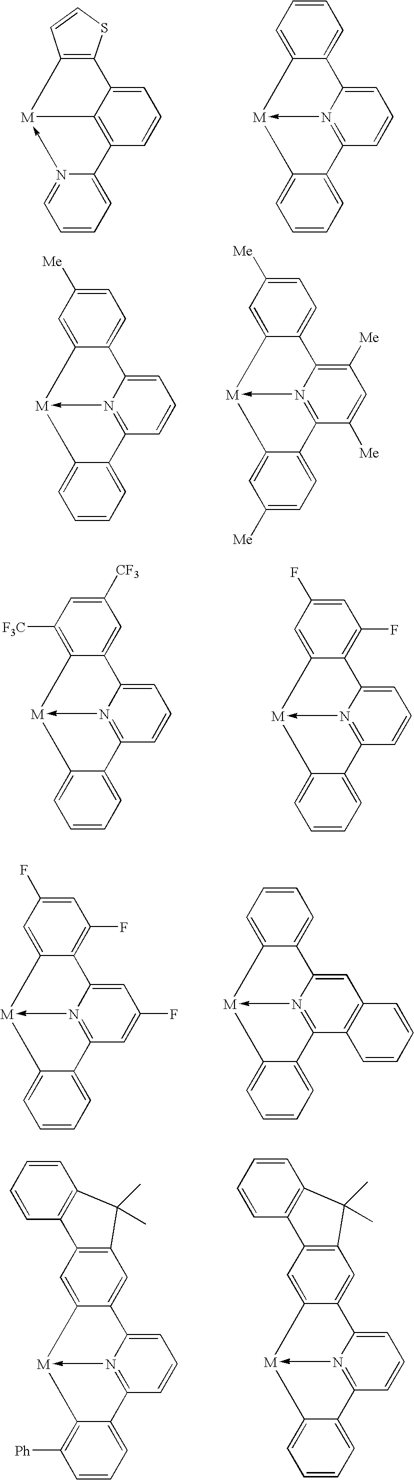

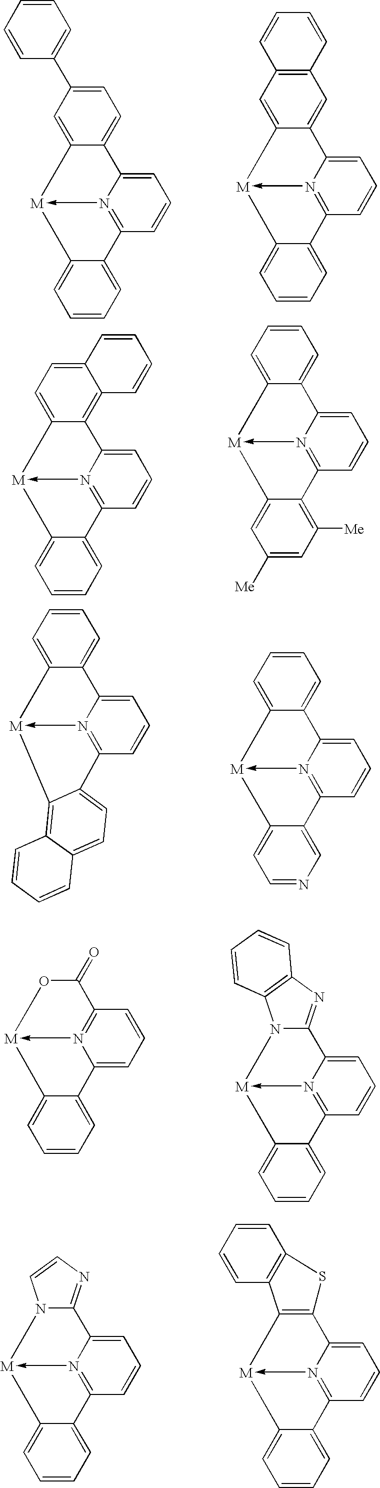

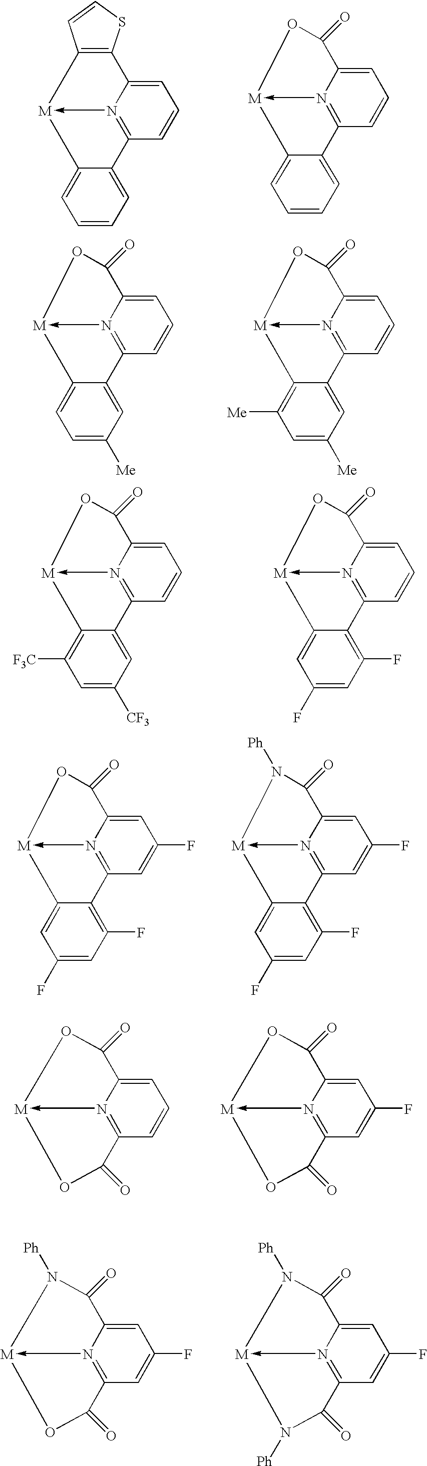

In Formulas (1) to (18) described above, M described above is preferably Ir.

Substituents for the respective groups in Formulas (1) to (18) described above include a substituted or non-substituted aryl group having 5 to 50 ring carbon atoms, a substituted or non-substituted alkyl group having 1 to 50 carbon atoms, a substituted or non-substituted alkoxy group having 1 to 50 carbon atoms, a substituted or non-substituted aralkyl group having 6 to 50 ring carbon atoms, a substituted or non-substituted aryloxy group having 5 to 50 ring carbon atoms, a substituted or non-substituted arylthio group having 5 to 50 ring carbon atoms, a substituted or non-substituted alkoxycarbonyl group having 1 to 50 carbon atoms, an amino group, a halogen atom, a cyano group, a nitro group, a hydroxyl group and a carboxyl group.

Among them, an alkyl group having 1 to 10 carbon atoms, a cycloalkyl group having 5 to 7 carbon atoms and an alkoxy group having 1 to 10 carbon atoms are preferred, and an alkyl group having 1 to 6 carbon atoms and a cycloalkyl group having 5 to 7 carbon atoms are more preferred. Particularly preferred are methyl, ethyl, n-propyl, isopropyl, n-butyl, sec-butyl, tert-butyl, n-pentyl, n-hexyl, cyclopentyl and cyclohexyl.

Next, the production process of the present invention for a metal complex compound shall be explained with a compound B and a compound F each shown below as representative examples thereof, but the present invention shall not be restricted thereto, and compounds having other structures and derivatives thereof can be produced in a similar manner.

(1) Synthesis of compound B

(i) Synthesis of compound A

A compound A which is an intermediate of the compound B shown below is synthesized by the following synthetic route. The compound A is synthesized according to a reference document (J. Am. Chem. Soc., 123, 31, 2001, 7727 or Tetrahedron Lett. 40, 14, 1999, 2657). 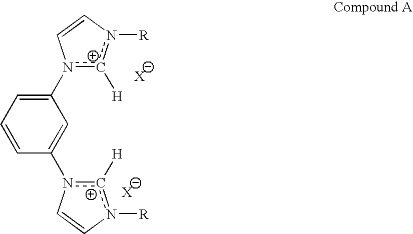
(R is, for example, an alkyl group, and X is halogen or a conjugated base of strong acid or superstrong acid).
<Synthetic Route>

CuOTf is copper (I) trifluoromethanesulfonate. 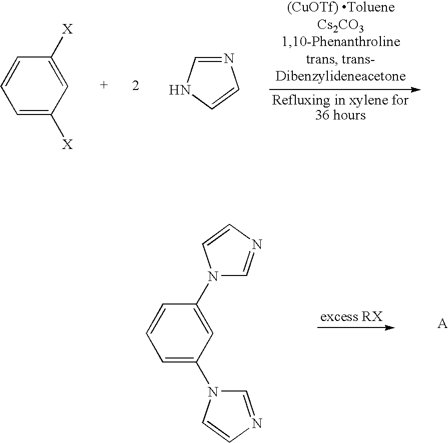
(ii) Synthesis of Compound B

Next, the compound B is synthesized by the following synthetic route 1 or synthetic route 2.

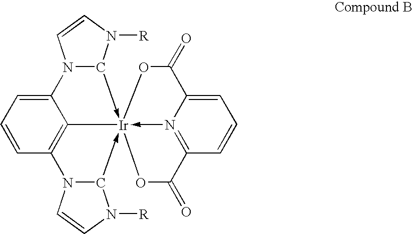

COD is 1,5-cyclooctadiene, and a compound C is the following compound: 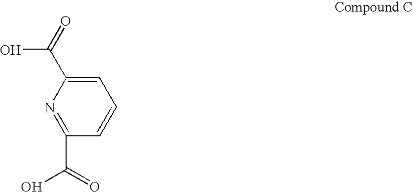 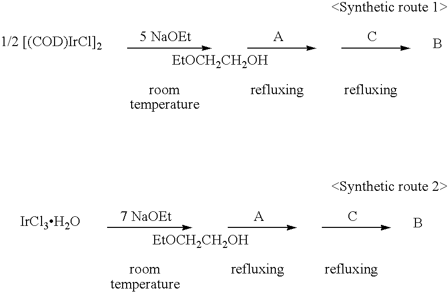
(2) Synthesis of compound F
(i) Synthesis of compound D

A compound D is synthesized according to WO 2005/019373: 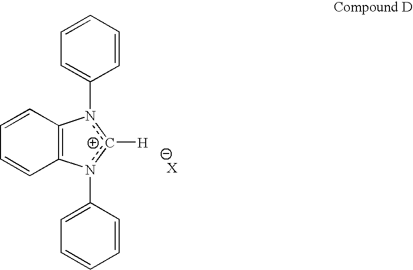
(ii) Synthesis of Compound E

A compound E which is an intermediate of the compound F shown below is synthesized by the following synthetic route: 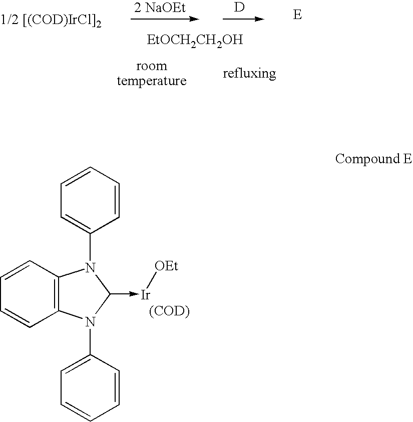
(iii) Synthesis of Compound F

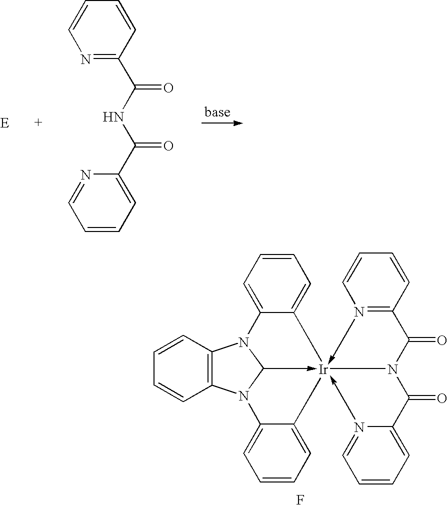

The organic EL device of the present invention is an organic EL device in which an organic thin film layer comprising a single layer or plural layers having at least a light emitting layer is interposed between a pair of electrodes comprising an anode and a cathode, wherein at least one layer in the organic thin film layer contains the transition metal complex compound of the present invention represented by at least one selected from Formulas (1) to (5).

A content of the transition metal complex compound of the present invention contained in the organic thin film layer described above is usually 0.1 to 100% by weight, preferably 1 to 30% by weight based on the mass of the whole light emitting layer.

The organic EL device of the present invention preferably contains the transition metal complex compound of the present invention as a luminescent material or a dopant in the light emitting layer described above. Usually, the light emitting layer described above is formed into a thin film by vacuum deposition or coating, and the layer containing the transition metal complex compound of the present invention is formed preferably by coating since coating makes it possible to simplify the production process.

In the organic EL device of the present invention, when the organic thin film layer is a single layer type, the organic thin film layer is a light emitting layer, and this light emitting layer contains the transition metal complex compound of the present invention. The organic EL device of a multilayer type includes devices comprising (anode/hole injecting layer (hole transporting layer)/light emitting/cathode), (anode/light emitting layer/electron injecting layer (electron transporting layer)/cathode) and (anode/hole injecting layer (hole transporting layer)/light emitting layer/electron injecting layer (electron transporting layer)/cathode).

The anode in the organic EL device of the present invention supplies holes to the hole injecting layer, the hole transporting layer and the light emitting layer, and it is effective that the anode has a work function of 4.5 eV or more. Metals, alloys, metal oxides, electrically conductive compounds and mixtures thereof can be used as a material for the anode. The specific examples of the material for the anode include electrically conductive metal oxides such as tin oxide, zinc oxide, indium oxide and indium tin oxide (ITO), metals such as gold, silver, chromium and nickel, mixtures or laminates of the above electrically conductive metal oxides and metals, inorganic conductive substances such as copper iodide and copper sulfide, organic conductive substances such as polyaniline, polythiophene and polypyrrole and laminates of the above substances with ITO. They are preferably the conductive metal oxides, and ITO is particularly preferably used from the viewpoint of a productivity, a high conductivity and a transparency. A layer thickness of the anode can suitably be selected according to the material.

The cathode in the organic EL device of the present invention supplies electrons to the electron injecting layer, the electron transporting layer and the light emitting layer. Metals, alloys, metal halides, metal oxides, electrically conductive compounds and mixtures thereof can be used as a material for the cathode. The specific examples of the material for the cathode include alkali metals (for example, Li, Na, K and the like) and fluorides and oxides thereof, alkaline earth metals (for example, Mg, Ca and the like) and fluorides and oxides thereof, gold, silver, lead, aluminum, sodium-potassium alloys or sodium-potassium mixed metals, lithium-aluminum alloys or lithium-aluminum mixed metals, magnesium-silver alloys or magnesium-silver mixed metals and rare earth metals such as indium, ytterbium and the like. Among them, aluminum, lithium-aluminum alloys or lithium-aluminum mixed metals and magnesium-silver alloys or magnesium-silver mixed metals are preferred. The cathode may have a single layer structure comprising the material described above or a laminate structure having layers comprising the materials described above. For example, laminate structures of aluminum/lithium fluoride and aluminum/lithium oxide are preferred. A layer thickness of the cathode can suitably be selected according to the material.

The hole injecting layer and the hole transporting layer in the organic EL device of the present invention may be any ones as long as they have any of a function of injecting holes from the anode, a function of transporting holes and a function of blocking electrons injected from the cathode. The specific examples thereof include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidene base compounds, porphyrin base compounds, polysilane base compounds, poly(N-vinylcarbazole) derivatives, aniline base copolymers, conductive high molecular oligomers such as thiophene oligomers and polythiophenes, organic silane derivatives and the transition metal complex compounds of the present invention. The hole injecting layer and the hole transporting layer each described above may have a single layer structure comprising at least one of the materials described above or a multilayer structure comprising plural layers having the same composition or different kinds of compositions.

The electron injecting layer and the electron transporting layer in the organic EL device of the present invention may be any ones as long as they have any of a function of injecting electrons from the cathode, a function of transporting electrons and a function of blocking holes injected from the anode. The specific examples thereof include triazole derivatives, oxazole derivatives, oxadiazole derivatives, imidazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, tetracarboxylic anhydrides having an aromatic ring such as naphthalene and perylene, phthalocyanine derivatives, various metal complexes represented by metal complexes of 8-quinolinol derivatives and metal complexes comprising metal phthalocyanine, benzoxazole and benzothiazole as ligands, organic silane derivatives and the transition metal complex compounds of the present invention. The electron injecting layer and the electron transporting layer each described above may have a single layer structure comprising at least one of the materials described above or a multilayer structure comprising plural layers having the same composition or different kinds of compositions.

Further, electron transporting materials used for the electron injecting layer and the electron transporting layer include compounds shown below.

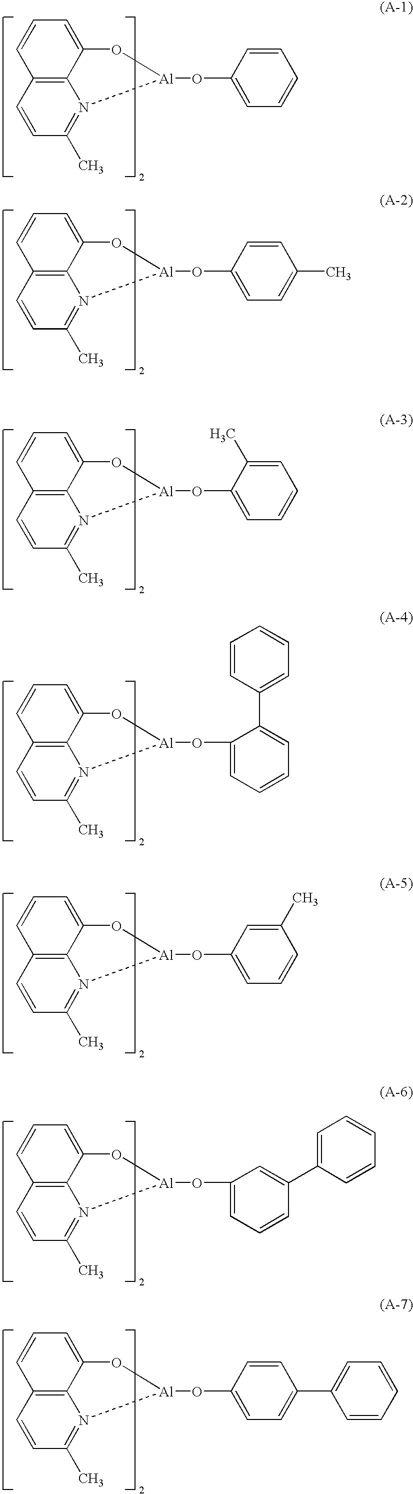

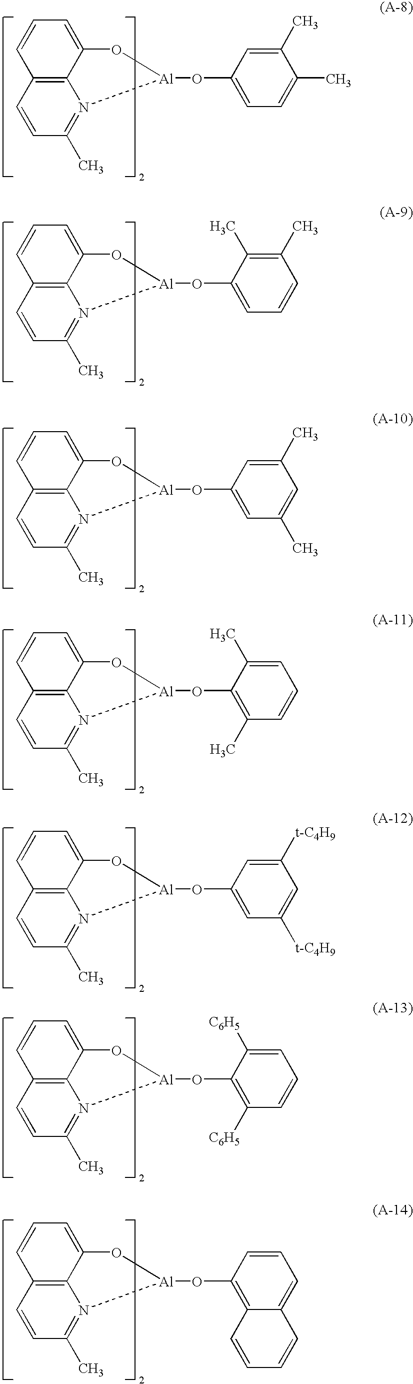

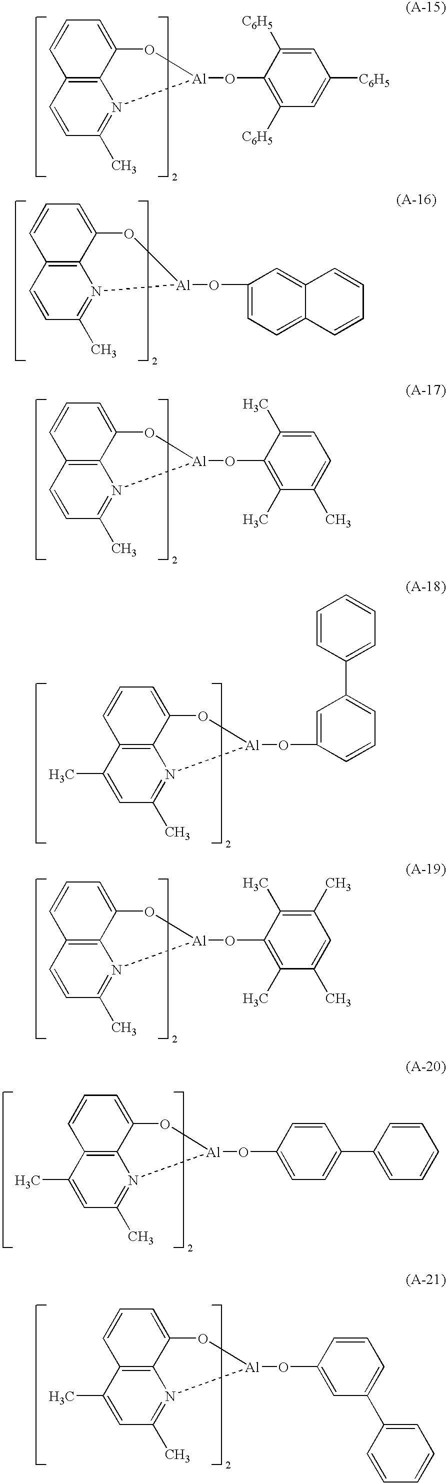

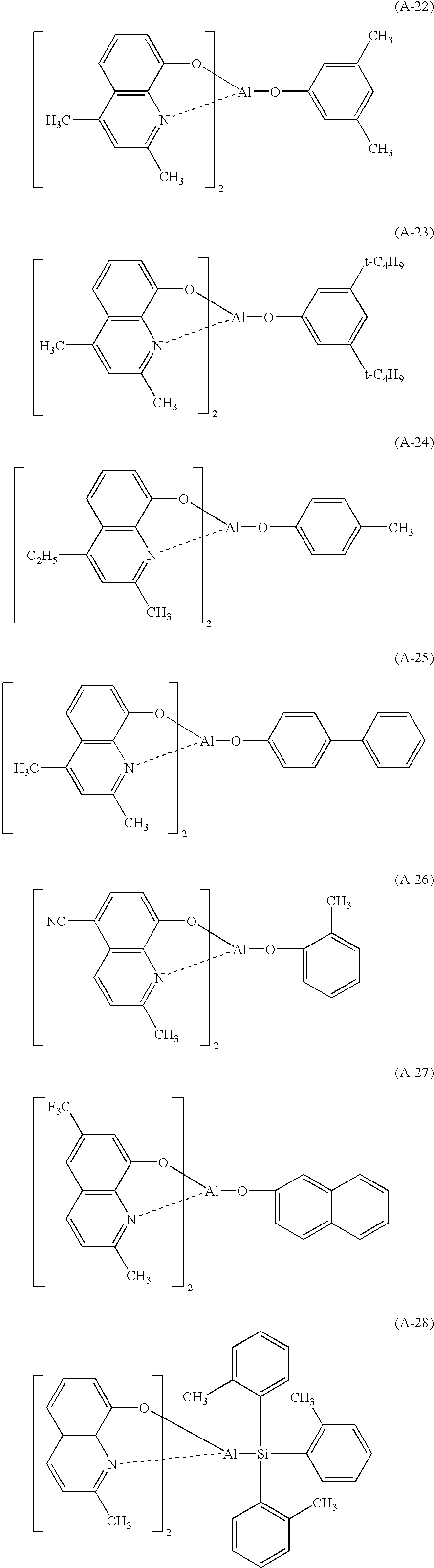

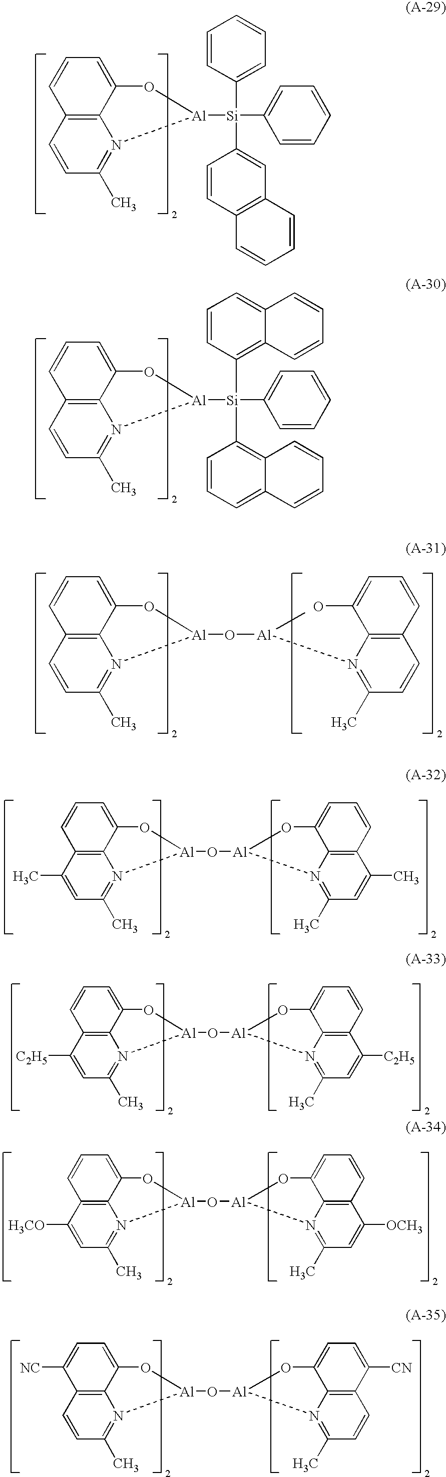

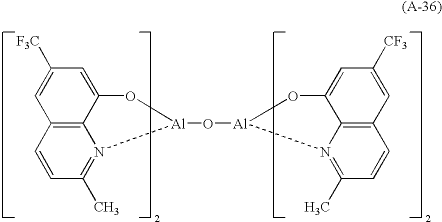

In the organic EL device of the present invention, the above electron injecting layer and/or electron transporting layer contain preferably a π electron deficient nitrogen-containing heterocyclic derivative as a principal component.

The preferred examples of the π electron deficient nitrogen-containing heterocyclic derivative include derivatives of a nitrogen-containing five-membered ring selected from a benzimidazole ring, a benzotriazole ring, a pyridinoimidazole ring, a pyrimidinoimidazole ring and a pyridazinoimidazole ring and nitrogen-containing six-membered ring derivatives constituted from a pyridine ring, a pyrimidine ring, a pyrazine ring and a triazine ring. The nitrogen-containing five-membered ring derivative includes preferably a structure represented by the following Formula B-I. The nitrogen-containing six-membered ring derivative includes preferably structures represented by the following Formulas C-I, C-II, C-III, C-IV, C-V and C-VI, and the structures represented by Formulas C-I and C-II are particularly preferred.

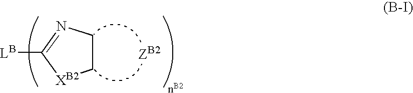

In Formula (B-I), L^{B} represents a divalent or higher linkage group, and it is preferably a linkage group formed from carbon, silicon, nitrogen, boron, oxygen, sulfur, metal and a metal ion, more preferably a carbon atom, a nitrogen atom, a silicon atom, a boron atom, an oxygen atom, a sulfur atom, an aromatic hydrocarbon ring or an aromatic heterocycle and further preferably a carbon atom, a silicon atom, an aromatic hydrocarbon ring or an aromatic heterocycle.

L^{B} may have a substituent, and the substituent is preferably an alkyl group, an alkenyl group, an alkynyl group, an aromatic hydrocarbon group, an amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a halogen atom, a cyano group and an aromatic heterocyclic group, more preferably an alkyl group, an aryl group, an alkoxy group, an aryloxy group, a halogen atom, a cyano group and an aromatic heterocyclic group, further preferably an alkyl group, an aryl group, an alkoxy group, an aryloxy group and an aromatic heterocyclic group and particularly preferably an alkyl group, an aryl group, an alkoxy group and an aromatic heterocyclic group.

The specific examples of the linkage group represented by L^{B} include the following ones:

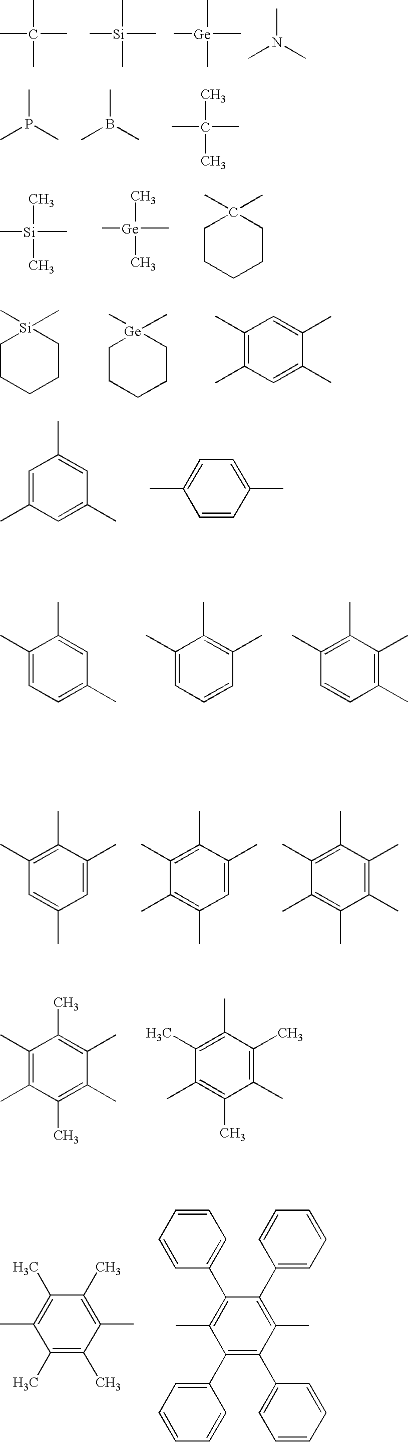

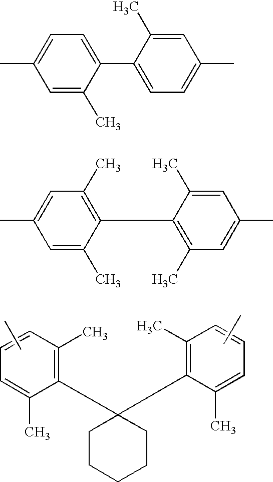

In Formula (B-I), X^{B2} represents —O—, —S— or ═N—R^{B2} R^{B2} represents a hydrogen atom, an aliphatic hydrocarbon group, an aryl group or a heterocyclic group.

The aliphatic hydrocarbon group represented by R^{B2} is a linear, branched or cyclic alkyl group (an alkyl group having preferably 1 to 20 carbon atoms, more preferably 1 to 12 carbon atoms and particularly preferably 1 to 8 carbon atoms, and it includes, for example, methyl, ethyl, isopropyl, t-butyl, n-octyl, n-decyl, n-hexadecyl, cyclopropyl, cyclopentyl and cyclohexyl), an alkenyl group (an alkenyl group having preferably 2 to 20 carbon atoms, more preferably 2 to 12 carbon atoms and particularly preferably 2 to 8 carbon atoms, and it includes, for example, vinyl, allyl, 2-butenyl and 3-pentenyl) or an alkynyl group (an alkynyl group having preferably 2 to 20 carbon atoms, more preferably 2 to 12 carbon atoms and particularly preferably 2 to 8 carbon atoms, and it includes, for example, propargyl and 3-pentynyl), and it is more preferably an alkyl group.

The aryl group represented by R^{B2} is an aryl group of a single ring or a condensed ring, and it is an aryl group having preferably 6 to 30 carbon atoms, more preferably 6 to 20 carbon atoms and further preferably 6 to 12 carbon atoms. It includes, for example, phenyl, 2-methylphenyl, 3-methylphenyl, 4-methylphenyl, 2-methoxyphenyl, 3-trifluoromethylphenyl, pentafluorophenyl, 1-naphthyl and 2-naphthyl.

The heterocyclic group represented by R^{B2} is a heterocyclic group of a single ring or a condensed ring (a heterocyclic group having 1 to 20 carbon atoms, more preferably 1 to 12 carbon atoms and further preferably 2 to 10 carbon atoms), and it is preferably an aromatic heterocyclic group having at least one of a nitrogen atom, an oxygen atom, a sulfur atom and a selenium atom. It includes, for example, pyrrolidine, piperidine, piperazine, morpholine, thiophene, selenophene, furan, pyrrole, imidazole, pyrazole, pyridine, pyrazine, pyridazine, pyrimidine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzothiazole, benzotriazole, tetrazaindene, carbazole and azepine. It is preferably furan, thiophene, pyridine, pyrazine, pyrimidine, pyridazine, triazine, quinoline, phthalazine, naphthylidine, quinoxaline or quinazoline, more preferably furan, thiophene, pyridine or quinoline, and it is further preferably quinoline.

The aliphatic hydrocarbon group, the aryl group and the heterocyclic group each represented by R^{B2} may have substituents and include the same substituents as in L^{B}.

R^{B2} is preferably an alkyl group, an aryl group or an aromatic heterocyclic group, more preferably an aryl group or an aromatic heterocyclic group and further preferably an aryl group.

X^{B2} is preferably —O— or ═N—R^{B2}, more preferably ═N—R^{B2} and particularly preferably ═N—Ar^{B2} (Ar^{B2} represents an aryl group (an aryl group having preferably 6 to 30 carbon atoms, more preferably 6 to 20 carbon atoms and further preferably 6 to 12 carbon atoms) or an aromatic heterocyclic group (an aromatic heterocyclic group having preferably 1 to 20 carbon atoms, more preferably 1 to 12 carbon atoms and further preferably 2 to 10 carbon atoms), preferably an aryl group).

Z^{B2} represents the group of atoms necessary for forming an aromatic ring. The aromatic ring formed by Z^{B2} may be any of an aromatic hydrocarbon ring and an aromatic heterocycle, and the specific examples thereof include, for example, a benzene ring, a pyridine ring, a pyrazine ring, a pyrimidine ring, a pyridazine ring, a triazine ring, a pyrrole ring, a furan ring, a thiophene ring, a selenophene ring, a tellurophene ring, an imidazole ring, a thiazole ring, a selenazole ring, a tellurazole ring, a thiadiazole ring, an oxadiazole ring and a pyrazole ring. It is preferably a benzene ring, a pyridine ring, a pyrazine ring, a pyrimidine ring or a pyridazine ring, more preferably a benzene ring, a pyridine ring or a pyrazine ring, further preferably a benzene ring or a pyridine ring and particularly preferably a pyridine ring. The aromatic ring formed by Z^{B2} may further form a condensed ring with other rings and may have substituents. The substituents are preferably an alkyl group, an alkenyl group, an alkynyl group, an aryl group, an amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a halogen atom, a cyano group and a heterocyclic group, more preferably an alkyl group, an aryl group, an alkoxy group, an aryloxy group, a halogen atom, a cyano group and a heterocyclic group, further preferably an alkyl group, an aryl group, an alkoxy group, an aryloxy group and an aromatic heterocyclic group and particularly preferably an alkyl group, an aryl group, an alkoxy group and an aromatic heterocyclic group.

n^{B2} is an integer of 1 to 4, and it is preferably 2 to 3.

Among the compounds represented by Formula (B-I) described above, compounds represented by the following Formula (B-II) are further preferred:

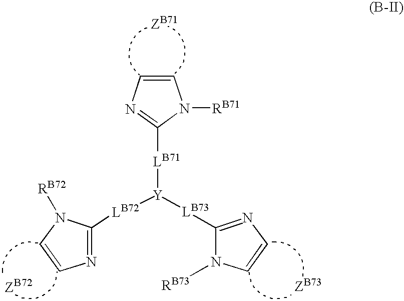

In Formula (B-II), R^{B71}, R^{B72} and R^{B73} each are the same as R^{B2} in Formula (B-I), and the preferred ranges thereof are the same.

Z^{B71}, Z^{B72} and Z^{B73} each are the same as Z^{B2} in Formula (B-I), and the preferred ranges thereof are the same.

L^{B71}, L^{B72} and L^{B73} each represent a linkage group and include groups obtained by converting the groups given as the examples of L^{B} in Formula (B-I) into divalent groups, and they are preferably a single bond, a divalent aromatic hydrocarbon ring group, a divalent aromatic heterocyclic group or a linkage group comprising a combination of the above groups, more preferably a single bond. L^{B71}, L^{B72} and L^{B73} may have substituents, and the substituents include the same ones as given for L^{B} in Formula (B-I).

Y represents a nitrogen atom, a 1,3,5-benzenetriyl group or a 2,4,6-triazinetriyl group. The 1,3,5-benzenetriyl group may have substituents in 2-, 4- and 6-positions, and the substituents include, for example, an alkyl group, an aromatic carbocyclic group and a halogen atom.

The specific examples of the nitrogen-containing five-membered ring derivative represented by Formula (B-I) or (B-II) are shown below, but they shall not be limited to these compounds given as the examples. 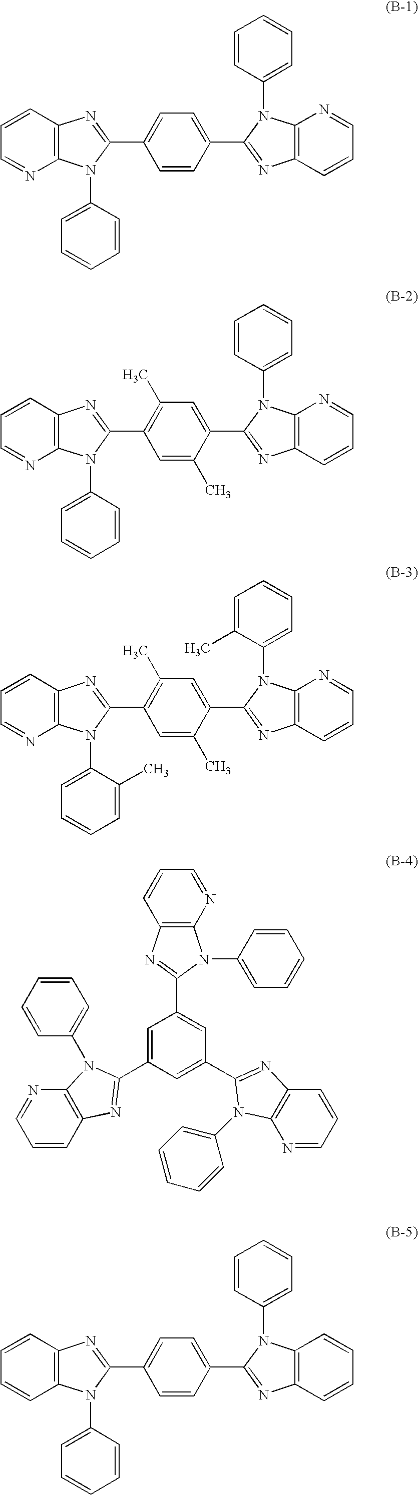 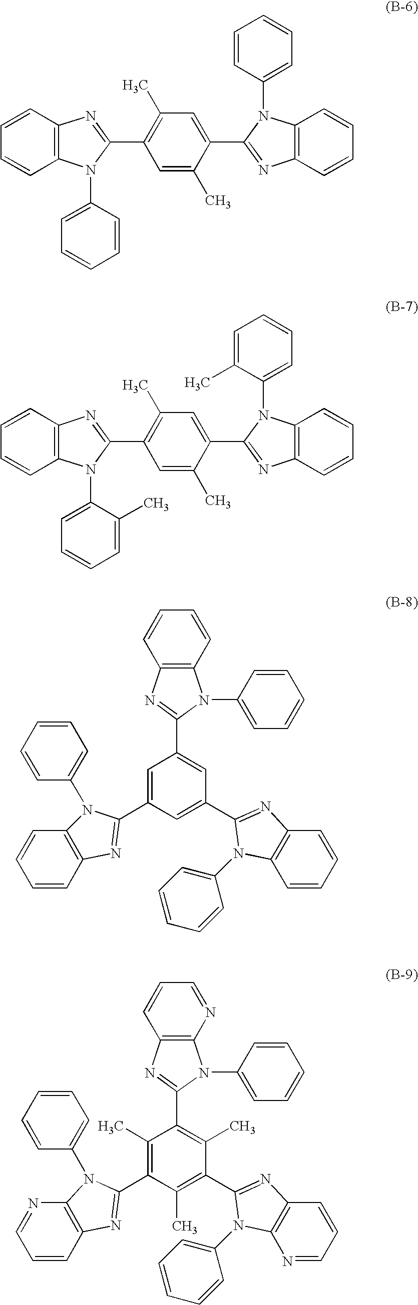 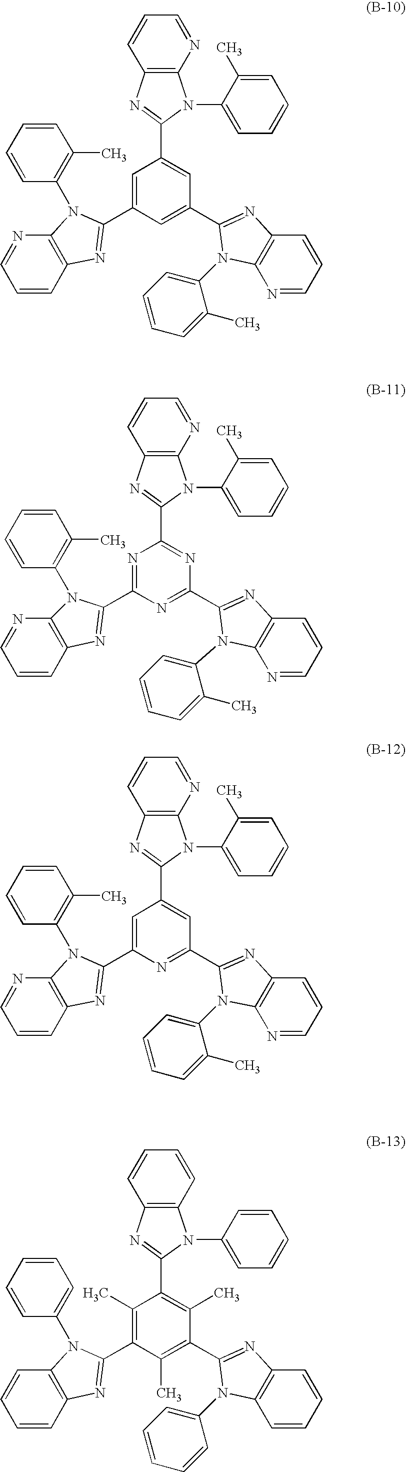 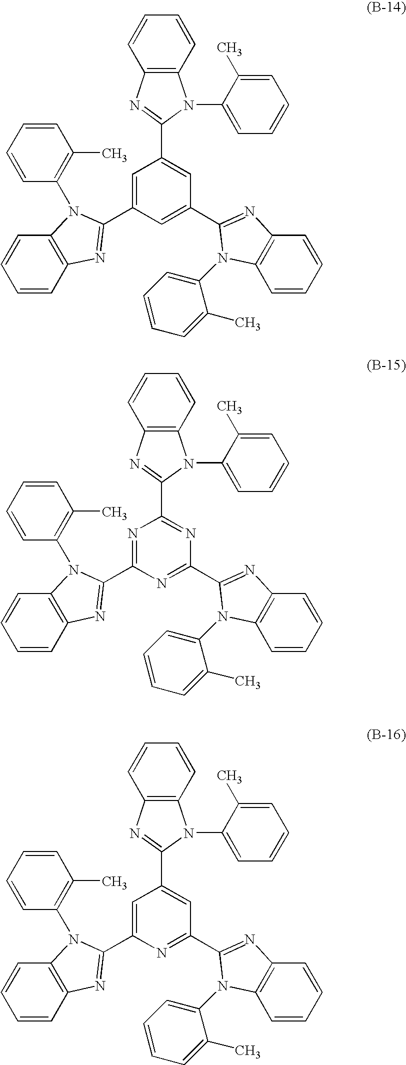
(Cz-)ₙA (C-I)
Cz(-A)ₘ (C-II)
[wherein Cz represents a substituted or non-substituted carbazolyl group, an arylcarbazolyl group or a carbazolylalkylene group; A represents a group formed by a part represented by the following Formula (A); and n and m each represent an integer of 1 to 3:
(M)ₚ-(L)_{q}-(M′)ᵣ (A)
(M and M′ each independently represent a nitrogen-containing aromatic heterocycle having 2 to 40 carbon atoms which forms a ring, and the ring may have or may not have a substituent; M and M′ may be the same or different; L represents a single bond, an arylene group having 6 to 30 carbon atoms, a cycloalkylene group having 5 to 30 carbon atoms or an aromatic heterocycle having 2 to 30 carbon atoms, and it may have or may not have a substituent bonded to the ring; p represents an integer of 0 to 2; q is an integer of 1 to 2; r is an integer of 0 to 2; and p+r is 1 or more.)]

The bonding modes of Formulas (C-I) and (C-II) each described above are shown according to the numbers of the parameters n and m, to be specific, as described in the following table.

| n = m = 1 | n = 2 | n = 3 | m = 2 | m = 3 |
|---|---|---|---|---|
| 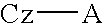 | 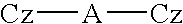 | 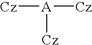 | 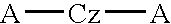 | 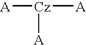 |

The bonding mode of the group represented by Formula (A) is shown according to the numbers of the parameters p, q and r, to be specific, in forms described in (1) to (16) in the following table.

| No | p | q | r | Bonding mode |
|---|---|---|---|---|
| (1) | 0 | 1 | 1 | L—M′ |
| (2) | 0 | 1 | 2 | L—M′,—M′, M′ —L—M′ |
| (3) | 0 | 2 | 1 | L—L—M′, L—M′ —L |
| (4) | 0 | 2 | 2 | L—L—M′ —M′, M′ —L—L—M′, 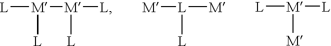 |
| (5) | 1 | 1 | 0 | same as (1) (m′ is replaced by M) |
| (6) | 1 | 1 | 1 | M—L—M′ |
| (7) | 1 | 1 | 2 | 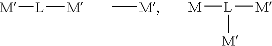 |
| (8) | 1 | 2 | 0 | same as (3) (m′ is replaced by M) |
| (9) | 1 | 2 | 1 | M—L—L—M′, L—M—L—M′, M—L—M′ |
| (10) | 1 | 2 | 2 | M—L—L—M′ —M′ M′ —L—M—L—M′, M′ —M′ —L—M—L, 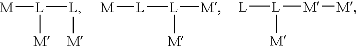 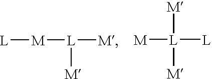 |
| (11) | 2 | 1 | 0 | same as (2) (M′ is replaced by M) |
| (12) | 2 | 1 | 1 | same as (7) (M′ is replaced by M) |
| (13) | 2 | 1 | 2 | 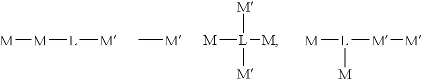 |
| (14) | 2 | 2 | 0 | same as (4) (M′ is replaced by M) |
| (15) | 2 | 2 | 1 | same as (10) (M′ is replaced by M) |
| (16) | 2 | 2 | 2 | M—M—L—L—M′ —M′, 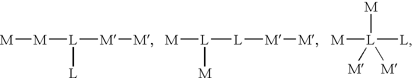 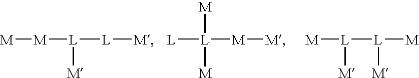 |

When the group represented by Cz is bonded to A in Formulas (C-I) and (C-II) described above, it may be bonded to any position of M, L and M′ representing A. For example, in Cz-A in which m and n are 1, A is M-L-M′ in the case of p=q=r=1 ((6) in the table), and the structure is shown by the three bonding modes of Cz-M-L-M′, M-L(-Cz)-M′ and M-L-M′-Cz. Similarly, for example, in (Cz-A-Cz) in which n is 2 in Formula (C-I), A is M-L-M′-M′ or M-L(-M′)-M′ in the case of p=q=1 and r=2 ((7) in the table), and the structure is shown by the following bonding modes:

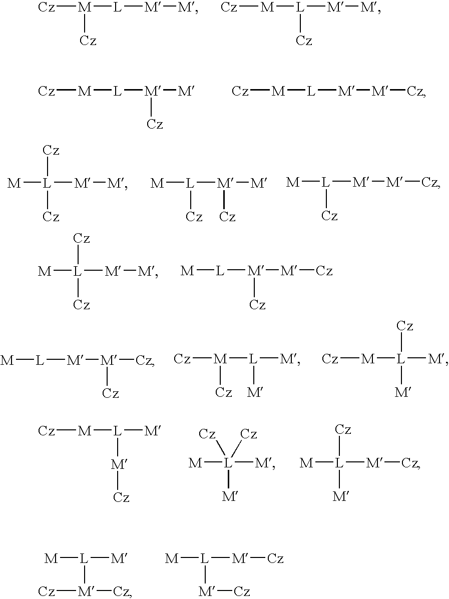

The specific examples of the structures represented by Formulas (C-I) and (C-II) include the following structures, but they shall not be restricted to these examples. 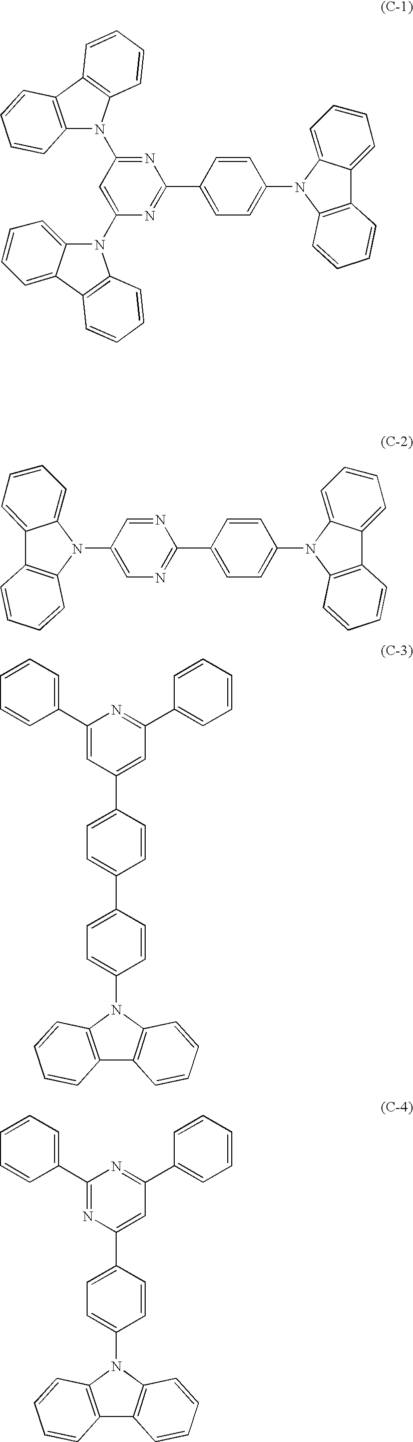 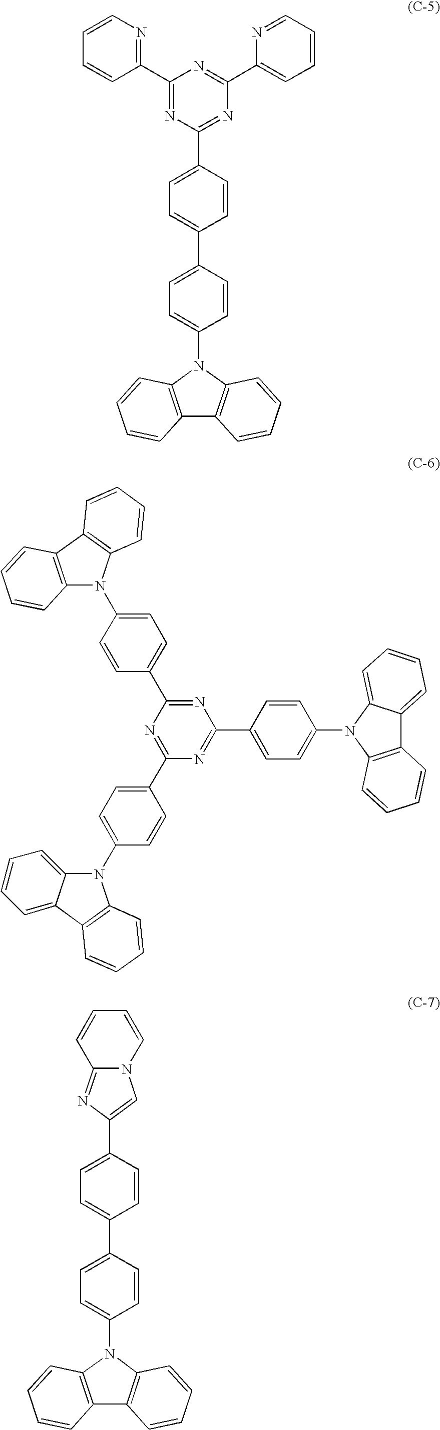 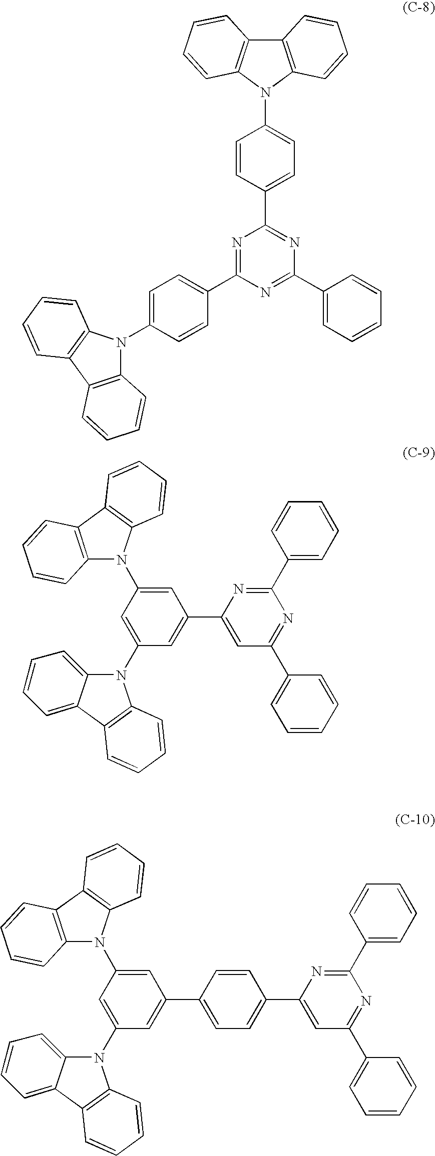 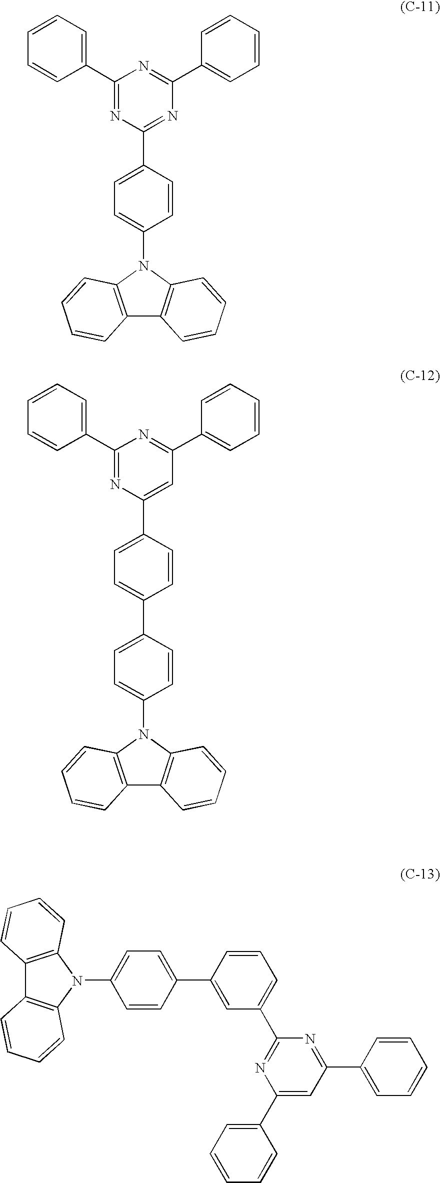 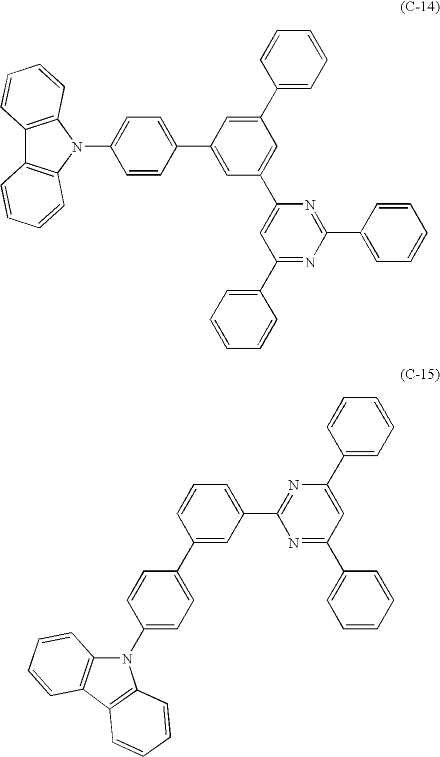 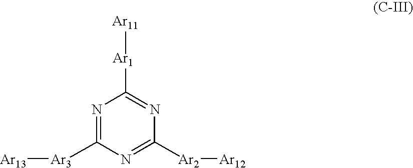
(wherein Ar₁₁ to Ar₁₃ each represent the same groups as R^{B2} in Formula (B-1), and the specific examples thereof are the same; Ar₁ to Ar₃ each represent groups obtained by converting the same groups as R^{B2} in Formula (B-1) into divalent groups, and the specific examples thereof are the same).

The specific example of the structure represented by Formula (C-III) is shown below, but it shall not be restricted thereto. 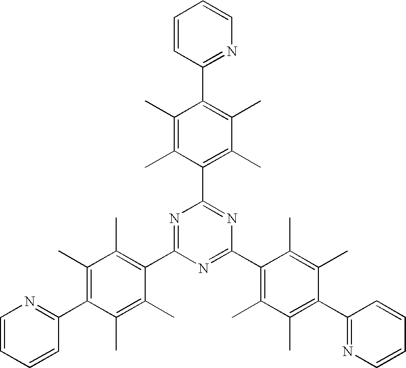 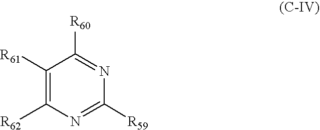
(wherein R₅₉ to R₆₂ each represent the same groups as R^{B2} in Formula (B-1), and the specific examples thereof are the same).

The specific example of the structure represented by Formula (C-IV) is shown below, but they shall not be restricted thereto. 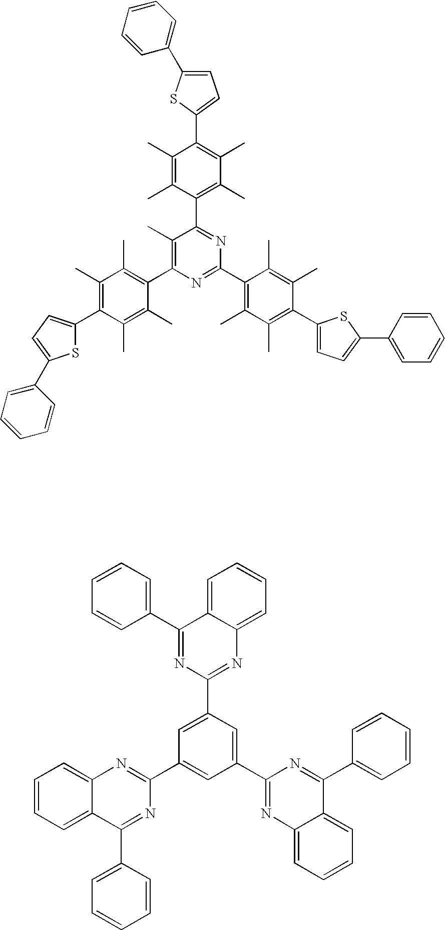 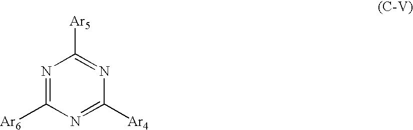
(wherein Ar₄ to Ar₆ each represent the same group as R^{B2} in Formula (B-1), and the specific examples thereof are the same).

The specific example of the structure represented by Formula (C-V) is shown below, but it shall not be restricted thereto. 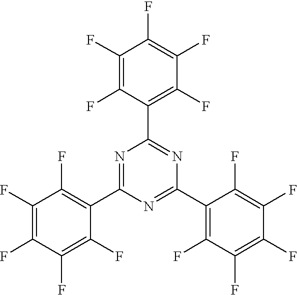 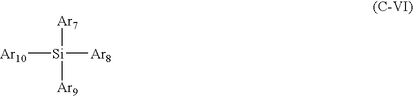
(wherein Ar₇ to Ar₁o each represent the same group as R^{B2} in Formula (B-1), and the specific examples thereof are the same).

The specific example of the structure represented by Formula (C-VI) is shown below, but it shall not be restricted thereto.

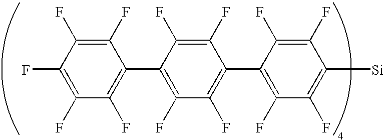

In the organic EL device of the present invention, inorganic compounds of insulating materials or semiconducting materials are preferably used as a material for constituting the electron injecting and transporting layer. If the electron injecting and transporting layer is constituted by an insulating material or a semiconducting material, an electric current can effectively be prevented from leaking to improve the electron injecting property. Preferably used as the above insulating material described above is at least one metal compound selected from the group consisting of chalcogenides of alkali metals, chalcogenides of alkaline earth metals, halides of alkali metals and halides of alkaline earth metals. The electron injecting and transporting layer is preferably constituted by the above metal compound, such as chalcogenides of alkali metals, from the viewpoint that the electron injecting property can further be enhanced.

To be specific, the preferred chalcogenides of alkali metals include, for example, Li₂O, Na₂S and Na₂Se. The preferred chalcogenides of alkaline earth metals include, for example, CaO, BaO, SrO, BeO, BaS and CaSe. Also, the preferred halides of alkali metals include, for example, LiF, NaF, KF, LiCl, KCl and NaCl. The preferred halides of alkaline earth metals include, for example, fluorides such as CaF₂, BaF₂, SrF₂, MgF₂ and BeF₂ and halides other than fluorides.

The semiconducting material constituting the electron injecting and transporting layer includes a single component of oxides, nitrides and oxide nitrides containing at least one element of Ba, Ca, Sr, Yb, Al, Ga, In, Li, Na, Cd, Mg, Si, Ta, Sb and Zn or combinations of two or more kinds thereof. The inorganic compound constituting the electron transporting layer is preferably a fine crystal or amorphous insulating thin film. If the electron transporting layer is constituted by the above insulating thin film, the more homogeneous thin film is formed, and therefore defects in pixels such as dark spots can be reduced. The above inorganic compound includes the chalcogenides of alkali metals, the chalcogenides of alkaline earth metals, the halides of alkali metals and the halides of alkaline earth metals each described above.

Further, in the organic EL device of the present invention, the electron injecting layer and/or the electron transporting layer may contain a reducing dopant having a work function of 2.9 eV or less. In the present invention, the reducing dopant is a compound which improves an efficiency of injecting electrons.

Also, in the present invention, the reducing dopant is preferably added to an interfacial region between the cathode and the organic thin film layer, and at least a part of the organic layer included in the interfacial region is reduced and converted into an anion. The preferred reducing dopant is at least one compound selected from the group of alkaline metals, oxides of alkaline earth metals, alkaline earth metals, rare earth metals, oxides of alkali metals, halides of alkali metals, oxides of alkaline earth metals, halides of alkaline earth metals, oxides of rare earth metals or halides of rare earth metals, alkali metal complexes, alkaline earth metal complexes and rare earth metal complexes. To be more specific, the preferred reducing dopant includes at least one alkali metal selected from the group consisting of Na (work function: 2.36 eV), K (work function: 2.28 eV), Rb (work function: 2.16 eV) and Cs (work function: 1.95 eV) and at least one alkaline earth metal selected from the group consisting of Ca (work function: 2.9 eV), Sr (work function: 2.0 to 2.5 eV) and Ba (work function: 2.52 eV), and compounds having a work function of 2.9 eV are particularly preferred. Among them, the reducing dopant is more preferably at least one alkali metal selected from the group consisting of K, Rb and Cs, further preferably Rb or Cs and most preferably Cs. These alkali metals have a particularly high reducing ability, and addition of a relatively small amount thereof to the electron injecting zone enhances an emission luminance and elongates a life in the organic EL device.

The preferred alkaline earth metal oxides described above include, for example, BaO, SrO, CaO and BaₓSr₁₋ₓO (0<x<1) and BaₓCa₁₋ₓ (0<x<1) which are obtained by mixing the above compounds. The oxides or fluorides of alkaline metals include LiF, Li₂O, NaF and the like. The alkali metal complexes, the alkaline earth metal complexes and the rare earth metal complexes shall not specifically be restricted as long as they contain at least one metal ion of alkali metal ions, alkaline earth metal ions and rare earth metal ions. The ligand includes, for example, quinolinol, benzoquinolinol, acrydinol, phenanthridinol, hydroxyphenyloxazole, hydroxyphenylthiazole, hydroxydiaryloxadiazole, hydroxydiarylthiadiazole, hydroxyphenylpyridine, hydroxyphenylbenzimidazole, hydroxybenzotriazole, hydroxylfurborane, bipyridyl, phenanthroline, phthalocyanine, porphyrin, cyclopentadiene, β-diketones, azomethines and derivatives thereof. However the ligand shall not be restricted to the above compounds.

The preferred shape of the reducing dopant is constituted in the form of a layer or an island. When used in the form of a layer, a preferred thickness thereof is 0.05 to 8 nm.

A method for forming the electron injecting and transporting layer containing the reducing dopant is preferably a method in which a luminescent material for forming the interfacial region or an organic substance as an electron injecting material is deposited at the same time while the reducing dopant is deposited by a resistance heating deposition method to disperse the reducing dopant in the organic substance. A dispersion concentration thereof is 100:1 to 1:100, preferably 5:1 to 1:5 in terms of a mole ratio. When the reducing dopant is constituted in the form of a layer, the luminescent material or the electron injecting material which is the organic layer in the interface is constituted in the form of a layer, and then the reducing dopant is deposited alone by the resistance heating deposition method to constitute the layer preferably in a film thickness of 0.5 to 15 nm. When the reducing dopant is constituted in the form of an island, the luminescent material or the electron injecting material which is the organic layer in the interface is constituted in the form of an island, and then the reducing dopant is deposited alone by the resistance heating deposition method to constitute the islands preferably in a film thickness of 0.05 to 1 nm.

The light emitting layer in the organic EL device of the present invention has the function of making it possible to inject holes from the anode or the hole injecting layer and making it possible to inject electrons from the cathode or the electron injecting layer when an electric field is applied, the function of transferring charges injected (electrons and holes) by virtue of the force of the electric field and the function of providing a field for recombination of electrons and holes to lead this to light emission. The light emitting layer in the organic EL device of the present invention contains preferably at least the metal complex compound of the present invention and may contain a host material using the above metal complex compound as a guest material. The host material described above includes, for example, materials having a carbazole skeleton, materials having a diarylamine skeleton, materials having a pyridine skeleton, materials having a pyrazine skeleton, materials having a triazine skeleton and materials having an arylsilane skeleton. T1 (an energy level of a minimum triplet excited state) of the host material described above is preferably larger than a T1 level of the guest material. The host material described above may be a low molecular compound or a high molecular compound. A light emitting layer in which the luminescent material described above is doped with the host material can be formed by co-depositing the host material described above and the luminescent material such as the metal complex compound described above.

In the organic EL device of the present invention, methods for forming the respective layers described above shall not specifically be restricted, and capable of being used are various methods such as a vacuum deposition method, an LB method, a resistance heating deposition method, an electron beam method, a sputtering method, a molecular accumulation method, a coating method (a spin coating method, a casting method and a dip coating method), an ink jet method and a printing method. In the present invention, the coating method is preferred.

The organic thin film layer containing the metal complex compound of the present invention can be formed by a publicly known method such as a vacuum deposition process, a molecular beam epitaxy method (an MBE method) or a dipping method using a solution prepared by dissolving the compound in a solvent, a spin coating method, a casting method, a bar coating method and a roll coating method.

In the coating method described above, the metal complex compound of the present invention is dissolved in a solvent to prepare a coating liquid, and the above coating liquid is applied on a desired layer (or an electrode) and dried, whereby the layer can be formed. A resin may be contained in the coating liquid, and the resin can assume a dissolving state or a dispersing state in the solvent. Non-conjugated polymers (for example, polyvinyl carbazole) and conjugated polymers (for example, polyolefin base polymers) can be used as the resin described above. To be more specific, the resin includes, for example, polyvinyl chloride, polycarbonate, polystyrene, polymethyl methacrylate, polybutyl methacrylate, polyester, polysulfone, polyphenylene oxide, polybutadiene, poly(N-vinylcarbazole), hydrocarbon resins, ketone resins, phenoxy resins, polyamides, ethyl cellulose, vinyl acetate, ABS resins, polyurethane, melamine resins, unsaturated polyester resins, alkyd resins, epoxy resins and silicone resins.

The film thicknesses of the respective organic layers in the organic EL device of the present invention shall not specifically be restricted. In general, the too small thicknesses are liable to cause defects such as pinholes. On the other hand, the too large thicknesses require a high voltage applied, thus deteriorate the efficiency, and therefore the preferred range is usually several nm to 1 μm.

### EXAMPLES

The present invention shall be explained in further details below with reference to examples, but the present invention shall not be restricted by them.

### Example 1 (Synthesis of Compound 2)

(1) Synthesis of compound 1 (synthesized according to a reference document (J. Am. Chem. Soc., 123, 31, 2001, 7727 or Tetrahedron Lett. 40, 14, 1999, 2657))

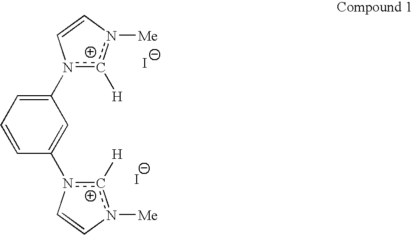

The compound 1 which was an intermediate of a compound 2 shown below was synthesized in the following manner.

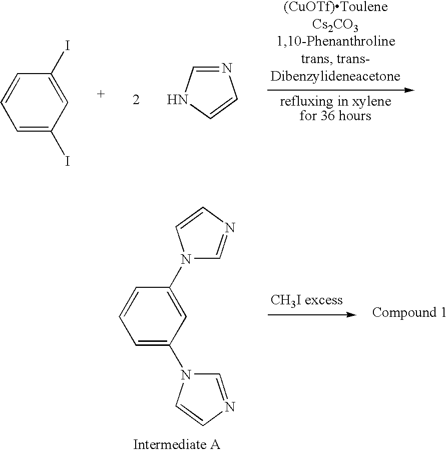

All reactions were carried out under argon flow.

Copper (I) iodide 0.380 g (0.05 equivalent, molecular weight: 190.45, 2.00×10⁻³ mole), 1,10-phenanthroline 0.720 g (0.1 equivalent, molecular weight: 180.21, 4.00×10⁻³ mole) and cesium carbonate 27.4 g (2.1 equivalent, molecular weight: 325.82, 0.084 mole) were suspended in 40 ml of dioxane. Added thereto were 1,3-diiodobenzene 6.60 g (1 equivalent, molecular weight: 329.90, 2.00×10⁻² mole) and imidazole 3.27 g (1.2 equivalent, molecular weight: 68.08, 4.80×10⁻² mole), and the mixture was refluxed at 110° C. for 36 hours.

After finishing the reaction, the solution was cooled down to room temperature. Methylene chloride about 200 ml was added thereto, and the solution was filtered while allowing it to pass through celite. The solvent was distilled off from the filtrate, and 1.35 g of an intermediate A (molecular weight: 210.23, 6.42×10⁻³ mole, yield: 32%) was separated from the residue by means of silica gel chromatography (developing solvent: methylene chloride).

Next, the intermediate A thus obtained was dissolved in 50 ml of tetrahydrofuran, and 3.97 g (molecular weight: 141.94, 0.028 mole) of methyl iodide was added thereto and stirred at room temperature for 24 hours. A white solid component obtained was filtered and washed with diethyl ether, and it was dried under vacuum to obtain the targeted product (compound 1). Further, the filtrate was stirred at room temperature for 24 hours to obtain a white solid component, and the targeted product (compound 1) was separated by the same procedure. Total 1.71 g of the compound 1 (molecular weight: 493.03, 3.47×10⁻³ mole, yield: 54%) was obtained.

(2) Synthesis of compound 2

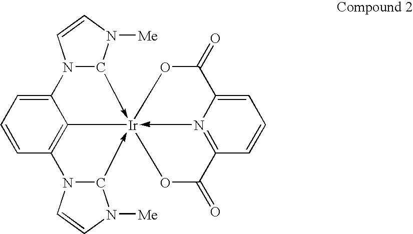

Next, a compound 2 was synthesized in the following manner. All reactions were carried out under argon flow.

A solvent 2-ethoxyethanol 50 ml was added to 1.01 g (molecular weight: 671.70, 1.5×10⁻³ mole) of [(COD)IrCl]₂ (COD: 1,5-cyclooctadiene), and then 5 equivalent (molecular weight: 68.05, 1.02 g, 1.5×10⁻² mole) of sodium ethoxide was added to react them at room temperature for 2 hours. Added thereto was 1.48 g (molecular weight: 493.03, 3.00×10⁻³ mole) of the compound 1 obtained in (1) described above, and the mixture was refluxed for 2 hours.

Next, 0.501 g (molecular weight: 167.12, 3.00×10⁻³ mole) of 2,6-pyridinecarboxylic acid was added to the above reaction solution, and the mixture was further refluxed for 2 hours. This crude product was subjected to fractional crystallization using methylene chloride and hexane, and it was further refined by silica gel chromatography using methylene chloride for a developing solvent to result in obtaining 0.214 g (molecular weight: 594.60, 3.60×10⁻⁴ mole, yield: 12%) of the compound 2.

FD-MS (field desorption mass spectrum) of the above compound was measured to find that a maximum peak of 595 was observed and that it agreed with the calculated value. This compound was irradiated with a UV lamp (365 nm) to find that a green color was observed to be emitted.

Example 2 (Synthesis of Compound 6)

(1) Synthesis of compound 3 (synthesized according to a reference document (WO 2005/019373))

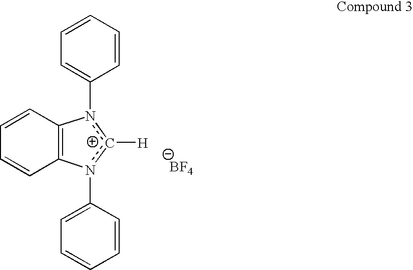

(2) Synthesis of Compound 4

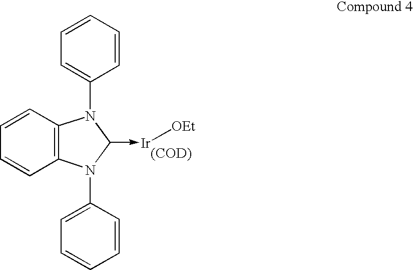

Next, a compound 4 was synthesized in the following manner.

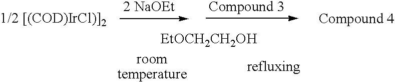

All reactions were carried out under argon flow.

A solvent 2-ethoxyethanol 50 ml was added to 1.01 g (molecular weight: 671.70, 1.5×10⁻³ mole) of [(COD)IrCl]₂ (COD: 1,5-cyclooctadiene), and then 2 equivalent (molecular weight: 68.05, 0.204 g, 3.0×10⁻³ mole) of sodium ethoxide was added to react them at room temperature for 2 hours. Added thereto was 0.537 g (molecular weight: 358.13, 1.50×10⁻³ mole) of the compound 3 obtained in (1) described above, and the mixture was refluxed for 2 hours. The solvent 2-ethoxyethanol was distilled off from the above reaction solution under reduced pressure. Next, a solid was deposited from methylene chloride and hexane, and this was separated to obtain 0.517 g (molecular weight: 615.79, 8.40×10⁻⁴ mole, yield: 56%) of the compound 4.

(3) Synthesis of Compound 6

Next, a compound 6 was synthesized in the following manner.

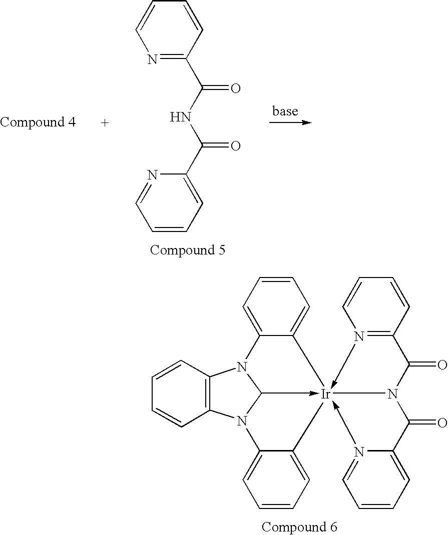

A solvent 2-ethoxyethanol 50 ml was added to 0.517 g (molecular weight: 615.79, 8.40×10⁻⁴ mole) of the compound 4 obtained in (2) described above, and 0.191 g (molecular weight: 227.22, 8.40×10⁻⁴ mole) of a compound 5 was added thereto. Then, 2 equivalent (molecular weight: 68.05, 0.114 g, 1.68×10⁻³ mole) of sodium ethoxide was added thereto, and the mixture was refluxed for 2 hours. This crude product was subjected to fractional crystallization using methylene chloride and hexane, and it was further refined by silica gel chromatography using methylene chloride for a developing solvent to result in obtaining 0.369 g (molecular weight: 686.74, 5.38×10⁻⁴ mole, yield: 32%) of the compound 6. FD-MS (field desorption mass spectrum) of the above compound was measured to find that a maximum peak of 687 was observed and that it agreed with the calculated value. This compound was irradiated with a UV lamp (365 nm) to find that a green color was observed to be emitted.

### INDUSTRIAL APPLICABILITY

As explained above in details, an organic EL device using the transition metal complex compound of the present invention having a metal carbene bond has a high luminous efficiency, and it is very useful as a material for an organic EL device which is required to emit blue light. Further, the transition metal complex compound of the present invention is a compound obtained by deriving a material having conventionally an emission wavelength in a UV region into a material having an emission wavelength in a blue color region by converting the molecular skeleton of the material having an emission wavelength in a UV region.

What is claimed is:

1. A transition metal complex compound having a metal carbene bond represented by the following Formula (1) 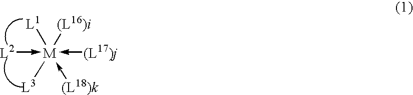
[in Formula (1), a bond shown by a solid line (—) represents a covalent bond, and a bond shown by an arrow (→) represents a coordinate bond; L²→M represents a metal carbene bond; M represents a metal atom of iridium (Ir) or platinum (Pt); L¹-L²-L³ represents a cross-linked tridentate ligand, and L¹⁶, L¹⁷ and L¹⁸ each independently represent a unidentate ligand, a cross-linked bidentate ligand in which two of them are cross-linked or a cross-linked tridentate ligand in which at least two of L¹⁶ and L¹⁷, L¹7 and L¹⁸ and L¹⁶ and L¹⁸ are cross-linked; at least one of L¹, L² and L³ may be cross-linked with at least one of L¹⁶, L¹⁷ and L¹⁸; i, j and k each represent an integer of 0 to 1, and 2+i represents a valence of metal M;
L¹ and L³ each independently represent a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent;
L² represents a divalent group having carbene carbon which may have a substituent;
L¹⁶ represents a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁶ and L¹⁷ or L¹⁶ and L¹⁸ are cross-linked, it is a divalent group of each group described above, and when L¹⁶ and L¹⁷ and L¹⁶ and L¹⁸ are cross-linked, it is a trivalent group of each group described above;
L¹⁷ and L¹⁸ each independently represent a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁶ and L¹⁷, L¹⁶ and L¹⁸ or L¹⁷ and L¹⁸ are cross-linked, it is a monovalent group of each ligand described above, and when L¹⁶ and L¹⁷ and L¹⁷ and L¹⁸ are cross-linked and when L¹⁶ and L¹⁸ and L¹⁷ and L¹⁸ are cross-linked, it is a divalent group of each ligand described above].

2. A transition metal complex compound having a metal carbene bond represented by the following Formula (2): 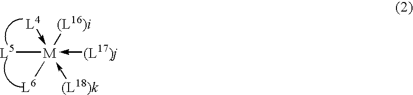
[in Formula (2), a bond shown by a solid line (—) represents a covalent bond, and a bond shown by an arrow (→) represents a coordinate bond; L⁴→M represents a metal carbene bond; M represents a metal atom of iridium (Ir) or platinum (Pt); L⁴-L⁵-L⁶ represents a cross-linked tridentate ligand, and L¹⁶, L¹⁷ and L¹⁸ each independently represent a unidentate ligand, a cross-linked bidentate ligand in which two of them are cross-linked or a cross-linked tridentate ligand in which at least two of L¹⁶ and L¹⁷, L¹⁷ and L¹⁸ and L¹⁶ and L¹⁸ are cross-linked; at least one of L⁴, L⁵ and L⁶ may be cross-linked with at least one of L¹⁶, L¹⁷ and L¹; i, j and k each represent an integer of 0 to 1, and 2+i represents a valence of metal M;
L⁶ each independently represents a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent;
L⁵ represents a group obtained by removing one hydrogen atom of each group represented by L⁶ described above to make it trivalent;
L⁴ represents a monovalent group having carbene carbon which may have a substituent, a monovalent aromatic hydrocarbon group having 6 to 30 ring carbon atoms which may have a substituent or a monovalent heterocyclic group having 3 to 30 ring carbon atoms which may have a substituent, and at least one of them is a monovalent group having carbene carbon which may have a substituent;
L¹⁶ represents a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L16 and L¹⁷ or L¹⁶ and L¹⁸ are cross-linked, it is a divalent group of each group described above, and when L¹⁶ and L¹⁷ and L¹⁶ and L¹⁸ are cross-linked, it is a trivalent group of each group described above;
L¹⁷ and L¹⁸ each independently represent a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁶ and L¹⁷, L¹⁶ and L¹⁸ or L¹⁷ and L¹⁸ are cross-linked, it is a monovalent group of each ligand described above, and when L¹⁶ and L¹⁷ and L¹⁷ and L¹⁸ are cross-linked and when L¹⁶ and L¹⁸ and L¹⁷ and L¹⁸ are cross-linked, it is a divalent group of each ligand described above].

3. A transition metal complex compound having a metal carbene bond represented by the following Formula (3): 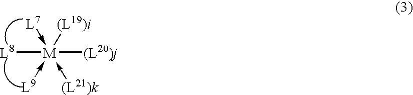
[in Formula (3), a bond shown by a solid line (—) represents a covalent bond, and a bond shown by an arrow (→) represents a coordinate bond; M represents a metal atom of iridium (Ir) or platinum (Pt); L⁷-L⁸-L⁹ represents a cross-linked tridentate ligand, and L¹⁹, L²⁰ and L²¹ each independently represent a unidentate ligand, a cross-linked bidentate ligand in which two of them are cross-linked or a cross-linked tridentate ligand in which at least two of L¹⁹ and L²⁰, L²⁰ and L²¹ and L¹⁹ and L²¹ are cross-linked; at least one of L⁷, L⁸ and L⁹ may be cross-linked with at least one of L¹⁹, L²⁰ and L²¹; i, j and k each represent an integer of 0 to 1, and 1+i+j represents a valence of metal M;
L⁸ represents a trivalent aromatic hydrocarbon group having 6 to 30 ring carbon atoms which may have a substituent, a trivalent heterocyclic group having 3 to 30 ring carbon atoms which may have a substituent, a trivalent carboxyl-containing group having 1 to 30 carbon atoms which may have a substituent, a trivalent hydrocarbon group containing amino group or hydroxyl group which may have a substituent, a trivalent cycloalkane moiety having 3 to 50 ring carbon atoms which may have a substituent, a trivalent alkane moiety having 1 to 30 carbon atoms which may have a substituent, a trivalent alkene moiety having 2 to 30 carbon atoms which may have a substituent or a trivalent arylalkane moiety having 7 to 40 carbon atoms which may have a substituent;
L⁷ and L⁹ each independently represent a monovalent group having carbene carbon which may have a substituent, a monovalent aromatic hydrocarbon group having 6 to 30 ring carbon atoms which may have a substituent or a monovalent heterocyclic group having 5 to 30 ring carbon atoms which may have a substituent; and at least one of L⁷ and L⁹ is a monovalent group having carbene carbon which may have a substituent;
L¹⁹ and L²⁰ each independently represent a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁹ and L²⁰, L¹⁹ and L²¹ or L²⁰ and L²¹ are cross-linked, it is a divalent group of each group described above, and when L¹⁹ and L²⁰ and L¹⁹ and L²¹ are cross-linked and when L¹⁹ and L²⁰ and L²⁰ and L²¹ are cross-linked, it is a trivalent group of each group described above;
L²¹ represents a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁹ and L²¹ or L²⁰ and L²¹ are cross-linked, it is a monovalent group of each ligand described above, and when L¹⁹ and L²¹ and L²⁰ and L²¹ are cross-linked, it is a divalent group of each ligand described above].

4. A transition metal complex compound having a metal carbene bond represented by the following Formula (4): 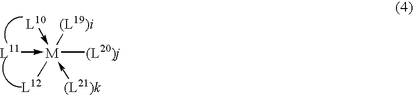
[in Formula (4), a bond shown by a solid line (—) represents a covalent bond, and a bond shown by an arrow (→) represents a coordinate bond; L¹⁰→M represents a metal carbene bond; M represents a metal atom of iridium (Ir) or platinum (Pt); L¹⁰-L¹¹-L¹² represents a cross-linked tridentate ligand, and L¹⁹, L²⁰ and L²¹ each independently represent a unidentate ligand, a cross-linked bidentate ligand in which two of them are cross-linked or a cross-linked tridentate ligand in which at least two of L¹⁹ and L²⁰, L²⁰ and L²¹ and L¹⁹ and L²¹ are cross-linked; at least one of L¹⁰, L¹¹ and L¹² may be cross-linked with at least one of L¹⁹, L²⁰ and L²¹; i, j and k each represent an integer of 0 to 1, and 1+i+j represents a valence of metal M;
L¹² represents a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent;
L¹⁰ represents a monovalent group having carbene carbon which may have a substituent;
L¹¹ represents a divalent aromatic hydrocarbon group having 6 to 30 ring carbon atoms which may have a substituent, a divalent heterocyclic group having 3 to 30 ring carbon atoms which may have a substituent or a divalent group having carbene carbon which may have a substituent;
L¹⁹ and L²⁰ each independently represent a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁹ and L²⁰, L¹⁹ and L²¹ or L²⁰ and L²¹ are cross-linked, it is a divalent group of each group described above, and when L¹⁹ and L²⁰ and L¹⁹ and L²¹ are cross-linked and when L¹⁹ and L²⁰ and L²⁰ and L²¹ are cross-linked, it is a trivalent group of each group described above;
L²¹ represents a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁹ and L²¹ or L²⁰ and L²¹ are cross-linked, it is a monovalent group of each ligand described above, and when L¹⁹ and L²¹ and L²⁰ and L²¹ are cross-linked, it is a divalent group of each ligand described above].

5. A transition metal complex compound having a metal carbene bond represented by the following Formula (5): 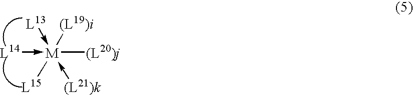
[in Formula (5), a bond shown by a solid line (—) represents a covalent bond, and a bond shown by an arrow (→) represents a coordinate bond; L¹⁴→M represents a metal carbene bond; M represents a metal atom of iridium (Ir) or platinum (Pt); L¹³-L¹⁴-L¹⁵ represents a cross-linked tridentate ligand, and L¹⁹, L²⁰ and L²¹ each independently represent a unidentate ligand, a cross-linked bidentate ligand in which two of them are cross-linked or a cross-linked tridentate ligand in which at least two of L¹⁹ and L²⁰, L²⁰ and L²¹ and L¹⁹ and L²¹ are cross-linked; at least one of L¹³, L¹⁴ and L¹⁵ may be cross-linked with at least one of L¹⁹, L²⁰ and L²¹; i, j and k each represent an integer of 0 to 1, and 1+i+j represents a valence of metal M;
L¹⁵ represents a divalent aromatic hydrocarbon group having 6 to 30 ring carbon atoms which may have a substituent, a divalent heterocyclic group having 3 to 30 ring carbon atoms which may have a substituent, a divalent carboxyl-containing group having 1 to 30 carbon atoms which may have a substituent, a divalent hydrocarbon group containing amino group or hydroxyl group which may have a substituent, a cycloalkylene group having 3 to 50 ring carbon atoms which may have a substituent, an alkylene group having 1 to 30 carbon atoms which may have a substituent, an alkenylene group having 2 to 30 carbon atoms which may have a substituent or an aralkylene group having 7 to 40 carbon atoms which may have a substituent;
L¹⁴ represents a monovalent group having carbene carbon which may have a substituent;
L¹³ represents a divalent aromatic hydrocarbon group having 6 to 30 ring carbon atoms which may have a substituent, a monovalent heterocyclic group having 3 to 30 ring carbon atoms which may have a substituent or a divalent group having carbene carbon which may have a substituent;
L¹⁹ and L²⁰ each independently represent a monovalent aromatic hydrocarbon group having 6 to 30 ring carbon atoms which may have a substituent, a monovalent heterocyclic group having 3 to 30 ring carbon atoms which may have a substituent, a monovalent carboxyl-containing group having 1 to 30 carbon atoms which may have a substituent, a monovalent hydrocarbon group containing amino group or hydroxyl group which may have a substituent, a cycloalkyl group having 3 to 50 ring carbon atoms which may have a substituent, an alkyl group having 1 to 30 carbon atoms which may have a substituent, an alkenyl group having 2 to 30 carbon atoms which may have a substituent or an aralkyl group having 7 to 40 carbon atoms which may have a substituent; when L¹⁹ and L²⁰, L¹⁹ and L²¹ or L²⁰ and L²¹ are cross-linked, it is a divalent group of each group described above, and when L¹⁹ and L²⁰ and L¹⁹ and L²¹ are cross-linked and when L¹⁹ and L²⁰ and L²⁰ and L²¹ are cross-linked, it is a trivalent group of each group described above;
L²¹ represents a ligand comprising a heterocycle having 3 to 30 ring carbon atoms which may have a substituent, carboxylic acid ester having 1 to 30 carbon atoms which may have a substituent, carboxylic amide having 1 to 30 carbon atoms, amine which may have a substituent, phosphine which may have a substituent, isonitrile which may have a substituent, ether having 1 to 30 carbon atoms which may have a substituent, thioether having 1 to 30 carbon atoms which may have a substituent or a double bond-containing compound having 1 to 30 carbon atoms which may have a substituent; when L¹⁹ and L²¹ or L²⁰ and L²¹ are cross-linked, it is a monovalent group of each ligand described above, and when L¹⁹ and L²¹ and L²⁰ and L²¹ are cross-linked, it is a divalent group of each ligand described above].

6. The transition metal complex compound having a metal carbene bond as described in claim 1, wherein a L¹L²L³M part in Formula (1) has a structure represented by the following Formula (6): 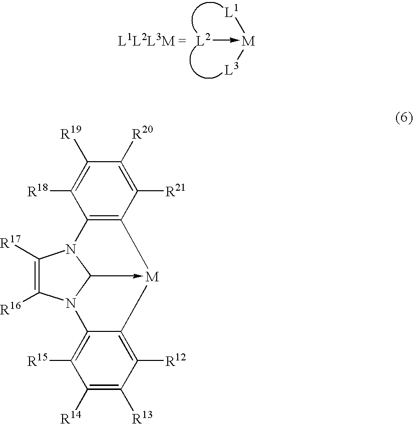
[in Formula (6), R¹² to R²¹ each independently represent a hydrogen atom, a halogen atom, a thiocyano group or a cyano group, a nitro group, a —S(═O)₂R′ group or a —S(═O)R′ group, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 30 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 ring carbon atoms which may have a substituent, an arylamino group having 6 to 30 carbon atoms which may have a substituent, an alkylsilyl group having 3 to 30 ring carbon atoms which may have a substituent, an arylsilyl group having 6 to 30 carbon atoms which may have a substituent or a carboxyl-containing group having 1 to 30 carbon atoms, and they may be cross-linked;
(R′ each independently represents a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 50 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent)].

7. The transition metal complex compound having a metal carbene bond as described in claim 2, wherein a L⁴L⁵L⁶M part in Formula (2) has a structure represented by the following Formula (7): 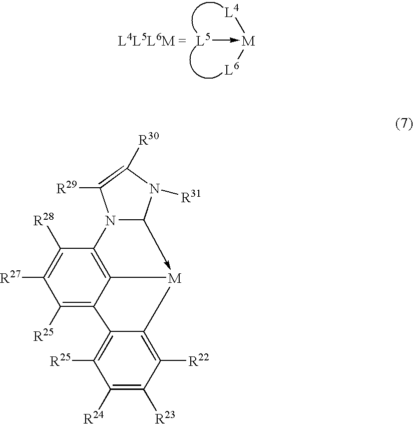
[in Formula (7), R²² to R³¹ each independently represent a hydrogen atom, a halogen atom, a thiocyano group or a cyano group, a nitro group, a —S(═O)₂R′ group or a —S(═O)R′ group, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 30 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 ring carbon atoms which may have a substituent, an arylamino group having 6 to 30 carbon atoms which may have a substituent, an alkylsilyl group having 3 to 30 ring carbon atoms which may have a substituent, an arylsilyl group having 6 to 30 carbon atoms which may have a substituent or a carboxyl-containing group having 1 to 30 carbon atoms, and they may be cross-linked;
(R′ each independently represents a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 50 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent)].

8. The transition metal complex compound having a metal carbene bond as described in claim 3, wherein a L⁷L⁸L⁹M part in Formula (3) has a structure represented by the following Formula (8) or (9): 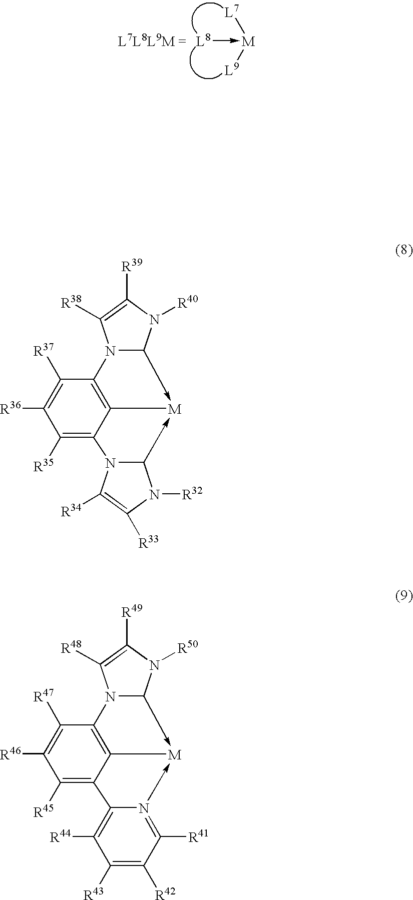
[in Formula (8) and (9), R³² to R⁵⁰ each independently represent a hydrogen atom, a halogen atom, a thiocyano group or a cyano group, a nitro group, a —S(═O)₂R′ group or a —S(═O)R′ group, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 30 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 ring carbon atoms which may have a substituent, an arylamino group having 6 to 30 carbon atoms which may have a substituent, an alkylsilyl group having 3 to 30 ring carbon atoms which may have a substituent, an arylsilyl group having 6 to 30 carbon atoms which may have a substituent or a carboxyl-containing group having 1 to 30 carbon atoms, and they may be cross-linked;
(R′ each independently represents a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 50 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent)].

9. The transition metal complex compound having a metal carbene bond as described in claim 4, wherein a L¹⁰L¹¹L¹²M part in Formula (4) has a structure represented by the following Formula (10): 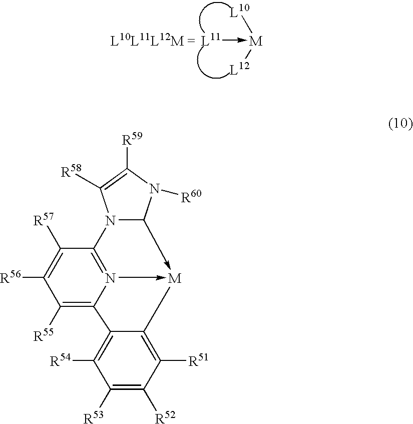
[in Formula (10), R⁵¹ to R⁶⁰ each independently represent a hydrogen atom, a halogen atom, a thiocyano group or a cyano group, a nitro group, a —S(═O)₂R′ group or a —S(═O)R′ group, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 30 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 ring carbon atoms which may have a substituent, an arylamino group having 6 to 30 carbon atoms which may have a substituent, an alkylsilyl group having 3 to 30 ring carbon atoms which may have a substituent, an arylsilyl group having 6 to 30 carbon atoms which may have a substituent or a carboxyl-containing group having 1 to 30 carbon atoms, and they may be cross-linked;
(R′ each independently represents a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 50 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent)].

10. The transition metal complex compound having a metal carbene bond as described in claim 5, wherein a L¹³L¹⁴L¹⁵M part in Formula (5) has a structure represented by the following Formula (11): 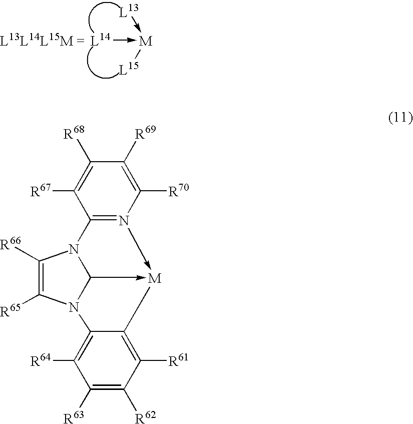
[in Formula (11), R⁶¹ to R⁷⁰ each independently represent a hydrogen atom, a halogen atom, a thiocyano group or a cyano group, a nitro group, a —S(═O)₂R′ group or a —S(═O)R′ group, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 30 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 ring carbon atoms which may have a substituent, an arylamino group having 6 to 30 carbon atoms which may have a substituent, an alkylsilyl group having 3 to 30 ring carbon atoms which may have a substituent, an arylsilyl group having 6 to 30 carbon atoms which may have a substituent or a carboxyl-containing group having 1 to 30 carbon atoms, and they may be cross-linked;
(R′ each independently represents a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 50 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent)].

11. The transition metal complex compound having a metal carbene bond as described in claim 1 or 2, wherein a M(L¹⁶)ᵢ(L¹⁷)ⱼ(L¹⁸)ₖ part in Formula (1) and Formula (2) each has independently a structure represented by the following Formula (12), (13) or (14):
M(L¹⁶)ᵢ(L¹⁷)ⱼ(L¹⁸) 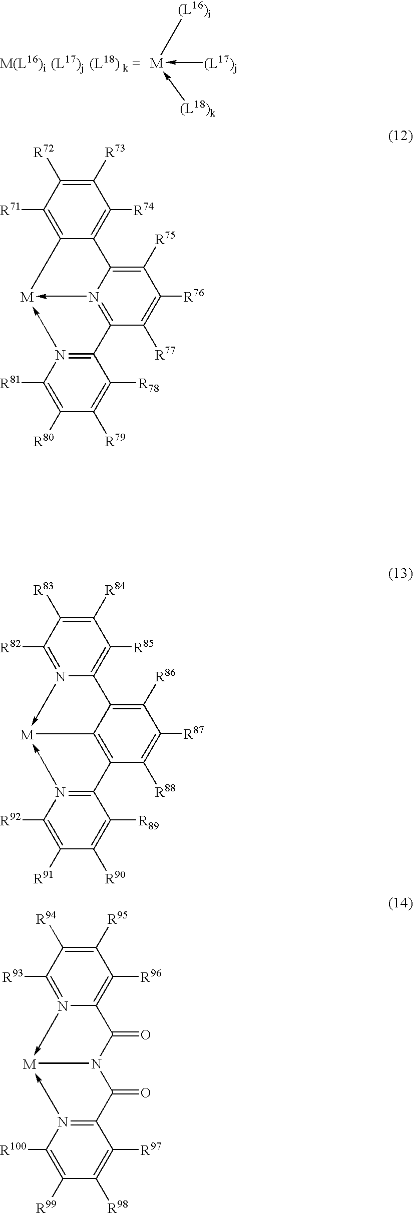
[in Formulas (12), (13) and (14), R⁷¹ to R¹⁰⁰ each independently represent a hydrogen atom, a halogen atom, a thiocyano group or a cyano group, a nitro group, a —S(═O)₂R′ group or a —S(═O)R′ group, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 30 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 ring carbon atoms which may have a substituent, an arylamino group having 6 to 30 carbon atoms which may have a substituent, an alkylsilyl group having 3 to 30 ring carbon atoms which may have a substituent, an arylsilyl group having 6 to 30 carbon atoms which may have a substituent or a carboxyl-containing group having 1 to 30 carbon atoms, and they may be cross-linked;
(R′ each independently represents a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 50 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent)].

12. The transition metal complex compound having a metal carbene bond as described in claim 3, 4 or 5, wherein a M(L¹⁹)ᵢ(L²⁰)(L²¹)ₖ part in Formula (3), Formula (4) and Formula (5) each has independently a structure represented by the following Formula (15), (16), (17) or (18):
M(L¹⁹)ᵢ(L²⁰)ⱼ(L²¹) 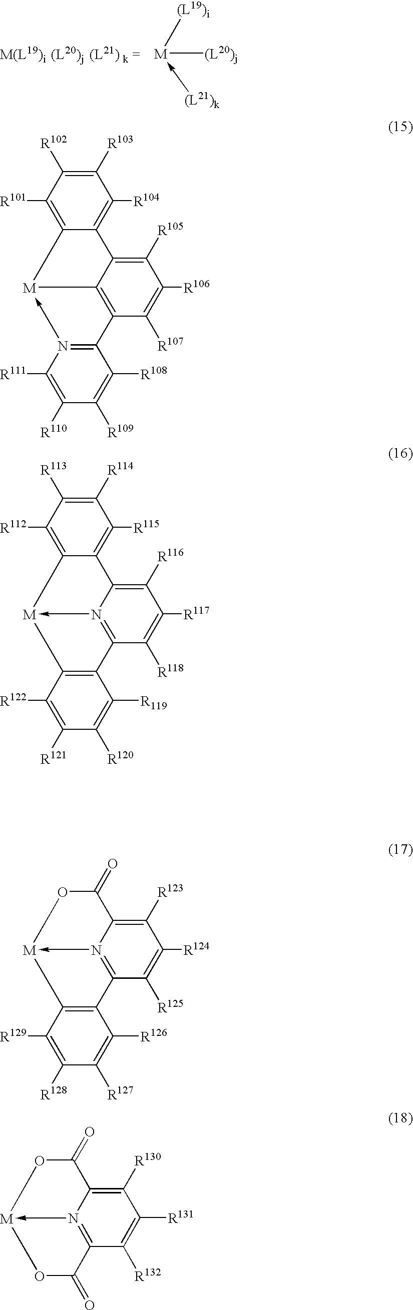
[in Formulas (15), (16), (17) and (18), R¹⁰¹ to R¹³² each independently represent a hydrogen atom, a halogen atom, a thiocyano group or a cyano group, a nitro group, a —S(═O)₂R′ group or a —S(═O)R′ group, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 30 ring carbon alkoxy group having 1 to 30 carbon atoms which may have a substituent, an aryloxy group having 6 to 30 ring carbon atoms which may have a substituent, an alkylamino group having 3 to 30 carbon atoms which may have a substituent, an arylamino group having 6 to 30 carbon atoms which may have a substituent, an alkylsilyl group having 3 to 30 carbon atoms which may have a substituent, an arylsilyl group having 6 to 30 carbon atoms which may have a substituent or a carboxyl-containing group having 1 to 30 carbon atoms which may have a substituent)].

13. The transition metal complex compound having a metal carbene bond as described in any of claims 1 to 5, wherein M described above is Ir.

14. An organic electroluminescent device in which an organic thin film layer comprising a single layer or plural layers having at least a light emitting layer is interposed between an anode and a cathode, wherein at least one layer in the organic thin film layer contains the transition metal complex compound having a metal carbene bond as described in any of claims 1 to 5.

15. The organic electroluminescent device as described in claim 14, wherein the light emitting layer described above contains the transition metal complex compound having a atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an alkoxy group having 1 to 30 carbon atoms which may have a substituent, an aryloxy group having 6 to 30 ring carbon atoms which may have a substituent, an alkylamino group having 3 to 30 ring carbon atoms which may have a substituent, an arylamino group having 6 to 30 carbon atoms which may have a substituent, an alkylsilyl group having 3 to 30 ring carbon atoms which may have a substituent, an arylsilyl group having 6 to 30 carbon atoms which may have a substituent or a carboxyl-containing group having 1 to 30 carbon atoms, and they may be cross-linked;
(R′ each independently represents a hydrogen atom, an alkyl group having 1 to 30 carbon atoms which may have a substituent, a halogenated alkyl group having 1 to 30 carbon atoms which may have a substituent, an aromatic hydrocarbon group having 6 to 30 ring carbon atoms which may have a substituent, a cycloalkyl group having 3 to 50 ring carbon atoms which may have a substituent, an aralkyl group having 7 to 40 carbon atoms which may have a substituent, an alkenyl group having 2 to 30 carbon atoms which may have a substituent, a heterocyclic group having 3 to 30 ring carbon atoms which may have a substituent, an metal carbene bond as described in any of claims 1 to 5 as a luminescent material.

16. The organic electroluminescent device as described in claim 14, containing the transition metal complex compound having a metal carbene bond as described in any of claims 1 to 5 as a dopant.

17. The organic electroluminescent device as described in claim 14, wherein an electron injecting layer and/or an electron transporting layer is provided between the light emitting layer and the cathode described above, and the above electron injecting layer and/or electron transporting layer comprises a π-electron deficient nitrogen-containing heterocyclic derivative as a principal component.

18. The organic electroluminescent device as described in claim 14, wherein a reducing dopant is added to an interfacial region between the cathode and the organic thin film layer described above
